(19) United States
(12) Patent Application Publication
(10) Pub. No.: US 2025/0303368 A1
(43) Pub. Date: Oct. 2, 2025

(54) CARBON-DOPED MEMBRANES, METHODS OF MAKING SAME, AND USES THEREOF

(71) Applicant: The Research Foundation for The State University of New York, Amherst, NY (US)

(72) Inventors: Miao YU, Pittsford, NY (US); Bratin SENGUPTA, Buffalo, NY (US); Qiaobei DONG, Mount Prospect, IL (US)

(21) Appl. No.: 18/865,742

(22) PCT Filed: May 16, 2023
(86) PCT No.: PCT/US2023/022354

§ 371 Date: Nov. 14, 2024

Related U.S. Application Data
(60) Provisional application No. 63/342,436, filed on May 16, 2022.

(51) Int. Cl. B01D 71/02; A23D 9/04; B01D 61/02; B01D 67/00; B01D 69/02; B01D 69/08; B01D 69/10; C11B 3/00

(52) U.S. Cl. CPC B01D 71/024; A23D 9/04; B01D 61/027; B01D 67/0069; B01D 67/0072; B01D 69/02; B01D 69/08; B01D 69/108; C11B 3/008; B01D 2325/02832; B01D 2325/20

(57) ABSTRACT

Carbon-doped layers and methods of making and using same. In various examples, a carbon-doped layer is porous. In various examples, a carbon-doped layer is a carbon-doped metal oxide and/or metal layer. In various examples, a carbon-doped layer is disposed on at least a portion of substrate. In various examples, a method of making carbon-doped layer(s) comprises contacting a substrate with liquid carbon precursor(s) and optionally, water, and contacting the substrate with liquid precursor(s) and optionally, water with one or more vapor-phase metal and/or metal oxide precursor(s), where the carbon-doped layer(s) is/are formed. In various examples, a method further comprises the carbon-doped layer(s), where porous carbon-doped layer(s) is/are formed. In various examples, a filtration substrate comprises one or more porous carbon-doped layer(s). In various examples, a filtration substrate is used in a separation method or the like. In various examples, the method is an organic solvent nanofiltration (OSN) or the like.

### CROSS-REFERENCE TO RELATED APPLICATIONS

This application claims the benefit of U.S. Provisional Patent Application No. 63/342,436, filed May 16, 2022; the contents of the above-identified application are hereby fully incorporated herein by reference in their entirety.

### BACKGROUND OF THE DISCLOSURE

Industrial separation costs ˜50% of the total US energy requirement and about 70% of the product's final cost. Efficient non-thermal based separation processes save not only 100 million tons of CO₂ being emitted into the atmosphere annually but also 40 billion USD energy cost annually. As this pushes membrane technology more into industrial applications, most commercial membranes face challenges in current industrial operation conditions-processes involving harsh organic solvents at elevated temperature and pressure. To address these problems, different membranes have been developed for organic solvent nanofiltration (OSN) applications. OSN membranes find applications in, but not limited to, oil and petrochemical industry (for example, lube oil dewaxing), pharmaceutical manufacturing processes & specialty chemical manufacturing (for example, active pharmaceutical ingredient concentration (API), homogeneous catalyst, and solvent recovery). In all these applications, a certain larger molecule (for example, homogeneous catalyst/product) is rejected by a semipermeable barrier (OSN membrane) based on its size difference compared to the other smaller molecules in the mixture, usually at elevated temperature and pressures. Without OSN technology, the smaller solvent molecules must be distilled off to separate, which involves immense energy cost. OSN technology is sought after in industry essentially because it lowers this energy cost. However, many membranes available in the market and developed in the laboratory cannot effectively perform this separation, either because they are unable to withstand harsh organic solvents under operation conditions (low stability) or because the rate of molecules passing through them is low (low permeance) or their ability to effectively separate out two molecules is low (low selectivity).

Industrially relevant molecular separations, for example, in pharmaceutical petroleum, and chemical industries, involve harsh solvents at high temperatures. Ease of fabrication into thin films, especially via interfacial polymerization, makes polymers promising for scalable membrane fabrication. However, only few polymeric membranes target these applications involving challenging industrially relevant conditions. Polymers usually suffer from instability in such severe conditions or undergo aging and pore collapse due to polymer chain relaxation. Non-polymeric counterparts-carbon and graphene/graphene oxide, metal/covalent organic frameworks (MOF/COF), and ceramics having stable rigid pores can extend membrane separation to these harsh industrial conditions. While disorders/defects and inter-crystalline grain boundaries are commonplace in graphene and MOF/COF membranes causing reproducibility issues and challenging scale-up, ceramic membranes prepared by traditional sol-gel method lack precise nanopore size control and have thickness in micrometer range. Materials with precisely tunable rigid pores, while owning processibility of polymers, ease to form defect-free continuous membranes, and excellent chemical, mechanical, and thermal stabilities of inorganic materials, therefore, are missing. Interfacial reactions, analogous to that used for commercial polyamide desalination membrane fabrication, to generate amorphous defect-free inorganic nanofilms are highly desirable and might fill this material gap, extending membrane separation to harsher conditions. However, till date, no such facile non-polymeric material/fabrication procedure exists, limiting membrane applications in many industrially relevant separations involving severe environments.

Besides stability and selectivity, high permeance is critical, considering large volume of solvents processed in industry. Thickness reduction is an effective way of increasing permeance. Indeed, most recent studies seek selective layer thickness reduction, sometimes down to atomic thinness, such as ultrathin polymeric coatings and monolayer graphene, to achieve high permeance. Although effective, this increases probability of introducing defects/pinholes and thus likely results in scale-up challenges.

### SUMMARY OF THE DISCLOSURE

The present disclosure provides, inter alia, carbon doped layers, which may be porous carbon doped layers.

In various examples, a filtration substrate comprises a substrate and layer comprising one or more porous carbon-doped metal oxide and/or metal layer(s), where at least one of the porous carbon-doped metal oxide and/or metal layer(s) is/are disposed on at least a portion of a surface or surfaces of the substrate. In various examples, the substrate is planar, a fiber, a plurality of fibers, or the like. In various examples, the fiber is a hollow fiber or the like. In various examples, the substrate is porous. In various examples, the substrate comprises a metal chosen from stainless steel, titanium, zirconium, tin, tungsten, or the like, and any combination thereof. In various examples, the substrate comprises a ceramic material chosen from aluminum oxide, titanium oxide, zirconium oxide, tin oxide, tungsten oxide, or the like, or any combination thereof. In various examples, each of the porous carbon-doped metal oxide and/or metal layer(s) independently comprise(s) at least one linear cross-sectional dimension of about 2 nm to about 200 nm. In various examples, each of the porous carbon-doped metal oxide and/or metal layer(s) independently comprise(s) one or more transition metal(s) and/or one or more transition metal oxide(s). In various examples, the each of the porous carbon-doped metal oxide and/or metal layer(s) independently comprise(s) a carbon-doped titanium oxide and/or titanium metal, a carbon-doped zirconium oxide and/or zirconium metal, carbon-doped tungsten oxide and/or tungsten metal, carbon-doped zinc oxide and/or zinc metal, carbon-doped copper oxide and/or copper metal, carbon-doped tin oxide and/or tin metal, or the like, or any combination thereof. In various examples, each of the porous carbon-doped metal oxide and/or metal layer(s) independently comprise(s) about 30% at. to about 60% at. In various examples, each of the porous carbon-doped metal oxide and/or metal layer(s) independently comprise(s) about 40 at. % to about 70 at. % metal and/or metal oxide. In various examples, each of the porous carbon-doped metal oxide and/or metal layer(s) independently comprise(s) an average pore diameter of about 2 nm to about 10 nm. In various examples, each of the porous carbon-doped metal oxide and/or metal layer(s) independently comprises interconnected pores or an open pore structure. In various examples, each of the porous carbon-doped metal oxide and/or metal layer(s) independently comprise(s) about 5% pore volume to about 50% pore volume. In various examples, the filtration substrate exhibits one or more or all of the following: a flux of greater than about 10 L m⁻² h⁻¹; no substantial change in pore dimension(s) at temperatures up to about 250° C. or greater; a porosity/tortuosity factor of about 0.05 or greater a molecular weight cutoff value from about 200 g/mol to about 1,000 g/mol); or a rejection of about 80% or more.

In various examples, a method of making a filtration substrate of the present disclosure comprises a substrate and layer comprises one or more porous carbon-doped metal oxide and/or metal layer(s) of the present disclosure, where at least one of the porous carbon-doped metal oxide and/or metal layer(s) is/are disposed on at least a portion of a surface or surfaces of the substrate comprising: contacting a substrate with one or more liquid carbon precursor(s) and optionally, water, optionally, holding the substrate and carbon precursor(s) and optionally, water for a desired time and/or temperature; optionally, drying or removing excess liquid precursor(s); contacting the substrate with liquid precursor(s) disposed thereon with one or more vapor-phase metal and/or metal oxide precursor(s), where a precursor layer is formed; optionally, contacting the precursor layer to remove undesirable material(s); and heating precursor layer, where the filtration substrate is formed. In various examples, the carbon sourc(es) is/are chosen from polyols, and the like, and any combination thereof. In various examples, the vapor-phase metal and/or metal oxide precursor(s) are chosen from metal halides, and the like, and any combination thereof.

In various examples, a filtration system comprises one or more filtration substrate(s) of the instant disclosure. In various examples, the system comprising one or more pump(s), one or more mass/flow controller(s), one or more reservoir(s), one or more tank(s), or one or more pressure gauge(s), or the like, or any combination thereof. In various examples, the filtration substrate(s) is/are disposed in a housing or the like, the housing or the like comprising one or more orafic(es).

In various examples, a method of separating one or more compound(s) from a composition comprises: contacting one or more filtration substrate(s) of the present disclosure with the composition comprising the compound(s), where the compound(s) are separated from the mixture. In various examples, the mixture is a reaction mixture or the like. In various examples, the composition comprises vegetable oil(s) or the like and one or more organic solvent(s) or the like and at least a portion of (e.g., substantially all or all) the organic solvent(s) or the like is/are separated from the composition. In various examples, the one or more compound(s) are chosen from reaction component(s), reaction product(s), reaction by-product(s), reactant component degradation product(s), catalyst(s), solvent(s), and the like, and any combination thereof. In various examples, the filtration membrane(s) is/are reused in a subsequent filtration. In various examples, the filtration membranes(s) are cleaned prior to use in each of the subsequent filtrations.

### BRIEF DESCRIPTION OF THE FIGURES

For a fuller understanding of the nature and objects of the disclosure, reference should be made to the following detailed description taken in conjunction with the accompanying figures.

FIG. 1A-E shows CDTO nanofilm formation and characterization. (A) Schematic showing the formation of the organometallic hybrid film (OHF) and subsequent generation of the porous carbon doped titanium oxide (CDTO) via calcination. The reaction scheme (I) shows the formation of OHF via a facile substitution reaction between ethylene glycol (EG) and titanium (IV) tetrachloride (TiCl₄) at the interface of two phases (II), leading to the formation of a dense OHF (III) that becomes porous CDTO (IV) after careful removal of carbon. (B) Visualization of nanopores in CDTO when OHF undergoes thermal treatment in O₂ (I) or N₂ (II), as realized by Molecular Dynamics simulation; blue and purple spheres represent titanium and carbon atoms, respectively, while solid parts (saffron or green) represent voids formed. Left to Right shows the decrease in carbon doping (values indicated on top of each frame) and increase in pore/voids in the structure. CDTO's porosity and surface area (and hence pore size) can be precisely tuned over a large range by controlling the carbon doping (III and IV), as evidenced from simulation. (C) Thermogravimetric analysis (TGA) of OHF showing its mass loss at 250° C. to generate porous CDTO nanofilms. Inset: mass loss of CDTO-Air and CDTO-N₂ in air and N₂, respectively, up to 300° C. (D) Pictures of OHF and CDTO nanofilms on anodic aluminum oxide (AAO) and α-alumina hollow fiber supports (1, 4: OHF; 2, 5: CDTO-Air; 3, 6: CDTO-N₂). (E) Scanning electron microscopy (SEM) images of the CDTO-Air nanofilm on AAO: surface (left) and cross-section (right).

FIG. 2A-E shows the solvent permeation through and dye rejection by CDTO nanofilms. (A) Permeation of various solvents through CDTO nanofilms on AAO at 20° C. Orange represents CDTO prepared by calcination in air at 250° C., denoted as CDTO-Air, while violet represents CDTO prepared by calcination in N₂ at 250° C., denoted as CDTO-N₂. (B) Permeation of various solvents through CDTO nanofilms on α-alumina hollow fiber support (50-nm pores). Solid symbols for solvents 1-6 represent permeation at 20° C., and open symbols for solvent 7 represent permeation at 20-140° C. Orange represents CDTO-Air, and violet represents CDTO-N₂. (C) Dye rejection by CDTO nanofilms on AAO and α-alumina hollow fiber supports at 20° C.: CDTO-N₂ (top); CDTO-Air (bottom). (D) Separation performance of CDTO-Air-250° C. nanofilm on α-alumina hollow fiber for Rose Bengal (RB; molecular weight: 973 g mol⁻¹) solution in DMF at different temperatures. (E) Methanol permeance verse molecular weight cut-off (MWCO) at 20° C. for CDTO nanofilms prepared on α-alumina hollow fiber support under different conditions. Violet represents CDTO calcined in N₂, while orange represents calcination in air. Diamond represents CDTO nanofilms prepared at different calcination temperatures (temperature values next to the symbols), while using pure ethylene glycol (EG). Circle represents CDTO nanofilms prepared by adding different weight percentages of water to EG (values next to the symbols), while maintaining the calcination temperature at 250° C. Error bars represent standard deviation from 3 samples. Error bars are omitted if they are smaller than symbols.

FIG. 3A-C shows a comparison of carbon-doped titanium oxide (CDTO) nanofilms with organic solvent nanofiltration (OSN) membranes. (A) Schematic showing the influence of ε and τ on permeation through an OSN membrane when pore size and membrane thickness is fixed. For constant pore size and thickness, high density of pores having low tortuosity yields high permeance. (B) Comparison of ε/τ of CDTO membranes with commercial OSN membranes and state-of-the-art membranes reported in the literature. Only Diamond like carbon (DLC) and 3D COF membrane fall in the region of our CDTO membranes. (C) Separation performance comparison of our CDTO membranes with state-of-the-art commercial membranes and membranes reported in the literature. Methanol permeance at 20° C. versus MWCO of these membranes is presented. CDTO nanofilms on AAO (high-permeance support) show the ultra-high permeance at a specific MWCO and 2 to 3 orders of magnitude higher than commercial OSN membranes. CDTO nanofilms on α-alumina hollow fiber support (low-permeance support) have higher permeance than most OSN membranes, except for DLC, 8 nm polyamide and 1 atom thin graphene. This is apparently because of the support resistance. The dashed lines are only a guide.

FIG. 4A-D shows a demonstration of CDTO membranes in the manufacturing of Boscalid under industrially relevant conditions (temperature: 80° C.). (A) A two-stage membrane cascade system designed using two CDTO membranes: membrane 1 with larger pores (MWCO: 940 Da) to retain the homogeneous catalyst (1,150 Da); membrane 2 with smaller pores (MWCO: 300 Da) to separate product (340 Da) from reactants (˜160 Da). Retentate from membrane 1 (containing catalyst) and permeate from membrane 2 (containing unreacted reactants) are to be recycled back into the reactor. (B) In 100-h operation, membrane 1 shows >99% catalyst rejection and <10% permeance drop. (C) In 100-h operation, membrane 2 shows >95% retention of product, while allowing reactants to pass through. (D) Concentrations of catalyst, product, and reactants over time for permeates 1 and 2 (as defined in A). The concentrations of the components in each stream have been normalized by their concentration in the feed.

FIG. 5A-B shows a schematic of a preparation procedure of CDTO nanofilms on porous substrate with different morphologies: (A) Flat sheet AAO support; (B) α-aluminum ceramic hollow fiber support.

FIG. 6A-B shows (A) Reaction for the formation and the structure of OHF: double substitution reaction between a metal precursor (e.g., TiCl₄) and an organic precursor (e.g., EG) forming dense OHF. (B) The unit chemical structure of organometallic network.

FIG. 7A-D shows optimization of an OHF synthesis. (A) N₂ permeance through OHF formed after different reaction time. Both organic and metallic reactant are in liquid phase, the reaction being carried out at room temperature with TiCl₄ (metallic reactant) concentration at 0.3 mol L⁻¹. (B) Time required to form a dense OHF at room temperature, both reactants being in liquid phase but varying concentration of TiCl₄. Higher concentration allowed dense OHF formation in shortest time. (C) The OHF formed is a function of TiCl₄ concentration. After 30 min reaction in room temperature, the hybrid material formed blocks the pores of the support for N₂ permeance. Lower permeance indicate more hybrid material formed, and this corresponds to the hypothesis that hybrid material yield heavily depends on TiCl₄ concentration. (D) Dense OHF formed on 5 nm pore size support, using 1,3-propylene glycol (reactant 3, containing 3 carbon) and EG (reactant 2, containing 2 carbon) as organic reactant. After calcination, the CDTO formed with EG shows lower permeance for both H₂ and N₂. However, both membrane shows no size sieving for these gas pairs. This indicates pores larger than these gases, but small enough to demonstrate Knudson diffusivity.

FIG. 8A-D shows SEM images showing surface morphology of OHF formed on 5 nm porous hollow fiber support via liquid-phase interfacial reaction. Surface of (A) 5 nm pore size bare support; and dense OHF formed with both reactants in liquid-phase with varying concentration of TiCl₄ (B) 0.01 mol L⁻¹ (D) 0.5 mol L⁻¹ and (D) 1 mol L⁻¹. All reactions were carried out at room temperature for 30 min.

FIG. 9A-F shows SEM images showing cross sectional thickness of defect free, dense OHF formed under different reaction conditions. The thinnest dense nanofilm was formed via high temperature reaction with organic reactant in liquid-phase and metallic reactant in vapor phase. (A-E) Room temperature reaction with both precursors in liquid-phase. (F) High temperature (150° C.) reaction with TiCl₄ in vapor phase. The concentration of metallic precursor in the liquid-phase and the reaction time has been varied: (A) 0.2 mol L⁻¹ with reaction of 180 min; (B) 0.3 mol L⁻¹ with reaction of 120 min; (C) 0.4 mol L⁻¹ with reaction of 60 min; (D) 1.0 mol L⁻¹ with reaction of 20 min; (E) Pure metallic precursor with reaction of 10 min. From the SEM images of the representative OHF, it is evident that liquid-phase reaction needs greater thickness to from a defect free film.

FIG. 10A-B shows methanol permeance through OHF after different interfacial reaction times between EG (liquid) and TiCl₄ (heated vapor), prepared on (A) flat sheet AAO with 20 nm pore size and (B) α-alumina ceramic hollow fiber membrane with pore size around 50 nm. For AAO: The pristine support showed methanol permeance of 1116 L L m⁻² h⁻¹ bar⁻¹; it drastically decreased about 60% to 422 L m⁻² h⁻¹ bar⁻¹ after 0.5 min of reaction and became dense (non-detectable flux, permeance<0.05 L m⁻² h⁻¹ bar⁻¹) after 1 min reaction. As expected, no methanol permeance was observed for OHF after 2 min reaction. This suggests 1 min is sufficient to form a dense OHF on AAO. For hollow fiber: Only after 1 min of reaction, the pure methanol permeance dropped from 750 L m⁻² h⁻¹ bar⁻¹ to 302 L m⁻² h⁻¹ bar⁻¹, and after 5 min of reaction the methanol permeance was not detectable (permeance<0.05 L m⁻² h⁻¹ bar⁻¹). Also, after 10 min reaction, no methanol permeance was detected, indicating that only 5 min reaction is necessary to generate a dense OHF on hollow fiber surface.

FIG. 11A-D shows SEM images showing surface morphology evolution during vapor-liquid interfacial reaction at 150° C. (A) The 50 nm pore size support at the beginning of the reaction. (B) surface after 1 min of interfacial reaction. (C) surface is mostly covered after 3 min of reaction. Few large defects remain on the surface that prevent formation of continuous large area OHF. (D) defect free CDTO (formed by calcining in air at 250° C. a defect free OHF formed after 5 min of reaction).

FIG. 12A-B shows thermogravimetric analysis of OHF and CDTO. (A) Mass change with temperature for CDTO-Air and CDTO-N₂, undergoing thermal treatment either in N₂ (dashed lines) or air (solid lines). All CDTO shows less than 5% mass loss upon heating to 300° C. (B) Derivative mass change (with respect to temperature) of OHF and CDTO-Air and N₂ under thermal treatment in either air or N₂. Only OHF shows significant mass loss at 250° C. under thermal treatment.

FIG. 13 shows SEM images showing surface (top) and cross section (bottom) of CDTO-Air synthesized on hollow fiber support. Inset: dense OHF were synthesized down to 150 nm thin after 5 min of interfacial reaction. After skin layer synthesis, the surface of the hollow fiber changes completely compared to pristine hollow fiber support.

FIG. 14A-D shows temperature independent separation performance of CDTO nanofilms. (A) CDTO-N₂ membrane shows consistant rejection of Rose Bengal up to 140° C. in DMF. (B) CDTO-Air (prepared by calcining OHF synthesized with 20% H₂O in EG) nanofilm shows consistent rejection of Rose Bengal from methanol upto 100° C. (D) CDTO-N₂ (prepared by calcining OHF synthesized with 20% H₂O in EG) shows consistant rejection of Methyl Blue dissloved in methanol; (D) Viscosity dependent permeance was observed for DMF through the membrane in (C) at different temperatures (20-140° C.; lower viscosity indicates lower operation temperature). These measurements indicate that pores of CDTO are rigid even at high temperatures.

FIG. 15 shows CDTO-N₂ nanofilm long term stability for dye rejection. The membrane was soaked in methanol with dissolved solute-Rose Bengal, for different times. The membrane was subjected to periodic transmembrane pressure to collect permeate and observed no change in rejection through the membrane even after 80 h. The permeance decreased slightly due to fouling during the operation.

FIG. 16 shows CDTO membrane long term stability in pure solvent (methanol). The CDTO-N₂ membrane maintained constant premeance of methanol over 90 h of operation. The flux increases with the increase of transmembrane pressure linearly and reversible. No apparent change of premeance was observed over the varying transmembrane pressure range.

FIG. 17 shows rejection of Rose Bengal by CDTO-N₂ nanofilm at different transmemrbane pressures. Rejection of Rose Bengal from methanol remained unchanged with varying feed pressure. With the increase of pressure, CDTO-N₂ nanofilms maintained their structure and provided similar rejection at transmembrane pressure between 40 and 160 PSIG. The slight decrease of permeance may be due to higher fouling at higher pressure.

FIG. 18 shows rejection of Acid Fuchsin dye by a CDTO-N₂ nanofilm at different dye concentration. CDTO-N₂ (prepared by calcining OHF synthesized with 20% H₂O in EG) membrane maintained high rejection of Acid Fuchsin even at higher concentration, indicating possible practical use of these membranes under varying solute concentration in feed. The slight decrease of permeance may be due to higher fouling at feed concentrations.

FIG. 19 shows rejection through CDTO membrane is only based on size, and charge has very limited role. It was observed for a CDTO-N₂ (prepared by calcining OHF synthesized with 30% H₂O in EG) nanofilm, the rejections of similar sized dyes with opposite charges (6-hydroxy-2-naphthalenesulfonic acid sodium salt and Chrysoidine G) are very similar. This indicates that rejection is independent of the charge.

FIG. 20 shows nanofiltration performance of CDTO-N₂ nanofilms formed with different organic precursors. Permeation of methanol and rejection of Reactive Red 120 (dissolved in methanol) by CDTO membranes prepared from different glycols. These membranes were calcined for 2 h in N₂ at 250° C. CDTO membranes prepared with other glycols showed good rejection of solute molecules from the organic solvent.

FIG. 21A-D shows rejection of different dyes by CDTO nanofilms formed by calcination of OHF in air at 250° C. OHFs were prepared by adding different amount of water in EG. The water doping was varied from 0% to 30% to generate 4 different sets of CDTO nanofilms—(A) 0% water doped, (B) 10% water doped, (C) 20% water doped and (D) 30% water doped.

FIG. 22A-D shows rejection of different dyes by CDTO nanofilms formed by calcination of OHF in N₂ at 250° C. OHFs were prepared by adding different amount of water in EG. The water doping was varied from 0% to 30% to generate 4 different sets of CDTO nanofilms-A) 0% water doped, (B) 10% water doped, (C) 20% water doped and (D) 30% water doped.

FIG. 23 shows visualization of tighter packing of titanium atoms when the organic precursor is doped with water. Increasing water content in EG increases the Ti—O—Ti bonds, leading to denser packing of titanium atoms compared to Ti—CH₂—CH₂—Ti bonds. OHF with tightly packed titanium generated smaller pores when thermally treated under the same condition. Hence adding water to the organic phase yields membrane with lower MWCO.

FIG. 24A-D shows rejection of different dyes by CDTO nanofilms formed by calcination in air at different temperatures. OHFs were prepared with pure organic precursor—EG. The thermal treatment temperature was varied between 250° C. to 500° C. to generate 4 different sets of CDTO nanofilms—(A) thermal treatment at 250° C., (B) thermal treatment at 300° C., (C) thermal treatment at 400° C. and (D) thermal treatment at 500° C. All these nanofilms were thermally treated in air.

FIG. 25A-D shows rejection of different dyes by CDTO nanofilms formed by calcination in N₂ atmosphere at different temperatures. OHFs were prepared with pure organic precursor-EG. The thermal treatment temperature was varied between 250° C. to 500° C. to generate 4 different sets of CDTO nanofilms-(A) thermal treatment at 250° C., (B) thermal treatment at 300° C., (C) thermal treatment at 400° C. and (D) thermal treatment at 500° C. All these nanofilms were thermally treated in N₂.

FIG. 26 shows visualization of tighter packing of titanium atoms when OHF is thermally treated at different temperatures. OHF loses more carbon yielding larger pores as the calcination temperature increases. Hence increasing calcination temperature yields membrane with higher MWCO.

FIG. 27 shows CDTO membranes shows higher solvent permeance even if their thickness is greater other reported OSN membrane (Table 6) because of its high &/t values. The x-axis represents the inverse of thickness normalized by the pore size (MWCO) of the membrane while y-axis shows the methanol permeance.

FIG. 28 shows simplified reaction scheme for the synthesis of Boscalid. The reactant (1, 2 and 3:4-Chlorobenzeneboronic acid, 156.37 Da; 1-Chloro-2-nitrobenzene, 157.55 Da; 2-Chloropyridine-3-carbonyl chloride, 176 Da) all have molecular weight<180 Da and would pass though the tighter membrane (MWCO=300 Da) along with the solvent while the product (4: boscalid, 2-Chloro-N-(4′-chlorobiphenyl-2-yl)-nicotinamide 341 Da) would be rejected. The catalyst for Suzuki-Miyaura cross coupling is large (Tetrakis(triphenylphosphine) palladium (0), Pd(PPh₃)₄˜1115 Da) and would get rejected by the membrane with the larger pore size (MWCO=940 Da).

FIG. 29A-B shows (A) Schematic of 2 stage membrane cascade system comprising of 2 CDTO membranes of different MWCO. A mixture of the 3 reactant, product, and catalyst in DMF at 90° C., mimicking the output stream of a reactor designed to synthesize Boscalid is fed through the membrane 1 (MWCO=940 Da) which separates the catalyst, allowing the reactants and product to pass through. This stream is then passes through membrane 2 (MWCO=300 Da) which separates out the product (Boscalid) and allows the 3 reactants to pass through. The permeate of membrane 2 and retentate of membrane 1 is recycled back to the tank. The entire membrane cascade was maintained at a certain temperature. (B) Schematic of the membrane module used during the operation.

FIG. 30A-D shows gel permeation chromatography analysis to determine the concentration of different components in the feed and permeate. (A-C) Gel permeation chromatographs showing the feed, permeate of membrane 1 and permeate of membrane 2. (D) Deconvolution of chromatogram obtained for feed to estimate the individual peak areas. Peak areas correspond to the concentration of the component. For 100 h test, the 3 reactants were considered as same molecule and their total concentration was estimated.

FIG. 31A-B shows (A) separation Factor of various components tracked over time during separation through membrane 1 and membrane 2. (B) Instantaneous mass fraction of product, catalyst, and reactants relative to the initial feed (Basis: 1 g). A simple mass balance over the cascade membrane system revels that 1) a stream having <75% catalyst (retentate stream of membrane 1) is recycled back to the reactor, 2) an unreacted reactant stream having <95% reactant (permeate of membrane 2) is recycled back to the reactor and 3) a stream containing <73% product is achieved as product stream (retentate of membrane 2). The product steam contains >1% of the initial mass of catalyst in reactor.

FIG. 32 shows a comparison of separation factor and solvent permeance of membrane reported in literature. The separation factor is normalized by the ratio of molecular weights (MW) of the molecule that the membrane is separating. A higher molecular weight ratio usually indicates separation that are easier than one with lower molecular weight ratio. The numbers for circles in the graph represent the following membranes: 1: 2D-COF; 2: Ultrathin 2D Cyclodextrin; 3: Polyarylate; 4: Graphene Oxide; 5: Crumpled cyclodextrin films; 6: PIM; 7: Conjugate Polymers; 8: Cyclodextrin with Janus Pathways; 9: Trianglamine Macrocycle; 10: Polyamide; 11: Aligned Macrocycle. The diamonds are separation factors for CDTO membranes used for an industrially relevant separation at high temperature during Boscalid synthesis.

FIG. 33A-B shows (A) a schematic of CDTO membrane preparation by interfacial reaction and carbon removal. EG: ethylene glycol; OHF: organometallic hybrid film. (B) a schematic of a membrane-based process for vegetable oil processing.

### DETAILED DESCRIPTION OF THE DISCLOSURE

Although claimed subject matter will be described in terms of certain examples, other examples, including examples that do not provide the benefits and features set forth herein, are also within the scope of this disclosure. Various structural, logical, and process step changes may be made without departing from the scope of the disclosure.

As used herein, unless otherwise indicated, “about”, “substantially”, or “the like”, when used in connection with a measurable variable (such as, for example, a parameter, an amount, a temporal duration, or the like) or a list of alternatives, is meant to encompass variations of and from the specified value including, but not limited to, those within experimental error (which can be determined by, e.g., a given data set, an art accepted standard, etc. and/or with, e.g., a given confidence interval (e.g. 90%, 95%, or more confidence interval from the mean), such as, for example, variations of +/−10% or less, +/−5% or less, +/−1% or less, and +/−0.1% or less of and from the specified value), insofar such variations in a variable and/or variations in the alternatives are appropriate to perform in the instant disclosure. As used herein, the term “about” may mean that the amount or value in question is the exact value or a value that provides equivalent results or effects as recited in the claims or taught herein. That is, it is understood that amounts, sizes, compositions, parameters, and other quantities and characteristics are not and need not be exact, but may be approximate and/or larger or smaller, as desired, reflecting tolerances, conversion factors, rounding off, measurement error, or the like, or other factors known to those of skill in the art such that equivalent results or effects are obtained. In general, an amount, size, composition, parameter, or other quantity or characteristic, or alternative is “about” or “the like,” whether or not expressly stated to be such. It is understood that where “about,” is used before a quantitative value, the parameter also includes the specific quantitative value itself, unless specifically stated otherwise.

Ranges of values are disclosed herein. The ranges set out a lower limit value and an upper limit value. Unless otherwise stated, the ranges include the lower limit value, the upper limit value, and all values between the lower limit value and the upper limit value, including, but not limited to, all values to the magnitude of the smallest value (either the lower limit value or the upper limit value) of a range. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “0.1% to 5%” should be interpreted to include not only the explicitly recited values of 0.1% to 5%, but also, unless otherwise stated, include individual values (e.g., 1%, 2%, 3%, 4%, etc.) and the sub-ranges (e.g., 0.5% to 1.1%; 0.5% to 2.4%; 0.5% to 3.2%, and 0.5% to 4.4%, and other possible sub-ranges) within the indicated range. It is also understood (as presented above) there are a number of values disclosed herein, and each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about, it will be understood that the particular value forms a further disclosure. For example, if the value “about 10” is disclosed, then “10” is also disclosed.

As used herein, unless otherwise stated, the term “group” refers to a chemical entity that is monovalent (i.e., has one terminus that can be covalently bonded to other chemical species), divalent, or polyvalent (i.e., has two or more termini that can be covalently bonded to other chemical species). The term “group” also includes radicals (e.g., monovalent radicals and multivalent radicals, such as, for example, divalent radicals, trivalent radicals, and the like). Illustrative examples of groups include:

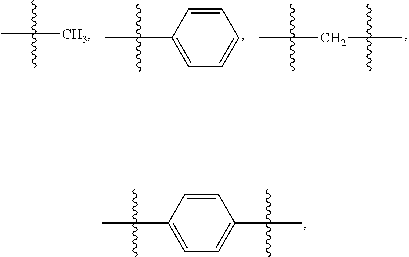

and the like.

The present disclosure provides carbon-doped membranes. The present disclosure also provides methods of making and uses of carbon-doped membranes.

The present disclosure provides, inter alia, facile self-terminating reactions. Without intending to be bound by any particular theory, it is considered a self-terminating reaction takes place at the interface of vapor (of metal precursor(s)) and liquid (of organic precursor(s)). In various examples, the reactions generate a thin film of an organometallic network, which is impermeable to gas and liquid molecules and is stable up to 250° C. Upon thermal treatment (which may be calcining) at different temperatures and different gas environments, different amounts of carbon were able to be removed from the impermeable network structure. In various examples, this carbon removal generates pores in the organometallic network while maintaining the abovementioned thin film morphology. In various examples, this forms a semipermeable barrier, which may be referred to as a membrane, that is stable in organic solvent under elevated temperatures. In various examples, a membrane was able to reject molecules with size ranging from, in various examples, 240 Da to 1,000 Da from organic solvents. In various examples, a membrane is used effectively for OSN application. In various examples, pressurizing a mixture of a larger solute (of molecular size: 200 Da to 1,000 Da) in organic solvents, these membranes will reject the larger molecule while allowing the smaller solvent molecules to permeate through. In various examples, membranes offered 2.5-10 times higher permeance compared to OSN membranes reported for similar applications, while maintaining similar selectivity.

In various examples, porous, thin films (carbon doped layers) are grown over a porous ceramic hollow fiber support and assembled into a module for an OSN application. In various examples, these modules can be used by the pharmaceutical industry to concentrate APIs, recover solvent, homogeneous catalyst, or the like, or a combination thereof, the oil and gas industry for dewaxing lube oil or the like, the specialty chemical industry for solvent and catalyst recovery or the like, etc.

Compared to previous polymer-based membranes for OSN technologies, a porous carbon-doped layer fabrication is similar to that used to fabricate the polymer-based membranes. However, in various examples, a porous carbon-doped layer can reduce the need of membrane area by 10 times or more for processing same volume of feed using the polymer-based membranes. In various examples, a porous carbon-doped layer is stable in various organic solvents and at elevated temperature and provide 2.5-10 times higher permeance while maintaining equivalent or higher selectivity compared to polymer-based membranes under the same or similar process conditions.

Moreover, the instant fabrication methodology can be used to fabricate membranes with pores tailored to target specific molecular separations. Non-limiting examples of fabrication technology can make membranes of multiple pore size or molecular weight cutoff (MWCO). So, using the same material and by modifying the fabrication method slightly, membranes tailored to a specific industrial application can be fabricated.

In various examples, a porous carbon-doped layer exhibit permeance that is at least 2.5 times higher than previously reported membranes and exhibit at least an order of magnitude higher than commercial membranes. This permeance allows design of processes with significantly less membrane area for processing similar volume of solvent. In various examples, a porous carbon-doped layer have rigid pores that do not deform under external operating pressure and membranes have shown, for example, stable permeance and selectivity up to temperatures of 100° C.

In an aspect, the present disclosure provides carbon-doped layers. In various examples, a carbon-doped layer is made by a method of the present disclosure. Non-limiting examples of carbon-doped layers are disclosed herein.

In various examples, a carbon-doped layer is a membrane, a precursor layer (such as, for example, an organometallic hybrid film (OHF) (such as, for example a non-porous organometallic hybrid film (OHF) or the like), or the like. In various examples, a carbon-doped layer (which may be a porous carbon-doped layer) is referred to as a skin layer or the like. In various examples, a carbon-doped layer comprises a metallo-organic network, an organometallic network, or the like. In various examples, a metallo-organic network or an organometallic network is referred to as a hybrid network. In various examples, a carbon-doped layer is a carbon-doped metal oxide and/or metal layer. In various examples, a carbon-doped layer is porous (such as, for example, a nanoporous carbon-doped layer or the like). In various examples, at least a portion or all of a carbon-doped layer is disposed on at least a portion or all of a surface or surfaces of a substrate (which may be a non-porous substrate or a porous substrate). In various examples, a device comprises one or more carbon-doped layer(s) (which may independently be a porous carbon-doped layer) and at least a portion or all the carbon-doped layer(s) is/are disposed on at least a portion or all a surface or surfaces of a substrate (which may be a non-porous substrate or a porous substrate).

In various examples, a filtration substrate (e.g., a filtration membrane or the like) comprises one or more substrate(s) and one or more carbon-doped layer(s). In various examples, one or more or all the carbon-doped layer(s) are porous. In various examples, each of the carbon-doped layer(s) are, independently, a porous carbon-doped metal oxide and/or metal layer. In various examples, one or more or all the carbon-doped layers, which independently may be porous carbon-doped layer(s), is/are disposed on at least a portion of a surface or surfaces of the substrate. In various examples, a filtration substrate (e.g., a filtration membrane or the like) comprises a substrate (which may be a porous substrate) and a porous carbon-doped layer (e.g., a porous carbon-doped metal oxide and/or metal layer) (which may be a nanoporous carbon-doped layer) disposed on at least a portion of a surface or surfaces (which may be an exterior surface or exterior surfaces, a pore surface or pore surfaces, or the like, or any combination thereof) of the substrate. In various examples, the filtration substrate is an organic solvent nanofiltration membrane. In various examples, a filtration substrate does not comprise a polymer or polymeric material or the like or any combination thereof.

A filtration substrate can comprise various substrates. In various examples, the efficacy of the deposited porous carbon-doped layer (e.g., a carbon-doped metal oxide and/or metal layer) is independent of the morphology of the substrate (e.g., hollow fiber, planer flat sheet or the like).

A substrate can have various forms, compositions, etc. In various examples, a substrate is a porous substrate or non-porous substrate. In various examples, a substrate is planar (e.g., a planar substrate), non-planar (e.g., a non-planar substrate), a fiber (which may be a hollow fiber or the like), or a plurality of fibers, or the like. In various examples, a fiber is a hollow fiber comprising a hollow wall (or at least a portion of a wall is hollow), and the hollow wall or the hollow portion of a wall comprises a plurality of pores (such as, for example a plurality of pores comprising at least one linear dimension (which may be a cross-sectional dimension, such as for example, a diameter, or the like) (which may be average pore dimension(s) of from about 1 nm to about 100 nm, including all 0.1 nm values and ranges therebetween (e.g., about 5 nm to about 50 nm, about 5 nm, about 10 nm, about 10 nm, or about 50 nm). In various examples, a substrate is aluminum oxide (AAO) (such as, for example, flat AAO (e.g., anodic flat AAO or the like)), cylindrical α-alumina hollow fiber (HF) or a plurality thereof, or the like.

In various examples, a substrate is (or comprises) one or metal(s), one or more ceramic material(s), or the like, or any combination thereof. In various examples, a substrate is (or comprises) a metal chosen from stainless steel, titanium, zirconium, tin, tungsten, or the like, or any combination thereof and/or a ceramic material chosen from aluminum oxide, titanium oxide, zirconium oxide, tin oxide, tungsten oxide, or the like, or any combination thereof.

In various examples, a carbon-doped layer (such as, for example, a porous carbon-doped layer) (e.g., a carbon-doped metal oxide and/or metal layer, a porous carbon-doped metal oxide and/or metal layer or the like) is charged (e.g., positively charged, negatively charged, or the like). In various examples, the charge pH dependent.

A carbon-doped layer (such as, for example, a porous carbon-doped layer) (e.g., a carbon-doped metal oxide and/or metal layer, a porous carbon-doped metal oxide and/or metal layer or the like) can have various sizes (areas, thicknesses, or the like, or any combination thereof). The area of a carbon-doped layer is not particularly limited. Processing methods/equipment that can be used to fabricate carbon-doped films of a wide-range of areas and thicknesses are known in the art. In various examples, the area of a carbon-doped layer is an area typically used in membrane filtration/separation process or the like. In various examples, a carbon-doped layer has (or comprises) at least one linear dimension (which may be a thickness, a cross-sectional dimension, or a dimension linear dimension substantially perpendicular (or perpendicular) to a longest linear dimension of the carbon-doped layer, or the like) of about 2 nm to about 200 nm (e.g., about 2 nm to about 100 nm, about 5 nm to about 50 nm, about 20 nm to about 200 nm, or about 35 to about 150 nm), including all 0.1 nm values and ranges therebetween.

A carbon-doped layer (such as, for example, a porous carbon-doped layer) (e.g., a carbon-doped metal oxide and/or metal layer, a porous carbon-doped metal oxide and/or metal layer or the like) can have various forms. In various examples, a carbon doped layer is a membrane, a film (e.g., a thin film), a sheet, a coating, a skin layer, or the like.

A carbon-doped layer (such as, for example, a porous carbon-doped layer) (e.g., a carbon-doped metal oxide and/or metal layer, a porous carbon-doped metal oxide and/or metal layer or the like) can comprise various metal(s) and/or metal oxide(s). In various examples, a carbon-doped layer is (or comprises) a carbon-doped metal, a carbon-doped metal oxide, or the like, or any combination thereof. In various examples, a carbon-doped metal comprises one or more transition metal(s) and/or a carbon-doped metal oxide(s) comprise one or more transition metal(s). Non-limiting examples of transition metals include titanium, zirconium, tungsten, copper, tin, and the like, and any combination thereof. In various examples, a carbon-doped metal oxide comprises one or more transition metal(s) (or transition metal oxide(s) or the like. Non-limiting examples, of transition metals include titanium, zirconium, tungsten, copper, tin, and the like, oxides thereof, and any combination thereof. In various examples, a carbon-doped layer is (or comprises) a carbon-doped titanium oxide (e.g., a carbon-doped titanium dioxide or the like) and/or zirconium metal, a carbon-doped zirconium oxide (e.g., a carbon-doped zirconium dioxide or the like) and/or zirconium metal, carbon-doped tungsten oxide and/or tungsten metal, carbon-doped zinc oxide and/or zinc metal, carbon-doped copper oxide and/or copper metal, carbon-doped tin oxide and/or tin metal, or the like, or any combination thereof.

A carbon-doped layer (such as, for example, a porous carbon-doped layer) (e.g., a carbon-doped metal oxide and/or metal layer, a porous carbon-doped metal oxide and/or metal layer or the like) can comprise various amounts of metal(s) and/or metal oxide(s). In various examples, a carbon-doped layer comprises about 40 to about 70% (which may be mol % or at. %) metal and/or metal oxide, including all 0.1 mol % or at % values and ranges therebetween. Methods of determining the amount of metal and/or metal oxide are known in the art. In various examples, the amount of metal and/or metal oxide is measured by a spectroscopic method, such as, X-ray Photoelectron Spectroscopy (XPS) or the like.

A carbon-doped layer (such as, for example, a porous carbon-doped layer) (e.g., a carbon-doped metal oxide and/or metal layer, a porous carbon-doped metal oxide and/or metal layer or the like) comprises carbon. A carbon-doped layer can comprise various amounts of carbon. In various examples, a carbon-doped layer comprises about 30 to about 60% (which may be mol % or at. %) carbon, including all 0.1 mol % or at % values and ranges therebetween. Methods of determining the amount of carbon are known in the art. In various examples, the amount of carbon is measured a spectroscopic method, such as, XPS or the like.

In various examples, the amount of carbon and metal(s) and/or metal oxide(s) totals 100% (which may be mol % (mol %=molar %) or at. % (at %=atom %). In various examples, a porous carbon-doped layer consists essentially of carbon and metal(s) and/or metal oxide(s). Non-limiting examples of components that do not materially affect the basic and novel characteristics of a porous carbon-doped layer include unreacted liquid carbon precursor(s), unreacted metal/metal oxide precursor(s), by-products thereof, degradation product(s) thereof, or the like, or any combination thereof.

Without intending to be bound by any particular theory, it is considered the content of the carbon in a porous carbon-doped layer is correlated to (e.g., determines) the size (e.g., diameter or like) of the pores (such as, for example, nanopores (e.g., nanopores comprising a diameter from about 0.7 nm to 1.5 nm, or less than 0.7 nm, or greater than 1.5 nm)).

A carbon-doped layer (e.g., a carbon-doped metal oxide and/or metal layer or the like) may be porous. Without intending to be bound by any particular theory, it is considered pore size is determined by various factors, such as, for example, liquid carbon precursor amount or structure; presence, absence, or amount of water); heating (e.g., calcining temperature, or the like) temperature, time, or atmosphere; or the like; or any combination thereof. In various examples, a carbon-doped layer is porous (e.g., comprises a plurality of pores). In various examples, the pores are substantially the same size or the pores have one or more different size(s). In various examples, each of the pores comprises at least one linear dimension (which may be a cross-sectional dimension, such as for example, a diameter, or the like) (which may be average pore dimension(s)) of about 2 nm to about 10 nm (e.g., about 0.6 nm to about 10 nm), including all 0.1 nm values and ranges therebetween. In various examples, about 80% or more, about 85% or more, about 90% or more, about 95% or more, about 98% or more, about 99% or more, about 99.5% or more, or about 100% or the pores comprise one or more linear dimension(s) (which may be a cross-sectional dimension, such as for example, a diameter, or the like) about 2 nm to about 10 nm (e.g., about 0.6 nm to about 2 nm, about 0.6 nm to less than about 2 nm, about 0.6 nm to about 5 nm, or about 0.6 nm to about 10 nm). In various examples, at about 80% or more, about 85% or more, about 90% or more, about 95% or more, about 98% or more, about 99% or more, about 99.5% or more, or about 100% or the pores comprise a linear dimension (which may be a cross-sectional dimension, such as for example, a diameter, or the like) that is +/−about 50 nm or about 40 nm or about 30 nm of the average of the average pore linear dimension (e.g., which is from about 2 nm to about 10 nm (e.g., about 0.6 nm to about 10 nm).

A porous carbon-doped layer (e.g., a porous carbon-doped metal oxide and/or metal layer) (which may be a nanoporous carbon-doped layer) can comprise various degrees of porosity (e.g., amounts of pores or the like). In various examples, a carbon-doped layer comprises a plurality of pores comprising about 5% pore volume to about 50% pore volume (based on the total volume of the porous carbon-doped layer), including all 0.1% pore volume values and ranges therebetween (e.g., about 10% pore volume to about 30% pore volume).

A porous carbon-doped layer (e.g., a carbon-doped metal oxide and/or metal layer) (which may be a nanoporous carbon-doped layer) can comprise various types of porosity. In various examples, the pores of the carbon-doped layer are interconnected (e.g., highly interconnected or the like) or the like and/or the substrate comprises a desirable pore density. In various examples, the carbon-doped layer comprises an open pore structure or the like.

In various examples, a carbon-doped layer is continuous. In various examples, a carbon-doped layer is substantially defect free or defect free. In various examples, a carbon-doped layer does not exhibit any observable defects (e.g., optically-observable defects or the like). In various examples, a defect or defects is/are pin-hole defects (such as, for example, pin-hole defects that do not exhibit substantially any or any selectivity (such as, for example, rejection or the like) or the like) or the like and/or pore(s) comprising a linear dimension (which may be a cross-sectional dimension, such as for example, a diameter, or the like) of greater than about 5 nm or greater than about 10 nm.

A porous carbon-doped layer (e.g., a porous carbon-doped metal oxide and/or metal layer, a porous carbon-doped metal oxide and/or metal layer or the like) is thermally stable (e.g., at temperatures up to about 250° C. or greater). In various examples, porous carbon-doped layer (e.g., a porous carbon-doped metal oxide and/or metal layer, a porous carbon-doped metal oxide and/or metal layer or the like) does not exhibit thermal degradation (e.g., substantial thermal degradation). In various examples, A porous carbon-doped layer (e.g., a porous carbon-doped metal oxide and/or metal layer, a porous carbon-doped metal oxide and/or metal layer or the like) is stable (e.g., at temperatures up to about 140° C. or greater or at temperatures up to about 250° C. or greater) to contact with organic solvent(s) (such as, for example, polar aprotic solvent(s) (e.g., dimethylformamide or the like), hydrocarbon solvent(s) (e.g., hexanes and the like), alcohols, or the like).

In various examples, a filtration substrate (or a substrate and/or one or more or all the carbon-doped layer(s), at least one or more or all of which are porous) is thermally stable (e.g., at temperatures up to about 250° C. or greater). In various examples, a filtration substrate (or a substrate and/or one or more or all the carbon-doped layer(s)) does not exhibit thermal degradation (e.g., substantial thermal degradation) and/or loss of efficacy (e.g., substantial loss of efficacy, which may be a measurable loss of efficacy) in a filtration method (such as, for example, an organic solvent nanofiltration method or the like) (which may be a method of the present disclosure), for example, at temperatures up to about 250° C. or greater. In various examples, a filtration substrate (or a substrate and/or one or more or all the carbon-doped layer(s), at least one or more or all of which are porous) is stable (e.g., at temperatures up to about 140° C. or greater or at temperatures up to about 250° C. or greater) to contact with organic solvent(s) (such as, for example, polar aprotic solvent(s) (e.g., dimethylformamide or the like), hydrocarbon solvent(s) (e.g., hexanes and the like), alcohols, or the like).

In various examples, a filtration substrate exhibits one or more desirable properties. In various examples, a filtration substrate exhibits one or more or all the following: a flux of greater than about 10 L m⁻² h⁻¹, greater than about 15 L m⁻² h⁻¹, or greater than about 20 L m⁻² h⁻¹ or about 10 L m⁻² h⁻¹ to about 200 L m⁻² h⁻¹, including all 0.1 L m⁻² h⁻¹ values and ranges therebetween; no substantial change in pore dimension(s) at temperatures up to about 250° C. or greater; a porosity/tortuosity factor of about 0.05 or greater or about 0.1 or greater or from about 0.05 to about 0.2, including all 0.005 values and ranges therebetween); a molecular weight cutoff value from about 200 g/mol to about 1,000 g/mol, including all 10 g/mol values and ranges therebetween (e.g., a molecular weight cutoff value of +/−about 50 g/mol from about any g/mol value from about 200 g/mol to about 1,000 g/mol, including all 10 g/mol values and ranges therebetween); or a rejection of about 80% or more, 90% or more, or about 100% of compounds having a molecular weight of about 200 g/mol to about 1,000 g/mol, including all 0.1 g/mol values and ranges therebetween (e.g., a molecular weight cutoff value of +/−about 50 g/mol from about 200 g/mol to about 1,000 g/mol, including all 10 g/mol values and ranges therebetween; or the like.

In an aspect, the present disclosure provides methods of making carbon-doped layers. In various examples, a method produces one or more carbon-doped layer(s) of the present disclosure. Non-limiting examples of methods of making carbon-doped filtration substrates are disclosed herein.

In various examples, a method of making a one or more carbon-doped layer(s) (such as, for example, porous carbon-doped layer(s)) (e.g., carbon-doped metal oxide and/or metal layer(s), porous carbon-doped metal oxide and/or metal layer(s), or the like) comprises contacting a substrate with one or more liquid carbon precursor(s) and optionally, water, where the liquid carbon precursor(s) is/are disposed on at least a portion of the substrate; optionally, holding the substrate and carbon precursor(s) for a desired time and/or temperature; optionally, drying or removing excess liquid precursor(s); contacting the substrate with liquid precursor(s) and, optionally, water disposed thereon with one or more metal and/or metal oxide precursor(s) (e.g., vapor-phase metal and/or metal oxide precursor(s) and/or liquid-phase metal and/or metal oxide precursor(s) or the like), where a precursor layer (such as, for example, an organometallic hybrid film (OHF) (such as, for example a non-porous organometallic hybrid film (OHF) or the like) is formed; optionally, contacting the precursor layer (e.g., with water, aqueous solution, organic solvent(s) or the like) to remove undesirable material(s) (such as, for example, unreacted liquid carbon precursor(s), unreacted metal/metal oxide precursor(s), by-products thereof, degradation product(s) thereof, or the like, or any combination thereof). In various examples, a method further comprises heating the precursor layer, where the one or more carbon-doped layer(s) (such as, for example, porous carbon-doped layer(s)) (e.g., carbon-doped metal oxide and/or metal layer(s), porous carbon-doped metal oxide and/or metal layer(s), or the like) is/are formed.

In various examples, a method of making a filtration substrate comprises: contacting a substrate with one or more liquid carbon precursor(s) (e.g., for a desired time and/or at a desired temperature) (and optionally, water, such as, for example, about 5% by weight to about 40% by weight (e.g., from about 10% by weight to about 30% by weight), based on the total weight of liquid carbon precursor(s) and water, including all 0.1% by weight values and ranges therebetween), where the liquid carbon precursor(s) are disposed on at least a portion of the substrate (e.g., in the case of a porous substrate, the liquid carbon precursor(s) at least partially fill the pores of the substrate); optionally, holding the substrate and carbon precursor(s) for a desired time and/or temperature; optionally, drying or removing excess liquid precursor(s); contacting the substrate with liquid precursor(s) disposed thereon with one or more metal and/or metal oxide precursor(s) (e.g., vapor-phase metal and/or metal oxide precursor(s) and/or liquid-phase metal and/or metal oxide precursor(s) or the like) (e.g., for a desired time and/or at a desired temperature) (which may be a dried substrate with liquid precursor(s) disposed thereon), where a precursor layer (such as, for example, an organometallic hybrid film (OHF) (such as, for example a non-porous organometallic hybrid film (OHF) or the like), which may be continuous and/or non-porous and/or dense (e.g., no observable liquid or as permeation) and/or hydrophobic; optionally, contacting the precursor layer (e.g., water, aqueous solution, organic solvent(s) or the like) to remove undesirable material(s) (such as, for example, unreacted liquid carbon precursor(s), unreacted metal/metal oxide precursor(s), by-products thereof, degradation product(s) thereof, or the like, or any combination thereof); and heating (e.g., calcining) precursor layer (which may be a washed precursor layer) (e.g., for a desired time and/or at a desired temperature) (e.g., in an inert or oxidizing atmosphere, such as, for example, air, nitrogen, argon) (e.g., at ambient pressure or under vacuum), where the filtration substrate is formed.

A method can use various liquid carbon precursor(s). Without intending to be bound by any particular theory, it is considered a liquid carbon precursor or liquid carbon precursors react(s) to form at least a portion or all the carbon in a carbon-doped layer. In various examples, a liquid carbon precursor reacts to form at least a portion of the carbon in a carbon-doped layer. In various examples, a liquid carbon precursor is a carbon source or the like. In various examples, a liquid carbon precursor comprises two or more (e.g., 2, 4, 4, 5, or more) hydroxyl groups. In various examples, at least a portion of or all the liquid carbon precursor(s) comprise(s) two or more hydroxyl groups that can react to form crosslinked liquid carbon precursor(s). In various examples, at least a portion of or all the liquid carbon precursor(s) is/are chosen from polyols, and the like, and any combination thereof. In various examples, the polyol(s) are C₂, C₃, C₄, C₅, C₆, C₇, C₈, C₉, C₁₀, C₁₁, or C₁₂ polyols. In various examples, the polyol(s) are glycols (e.g., C₂, C₃, C₄, C₅, C₆, C₇, C₈, C₉, C₁₀, C₁₁, or C₁₂ glycols) or the like. In various examples, liquid carbon precursor(s) exhibit(s) low vapor pressure.

A method can use various metal and/or metal oxide precursor(s). Without intending to be bound by any particular theory, it is considered a metal and/or metal oxide precursor (e.g., a vapor-phase metal and/or metal oxide precursor and/or a liquid-phase metal and/or metal oxide precursor) reacts to form at least a portion or all the metal and/or metal oxide in a carbon-doped layer. In various examples, a metal and/or metal oxide precursor (e.g., a vapor-phase metal and/or metal oxide precursor and/or a liquid-phase metal and/or metal oxide precursor) reacts to form at least a portion of the metal and/or metal oxide in a carbon-doped layer. In various examples, a vapor-phase metal and/or a metal oxide precursor comprises one or more transition metal(s) or the like. In various examples, metal and/or metal oxide precursor(s) (e.g., vapor-phase metal and/or metal oxide precursor(s) and/or liquid-phase metal and/or metal oxide precursor(s)) is/are a metal halide or the like, or a combination thereof. In various examples, metal and/or metal oxide precursor(s) (e.g., vapor-phase metal and/or metal oxide precursor(s) and/or liquid-phase metal and/or metal oxide precursor(s)) is/are chosen from metal halides (e.g., metal fluorides, metal chlorides, metal bromides, or metal iodides) or the like. In various examples, the metal halide(s) are chosen from titanium halides, zinc halides, tungsten halides, copper halides, tin halides, or the like, or any combination thereof. In various examples, a vapor-phase metal and/or metal oxide precursor is (or all vapor-phase metal and/or metal oxide precursor(s) are) stable at a temperature and/or pressure at which the precursor(s) exhibit(s) desirable vapor pressure.

In various examples, metal and/or metal oxide precursor(s) (e.g., vapor-phase metal and/or metal oxide precursor(s) and/or liquid-phase metal and/or metal oxide precursor(s)) react to form a metal and/or metal oxide domain in a carbon-doped layer (such as, for example, a porous carbon-doped layer (e.g., a carbon-doped metal oxide and/or metal layer, which may be porous). In various examples, a metal domain is a fully reduced metal domain. In various examples, a metal oxide domain is a fully oxidized (e.g., stoichiometric or the like) metal oxide domain, incompletely oxidized (e.g., sub-stoichiometric or the like) metal oxide domain. Without intending to be bound by any particular theory, it is considered selection of reaction condition(s) (such as, for example, temperature, time, atmosphere, or the like, or any combination thereof) to provide a desired carbon-doped layer composition is within the purview of one having skill in the art.

In various examples, a substrate (which may be a porous substrate) is contacted with one or more liquid carbon precursor(s) and optionally, water, where the liquid carbon precursor(s) and, optionally, water are disposed on at least a portion of the substrate. In various examples, a porous substrate is contacted with one or more liquid carbon precursor(s) and optionally, water, where the liquid carbon precursor(s) and, optionally, water are disposed in at least a portion, substantially all, or all the substrate pores. In various examples, a substrate, carbon precursor(s), and optionally, water are held for a desired time and/or temperature. In various examples, the contacting and optionally, the holding is repeated a desired number of times. In various examples, carbon-doped layer(s) (such as, for example, carbon-doped metal oxide and/or metal layer(s) or the like) is/are formed. In various examples, precursor layer(s) or the like is/are formed.

A substrate may be contacted with various amounts of water. In various examples, a substrate is contacted with about 10 to about 30 weight % (wt. %) water (based on the total weight of liquid carbon precursor(s) and water), including all 0.1 wt. % values and ranges therebetween. Without intending to be bound by any particular theory, it is considered the amount of water may be a factor related to the amount carbon in the carbon-doped layer.

In various examples, a plurality of layers comprising one or more liquid carbon precursor(s) and optionally, water is formed. In various examples, all the layers comprising one or more liquid carbon precursor(s) and optionally, water are substantially the same or the same or two or more of the layers comprising one or more liquid carbon precursor(s) and optionally, water are different (e.g., structurally and/or compositionally different) than one or more of the other layers comprising one or more liquid carbon precursor(s) and optionally, water.

In various examples, a substrate comprising liquid carbon precursor(s) and optionally, water disposed thereon is contacted with one or more metal and/or metal oxide precursor(s) (e.g., vapor-phase metal and/or metal oxide precursor(s) and/or liquid-phase metal and/or metal oxide precursor(s)) forming a precursor layer (such as, for example, an organometallic hybrid film (OHF) (such as, for example a non-porous organometallic hybrid film (OHF) or the like). Without intending to be bound by any particular theory, it is considered the vapor-phase metal and/or metal oxide precursor(s) react with the liquid carbon precursor(s) at the liquid-vapor interface formed by the precursor(s) and source(s). In various examples, a vapor-phase metal and/or metal oxide precursor(s) react with liquid carbon precursor(s) in a self-terminating interfacial reaction or the like.

In various examples, carbon-doped layer(s) (such as, for example, carbon-doped metal oxide and/or metal layer(s) or the like) (e.g., precursor layer(s)) is/are subjected to one or more additional process(es). In various examples, a precursor layer is contacted (such as, for examples, washed or the like) with one or more liquid(s) (such, as for example, water, an aqueous solution, organic solvent(s) (e.g., hydrocarbon solvents, such as, for example, toluene, water, or the like, or any combination thereof). Without intending to be bound by any particular theory, it is considered this contacting removes undesirable material(s) (such as, for example, unreacted liquid carbon precursor(s), unreacted metal/metal oxide precursor(s), by-products thereof, degradation product(s) thereof, or the like, or any combination thereof). In various examples, a substrate, liquid carbon precursor(s), and optionally, water are dried and/or excess liquid carbon precursor(s) are removed from a substrate and carbon precursor(s). In various examples, a substrate and liquid carbon precursor(s), and optionally, water are contacted at an elevated temperature to remove bubbles, facilitate coating of the substrate, or the like, or any combination thereof.

In various examples, carbon-doped layer(s) (such as, for example, carbon-doped metal oxide and/or metal layer(s) or the like) (e.g., precursor layer(s)) is/are heated. Without intending to be bound by any particular theory, it is considered heating can remove a portion of the carbon from the carbon-doped layer(s) (e.g., precursor layer(s)) resulting in formation of pores. In various examples, heating forms one or more porous carbon-doped layer(s) (such as, for example, porous carbon-doped metal oxide and/or metal layer(s)) (which may be a nanoporous carbon-doped layer(s)), a filtration substrate, or the like. In various examples, a heating comprises calcining carbon-doped layer(s) (e.g., precursor layer(s)) (which may be a washed and/or dried carbon-doped layer(s)). In various examples, carbon-doped layer(s) (e.g., precursor layer(s)) is heated (e.g., calcined or the like) for a desired time and/or at a desired temperature and/or in an inert or oxidizing atmosphere, such as, for example, air, nitrogen, argon, or the like) and/or at ambient pressure or under vacuum. In various examples, carbon-doped layer(s) (e.g., precursor layer(s)) is/are heated at or to a temperature of about 200° C. to about 500° C., including all 0.1° C. values and ranges therebetween.

In various examples, a method is repeated a desired number of times to form a plurality of carbon-doped layers (such as, for example, porous carbon-doped layers) (e.g., carbon-doped metal oxide and/or metal layers, porous carbon-doped metal oxide and/or metal layer, or the like). In various examples, all the carbon-doped layers are substantially the same or the same or two or more of the precursor layers are different (e.g., structurally and/or compositionally different) than one or more of the other precursor layer(s).

The methods comprise various reactions and processes. A reaction or process can be performed under various reaction conditions (e.g., time, temperature, pressure, or the like, or any combination thereof).

A reaction can be carried out for various times. The reaction time can depend on factors such as, for example, temperature, atmosphere, pressure, presence and/or reactivity of the carbon sourc(es) and vapor-phase metal and/or metal oxide precursor(s), presence and/or intensity of an applied energy source, mixing (e.g., stirring, grinding, or the like), or the like, any a combination thereof. In various examples, reaction times range from about several minutes to greater than about 2 hours, including all integer second values and ranges), or any combination thereof (e.g., where each step is performed at a different time as other steps).

In an aspect, the present disclosure provides systems. In various examples, a system comprises one or more carbon-doped layer(s) (such as, for example, porous carbon-doped layer(s)) (e.g., a carbon-doped metal oxide and/or metal layer, a porous carbon-doped metal oxide and/or metal layer or the like) of the present disclosure and/or comprises one or more carbon-doped layer(s) (such as, for example, porous carbon-doped layer(s)) (e.g., a carbon-doped metal oxide and/or metal layer, a porous carbon-doped metal oxide and/or metal layer or the like) made by a method of present disclosure. Non-limiting examples of systems are disclosed herein.

In various examples, a system is a separation system or the like. In various examples, a separation system comprises one or more carbon-doped filtration substrate(s) of the present disclosure and/or one or more carbon-doped filtration substrate(s) made by a method of present disclosure.

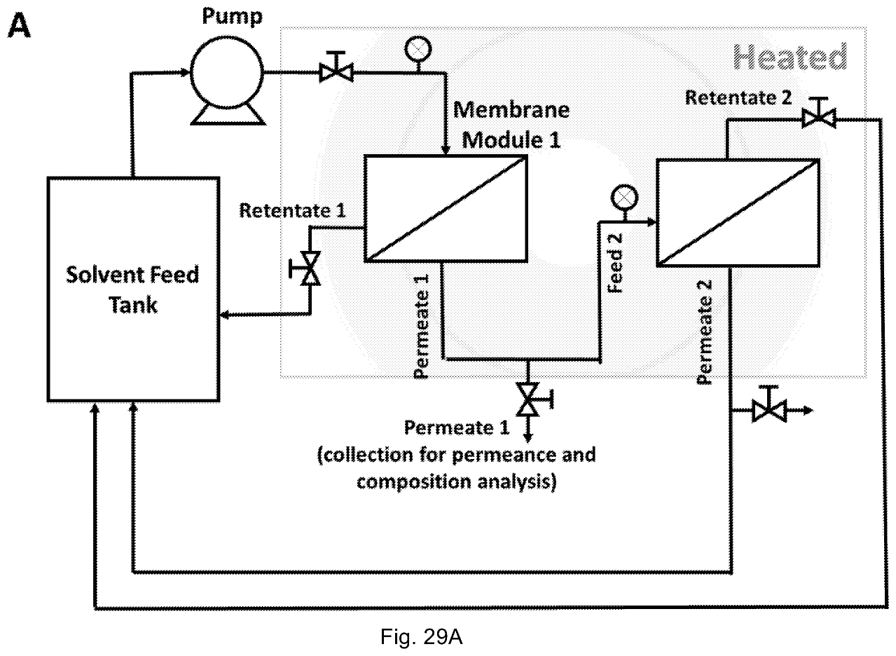

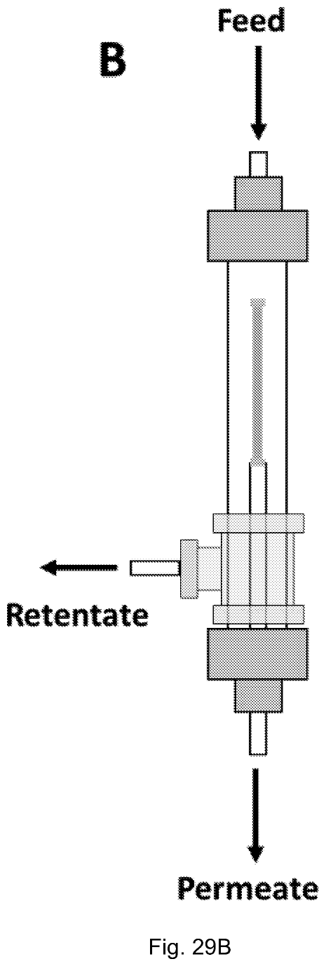

In various examples, a system (which may be a filtration system a separation system or the like) comprises one or more filtration substrate(s). In various examples, a system is a 2 stage membrane cascade system or the like. In various examples, one or more filtration substrate(s) is/are disposed in a housing, the housing comprising one or more orafic(es). In various examples, a system further comprises one or more additional components typically used in a filtration system (such as, for example, pump(s), mass/flow controller(s), reservoir(s), tank(s), pressure gauges, or the like, or any combination thereof, which may or may not be in fluid contact with the filtration substrate(s). In various examples, the filtration substrate(s) is/are disposed in a housing, the housing comprising one or more orafic(es), which may be in fluid contact with one or more additional component(s). In various examples, a system comprises one or more or all the features of the system described in FIG. 29B. In various examples, a system is configured for normal flow filtration, tangential flow filtration, or the like, or any combination thereof.

In various examples, a system is configured to operate at a pressure of at least about 20 bar or greater (e.g., about 70 bar or greater). In various examples, a system is configured to operate at a pressure of at least about 20 bar to about 120 bar, including all integer bar values and ranges therebetween (e.g., about 20 bar to about 100 bar). In various examples, a system is configured to operate at a temperature of about 0° C. to about 100° C., including all 0.1° C. values and ranges therebetween. In the case, where the system is configured to reject/retain solvent(s), the solvent flux is greater than about 500>/m²/h.

In various examples, a system is configured to clean one or more or all the filtration substrate(s) (such as, for example, for reuse of the filtration substate(s). In various examples, a system is configured to clean one or more or all the filtration substrates prior to use in each of the subsequent filtrations. In various examples, a system is configured to clean one or more or all the filtration substrates by heating the filtration substrate(s) at or to a temperature of about 0° C. to about 100° C., including all 0.1° C. values and ranges therebetween and/or using solvent(s) (e.g., polar aprotic solvent(s), such as, for example, dimethylformamide, or the like, or any combination thereof) and/or at elevated temperature (e.g., about 100° C. or greater, such as for example, to below the boiling point of one or more of the solvent(s)).

In an aspect, the present disclosure provides uses of carbon-doped layers of the present disclosure. Non-limiting examples of uses of carbon-doped layers are disclosed herein.

In various examples, a carbon-doped filtration substrate or carbon-doped filtration substrates (or a system comprising carbon-doped filtration substrate(s)) is/are used in a separation process. In various examples, the separation process is a filtration process. In various examples, the separation process is an OSN application (such as, for example, an OSN filtration or the like). In various examples, a carbon-doped filtration substrate or carbon-doped filtration substrates is used to separate (e.g., reject or the like) molecules, such as, for example, molecules with size ranging from about 240 Da to about 1,000 Da, including all 0.1 Da values and ranges therebetween, or the like, from organic solvent(s).

In various examples, a method of separating one or more compound(s) from a composition (such as, for example, a mixture, which may be a solution, a suspension, or the like) comprises: contacting the composition with one or more carbon-doped filtration substrate(s), where the one or more compound(s) are separated from the mixture. In various examples, separation (such as, for example, rejection, remove/recover (e.g., isolate or the like)) of one or more or the compound(s) from a composition is independent of charge of the carbon-doped filtration substrate(s). In various examples, a separation is a non-thermal separation or the like.

A separation process (such as, for example, a method of separating one or more compound(s) from a composition or the like) may be carried out under an applied pressure. In various examples, the contacting is carried out under applied pressure. In various examples, pressurizing a composition (e.g., a mixture or the like) of larger solute(s) (molecular size: about 200 Da to 1,000 Da) in organic solvents and contacting the pressurized composition with one or more carbon-doped filtration substrate(s) results in rejection of substantially all or all the larger molecule solute(s) while allowing smaller solvent molecules to permeate through the carbon-doped filtration substrate(s). In various examples, the separation is carried out with no observable phase change or the like. In various examples, the method is an organic solvent nanofiltration (OSN) or the like.

A separation process (such as, for example, a method of separating one or more compound(s) from a composition or the like) can be carried out at various temperatures and/or pressures. A separation process (such as, for example, a method of separating one or more compound(s) from a composition or the like) is carried out at a temperature of about 0° C. to about 40° C., including all 0.1° C. values and ranges therebetween, and/or a pressure of at least about 20 bar to about 120 bar, including all integer bar values and ranges therebetween (e.g., about 20 bar to about 100 bar).

A separation process (such as, for example, a method of separating one or more compound(s) from a composition or the like) can be performed under various reaction conditions. A separation process can comprise one or more steps and each step can be performed under the same or different reaction conditions as other steps. A separation process can be performed under various conditions (e.g., time, temperature, atmosphere, pressure, or the like, or any combination thereof).

In various examples, a composition is a reaction mixture (such as, for example, a pharmaceutical reaction mixture, a specialty chemical reaction mixture, a process product, or the like) and a method is used to separate (such as, for example, reject, remove/recover (e.g., isolate or the like), or the like) at least a portion of (e.g., substantially all or all) reaction/process product(s) (e.g., APIs, lube oil, vegetable oil, or the like), remove/recover solvent(s) (such as, for example, hydrocarbons (such as, for example, alkanes (e.g., hexanes and the like) and the like), alcohols (such as, for example, methanol, ethanol, and the like), and the like), remove/recover reaction component(s), remove/recover homogeneous catalyst(s), or the like, or a combination thereof from the composition.

In various examples, one or more compound(s) are chosen from reaction component(s). Non-limiting examples of reaction components include reaction product(s), reaction by-product(s), reactant component degradation product(s), catalyst(s) (which may be homogeneous catalysts or the like), solvent(s), and the like, and any combination thereof.

In various examples, at least a portion of the reaction component(s) comprises one or more small molecules(s). In various examples, at least a portion of the reaction component(s) comprises small molecule(s) independently having a molecular weight of about 200 g/mol to about 1,000 g/mol, including all 10 g/mol values and ranges therebetween.

In various examples, a composition comprises lube oil (such as, for example, a composition used in the oil and gas industry. In various examples, at least a portion of, substantially all or all the lube oil is removed/recovered (e.g., rejected, isolated, or the like).

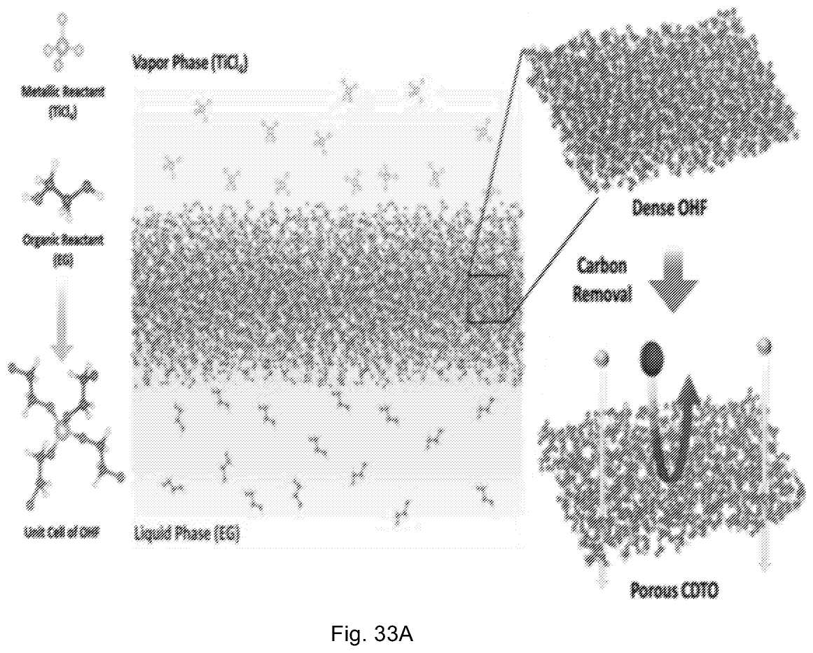

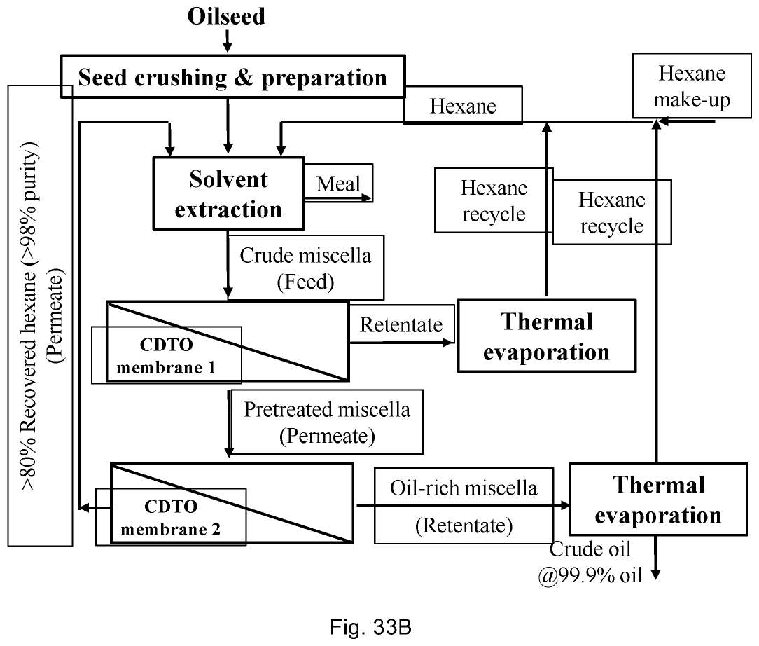

In various examples, a composition comprises vegetable oil(s) and organic solvent(s) and at least a portion of, substantially all or all the vegetable oil(s) and/or organic solvent(s) is/are removed/recovered (e.g., rejected, isolated, or the like). Non-limiting examples of vegetable oil removal/recovery are shown in FIG. 33B. In various examples, a composition comprises vegetable oil(s) and organic solvent(s) and substantially all or all the vegetable oil(s) and/or organic solvent(s) is/are removed/recovered. Non-limiting examples of vegetable oils include soybean oil, and the like, and combinations thereof. Non-limiting examples of organic solvents include hexanes, and the like, and combinations thereof.

In various examples, the vegetable oil(s) are soybean oil and the solvent(s) is/are hexanes. In these examples, in various examples, at least a portion or the filtration substrate(s) is/are CDTO membranes or the like. In various examples, the method is carried out at a pressure of at least about 70 bar or greater and/or a temperature of about 0° C. to about 40° C., including all 0.1° C. values and ranges therebetween. In various examples, the solvent flux is greater than about 500>/m²/h. In various examples, about 80% or greater of the hexanes is recovered (e.g., without a phase change). In various examples, the soybean oil product produced by the method comprises about 99.5% by weight or more, about 99.9% by weight, about 99.95% by weight, about 99.99% by weight, or about 100% by weight soybean oil (based on the total weight of the soybean oil product).

In various examples, one or more or all the filtration membrane(s) is/are reused in a subsequent filtration (such as, for example, a second filtration, a third filtration, etc.). In various examples, filtration membranes(s) is/are cleaned prior to use in each of the subsequent filtrations. In various examples, the filtration membrane(s) is/are cleaned prior to reuse by solvent washing under elevated temperatures. In various examples, the filtration membrane(s) is/are cleaned prior to reuse by solvent washing under elevated temperatures. In various examples, cleaning is carried out using solvent(s) (e.g., polar aprotic solvent(s), such as, for example, dimethylformamide, or the like, or any combination thereof) at elevated temperature (e.g., 100° C. or greater, such as for example, to below the boiling point of one or more of the solvent(s)).

The following Statements describe various examples of methods of polymer sequencing and/or imaging and systems of the present disclosure and are not intended to be in any way limiting:
Statement 1. A filtration substrate (e.g., a filtration membrane or the like) comprising a substrate (which may be a porous substrate) and a porous carbon-doped layer (e.g., a carbon-doped metal oxide and/or metal layer) (which may be a nanoporous carbon-doped layer) disposed on at least a portion of a surface or surfaces (which may be an exterior surface or exterior surfaces, a pore surface or pore surfaces, or the like, or any combination thereof) of the substrate.
Statement 2. A filtration substrate according to Statement 1, where the substrate is planar, a fiber (which may be a hollow fiber or the like), or the like.
Statement 3. A filtration substrate according to Statement 1 or 2, where the substrate is (or comprises) one or metal(s), one or more ceramic material(s), or the like.
Statement 4. A filtration substrate according to any of the preceding Statements, where the substrate is (or comprises) a metal chosen from stainless steel, titanium, zirconium, tin, tungsten, or the like, or any combination thereof.
Statement 5. A filtration substrate according to any of the preceding Statements, where the substrate is (or comprises) a ceramic material chosen from aluminum oxide, titanium oxide, zirconium oxide, tin oxide, tungsten oxide or the like, or any combination thereof.
Statement 6. A filtration substrate according to any of the preceding Statements, where the carbon-doped layer has (or comprises) at least one linear dimension (which may be a cross-sectional dimension or a dimension linear dimension substantially perpendicular (or perpendicular) to a longest linear dimension of the layer, or the like) of about 2 nm to about 200 nm (e.g., about 2 nm to about 100 nm, about 5 nm to about 50 nm, about 20 nm to about 200 nm, or about 35 to about 150 nm), including all 0.1 nm values and ranges therebetween.
Statement 7. A filtration substrate according to any of the preceding Statements, where the carbon-doped layer is (or comprises) a carbon-doped metal, a carbon-doped metal oxide, or the like, or any combination thereof.
Statement 8. A filtration substrate according to any of the preceding Statements, where the carbon-doped layer is (or comprises) a carbon-doped titanium oxide (e.g., a carbon-doped titanium dioxide or the like) and/or zirconium metal, a carbon-doped zirconium oxide (e.g., a carbon-doped zirconium dioxide or the like) and/or zirconium metal, carbon-doped tungsten oxide and/or tungsten metal, carbon-doped zinc oxide and/or zinc metal, carbon-doped copper oxide and/or copper metal, carbon-doped tin oxide and/or tin metal, or the like, or any combination thereof.
Statement 9. A filtration substrate according to any of the preceding Statements, where the carbon-doped layer comprises about 30 to about 60% (which may be mol % or at. %) carbon, as measured by X-ray Photoelectron Spectroscopy, including all 0.1 mol % or at % values and ranges therebetween).
Statement 10. A filtration substrate according to any of the preceding Statements, where the carbon-doped layer comprises about 40 to about 70% (which may be mol % or at. %) metal and/or metal oxide, as measured by X-ray Photoelectron Spectroscopy, including all 0.1 mol % or at % values and ranges therebetween).
Statement 11. A filtration substrate according to any of the preceding Statements, where the carbon-doped layer comprises a plurality of pores comprising at least one linear dimension (which may be a cross-sectional dimension, such as for example, a diameter, or the like) (which may be average pore dimension(s)) of about 2 nm to about 10 nm (e.g., about 0.6 nm to about 10 nm), including all 0.1 nm values and ranges therebetween.
Statement 12. A filtration substrate according to any of the preceding Statements, where the carbon-doped layer comprises a plurality of pores comprising about 5% pore volume to about 50% pore volume, including all 0.1% pore volume values and ranges therebetween (e.g., about 10% pore volume to about 30% pore volume).
Statement 13. A filtration substrate according to any of the preceding Statements, where the filtration substrate exhibits one or more or all of the following:
   a flux of greater than about 10 L m⁻² h⁻¹, greater than about 15 L m⁻² h⁻¹, or greater than about 20 L m⁻² h⁻¹ or about 10 L m⁻² h⁻¹ to about 200 L m⁻² h⁻¹, including all 0.1 L m⁻² h⁻¹ values and ranges therebetween;
   no substantial change in pore dimension(s) at temperatures up to about 250° C. or greater;
   a porosity/tortuosity factor of about 0.05 or greater or about 0.1 or greater or from about 0.05 to about 0.2, including all 0.005 values and ranges therebetween)·
   a molecular weight cutoff value from about 200 g/mol to about 1,000 g/mol, including all 10 g/mol values and ranges therebetween (e.g., a molecular weight cutoff value of +/−about 50 g/mol from about 200 g/mol to about 1,000 g/mol, including all 10 g/mol values and ranges therebetween);
   a rejection of about 80% or more, 90% or more, or about 100% of compounds having a molecular weight of about 200 g/mol to about 1,000 g/mol, including all 0.1 g/mol values and ranges therebetween (e.g., a molecular weight cutoff value of +/−about 50 g/mol from about 200 g/mol to about 1,000 g/mol, including all 10 g/mol values and ranges therebetween; or the like.
Statement 14. A method of making a filtration substrate comprising a substrate (which may be a porous substrate) and a porous carbon-doped layer (e.g., a carbon-doped metal oxide and/or metal layer) (which may be a nanoporous carbon-doped layer) disposed on at least a portion of a surface or surfaces (which may be an exterior surface or exterior surfaces, a pore surface or pore surfaces, or the like, or any combination thereof) of the substrate (which may be a filtration substrate of any of the preceding Statements), the method comprising contacting a substrate with one or more liquid carbon precursor(s) (e.g., for a desired time and/or at a desired temperature) (and optionally, water, such as, for example, about 5% by weight to about 40% by weight (e.g., from about 10% by weight to about 30% by weight), based on the total weight of liquid carbon precursor(s) and water, including all 0.1% by weight values and ranges therebetween), where in the liquid carbon precursor(s) are disposed on at least a portion of the substrate (e.g., in the case of a porous substrate, the liquid carbon precursor(s) at least partially fill the pores of the substrate); optionally, holding the substrate and carbon precursor(s) for a desired time and/or temperature; optionally, drying or removing excess liquid precursor(s); contacting the substrate with liquid precursor(s) disposed thereon with one or more vapor-phase metal and/or metal oxide precursor(s) (e.g., for a desired time and/or at a desired temperature) (which may be a dried substrate with liquid precursor(s) disposed thereon), where a precursor layer (e.g., a metallo-organic layer), which may be continuous and/or non-porous and/or dense (e.g., no observable liquid or as permeation) and/or hydrophobic, is formed; optionally, contacting the precursor layer (e.g., water, aqueous solution, organic solvent(s) or the like) to remove undesirable material(s) (such as, for example, unreacted carbon source(s), unreacted metal/metal oxide precursor(s), by-products thereof, degradation product(s) thereof, or the like, or any combination thereof); and heating (e.g., calcining) precursor layer (which may be a washed precursor layer) (e.g., for a desired time and/or at a desired temperature) (e.g., in an inert or oxidizing atmosphere, such as, for example, air, nitrogen, argon) (e.g., at ambient pressure or under vacuum), where the filtration substrate comprising the substrate (which may be a porous substrate) and the porous carbon-doped layer (e.g., a porous carbon-doped metal oxide and/or metal layer) (which may be a nanoporous carbon-doped layer) disposed on at least a portion of a surface or surfaces (which may be an exterior surface or exterior surfaces, a pore surface or pore surfaces, or the like, or any combination thereof) of the substrate is formed.
Statement 15. A method according to Statement 14, where the carbon sourc(es) is/are chosen from polyols, and the like, and any combination thereof.
Statement 16. A method according to Statement 14 or 15, where the vapor-phase metal and/or metal oxide precursor(s) are chosen from metal halides (e.g., metal fluorides, metal chlorides, metal bromides, or metal iodides), or the like.
Statement 17. A system (which may be a filtration system) comprising one or more filtration substrate(s) of the present disclosure (such as, for example, a filtration substrate/substrates of any of Statements 1-13 and/or a filtration substrate/substrates made by a method of present disclosure, such as, for example, a method of any of Statements 14-16).
Statement 18. A system according to Statement 17, where the filtration substrate(s) is/are disposed in a housing, the housing comprising one or more orafic(es).
Statement 19. A method of separating one or more compound(s) from a composition (such as, for example, a mixture, which may be a solution, a suspension, or the like), the method comprising contacting the composition (e.g., the mixture or the like) with one or more substrates of the present disclosure (such as, for example, a substrate/substrates of any of Statements 1-13 and/or a substrate/substrates made by a method of present disclosure, such as, for example, a method of any of Statements 14-16, and/or a system of the present disclosure, such as, for example, a system of Statement 17 or 18), where the one or more compound(s) are separated from the mixture.
Statement 20. A method according to Statement 19, where the method is an organic solvent nanofiltration.
Statement 21. A method according to Statement 19 or 20, where the mixture is a reaction mixture (such, as for example, a pharmaceutical reaction mixture, or the like), or the like.
Statement 22. A method according to any of Statements 19-21, where the one or more compound(s) are chosen from reaction component(s) (such as, for example, reactant(s) or the like), reaction product(s), reaction by-product(s), reactant component degradation product(s), catalyst(s) (which may be homogeneous catalysts or the like), solvent(s), or the like.
Statement 23. A method according to any one of Statements 19-22, where the filtration membrane(s) is/are reused in a subsequent filtration (such as, for example, a second filtration, a third filtration, etc.).
Statement 24. A method according to Statement 23, where the filtration membranes(s) are cleaned prior to use in each of the subsequent filtrations.

The steps of the methods described in the various embodiments and examples disclosed herein are sufficient carry out the methods of the present disclosure. Thus, in an embodiment or example, a method consists essentially of a combination of the steps of the methods disclosed herein. In another embodiment or example, a method consists of such steps.

The following examples are presented to illustrate the present disclosure. They are not intended to be limiting in any manner.

### Example 1

The following are examples of carbon-doped membranes of the present disclosure and methods of making and uses of same.

Membranes with molecular-sized, high-density nanopores, which are stable under industrially relevant conditions, are needed to decrease energy consumption for separations. An interfacial process to generate nanoporous, carbon-doped titanium oxide (CDTO) nanofilms for molecular separation was developed. For a given pore size, CDTO nanofilms have 2-10 times higher pore density (tortuosity normalized) than reported and commercial organic solvent nanofiltration (OSN) membranes, yielding ultra-high solvent permeance, even if they are thicker. Owing to the mechanical, chemical, and thermal stabilities, CDTO nanofilms with designable, rigid nanopores exhibited long-term stable and efficient organic separation under harsh conditions. This is expected to facilitate large scale OSN application in new fields where polymeric membranes may fail.

High-density nanopores with low tortuosity were envisioned as effective way of significantly increasing permeance. Although it is challenging to increase pore density without merging small nanopores into larger ones, this strategy can greatly enhance membrane permeance, avoiding pitfalls of pushing membrane thickness to their thinnest limit.

Membranes with molecular-sized pores were extended to highly efficient solvent separation in harsh environments by developing stable inorganic nanofilms with high-density rigid nanopores, via an interfacial reaction. Utilizing a self-terminating interfacial reaction between metallic and organic reactants and subsequent calcination, defect-free, continuous nanoporous films were fabricated on different porous supports. Simple adjustment to synthesis and calcination conditions allowed precise tuning of these nanopores, at a molecular weight cut-off (MWCO) step change as small as ˜100 Da, to prepare a series of membranes within the organic solvent nanofiltration (OSN) range.

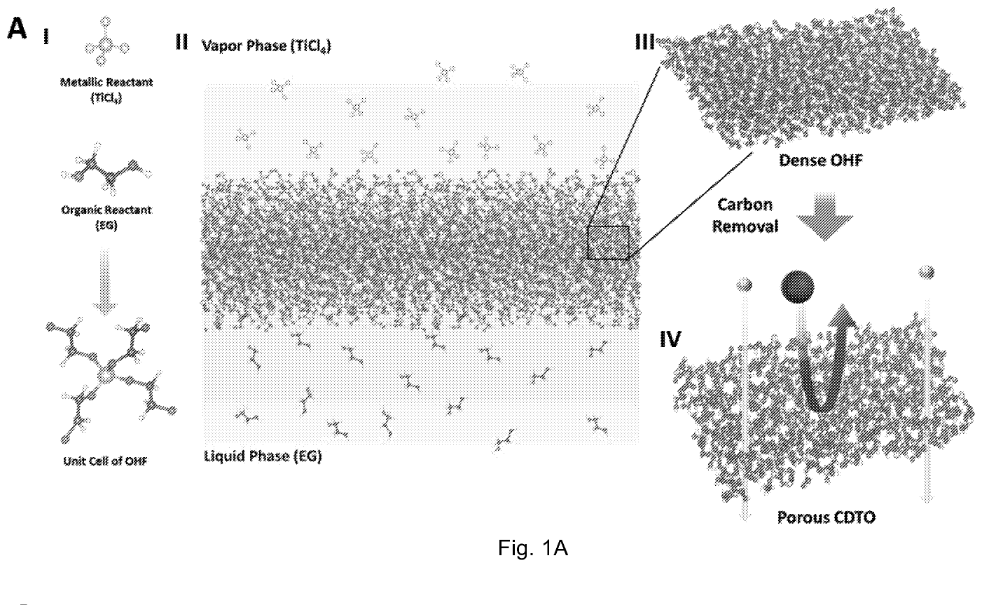

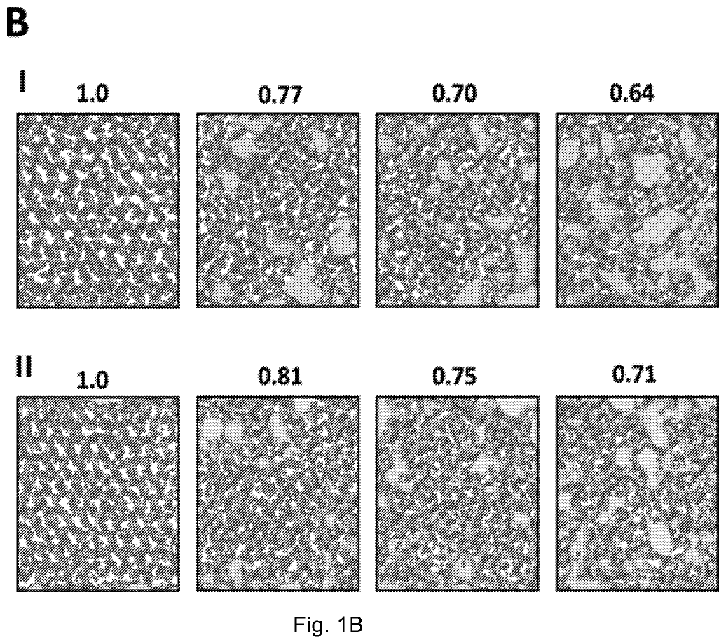

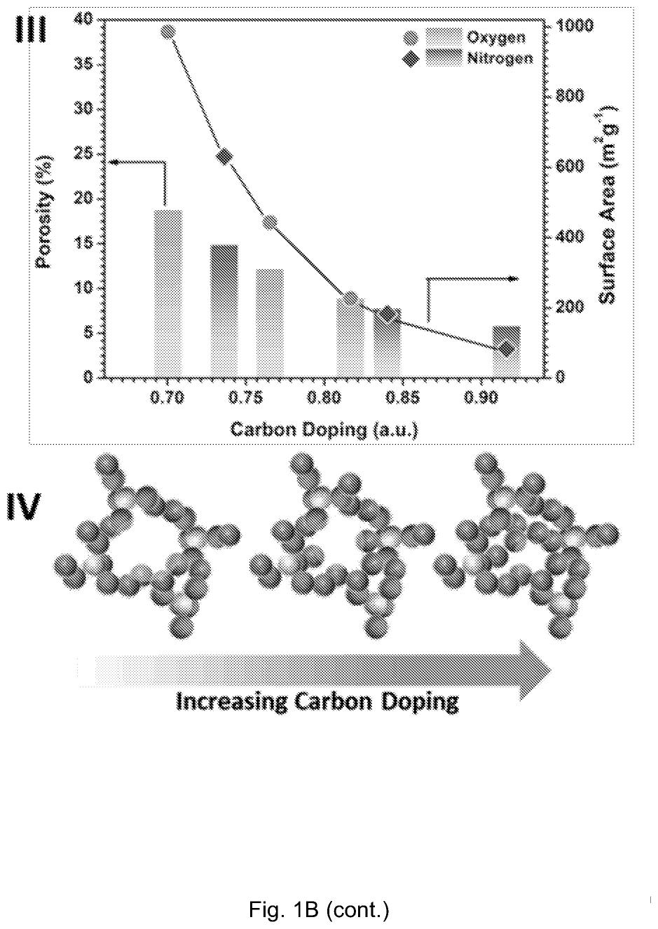

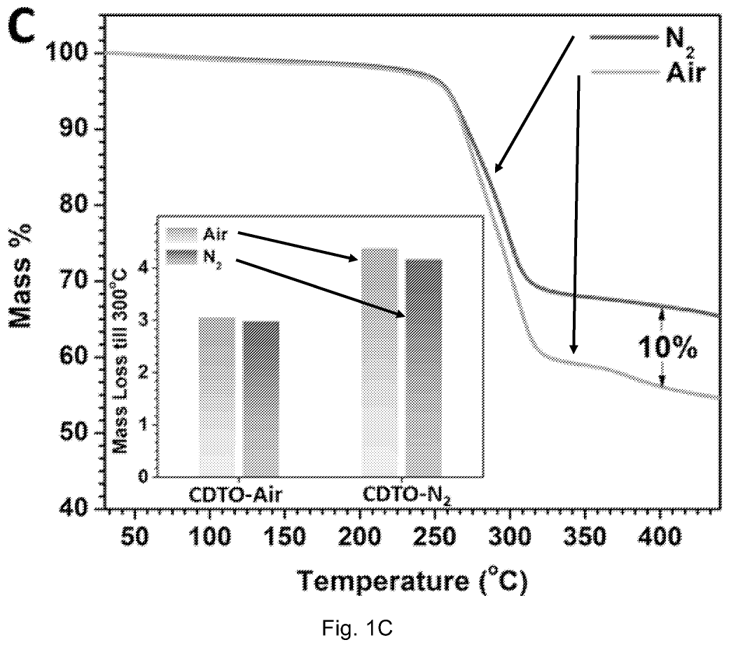

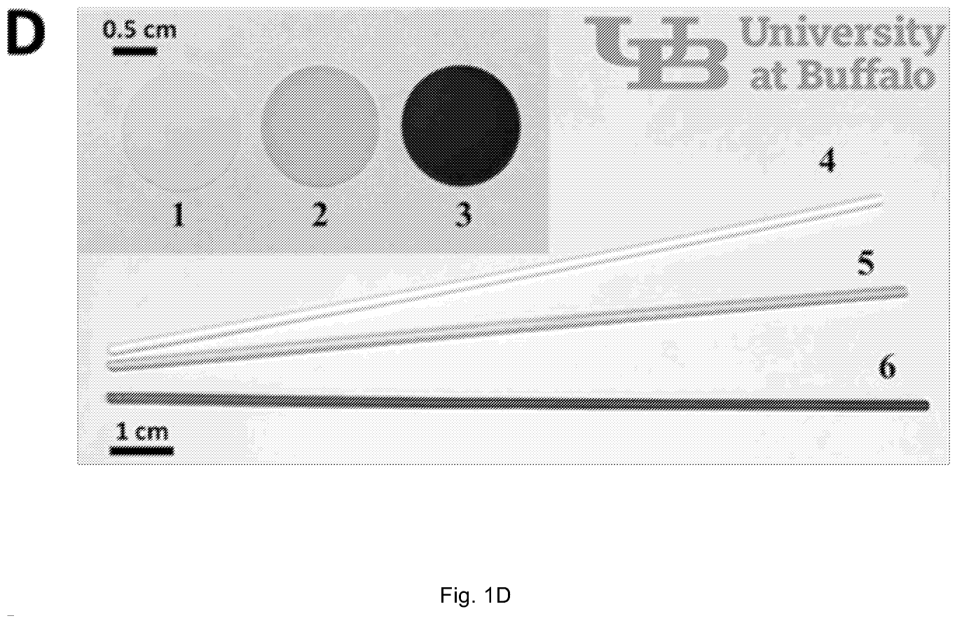

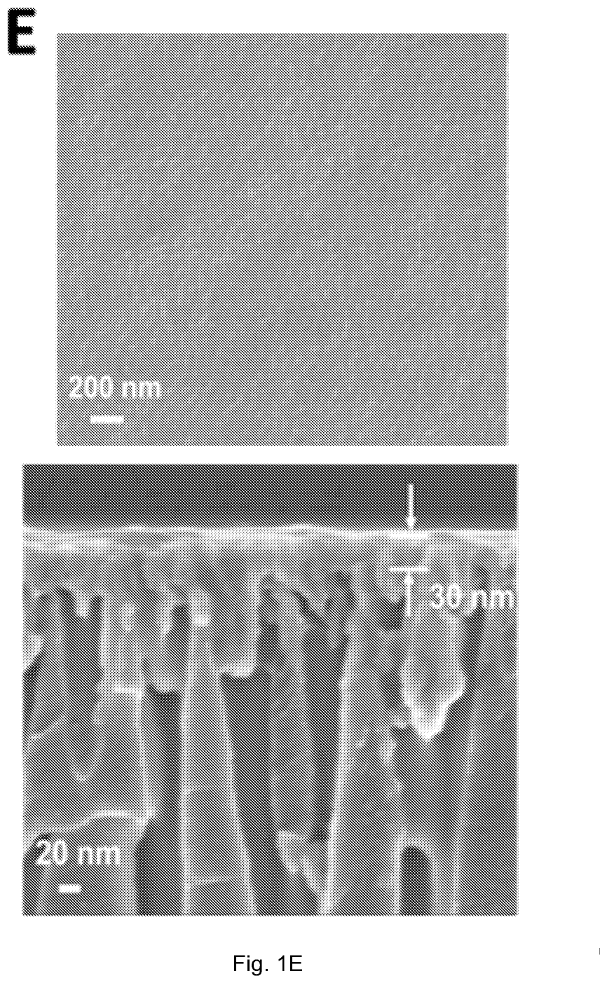

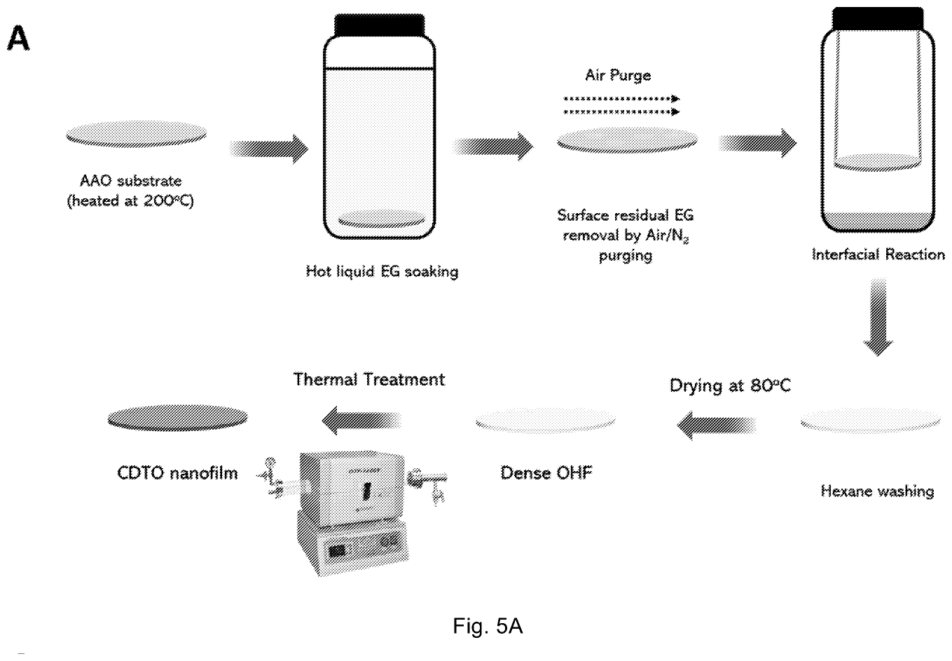

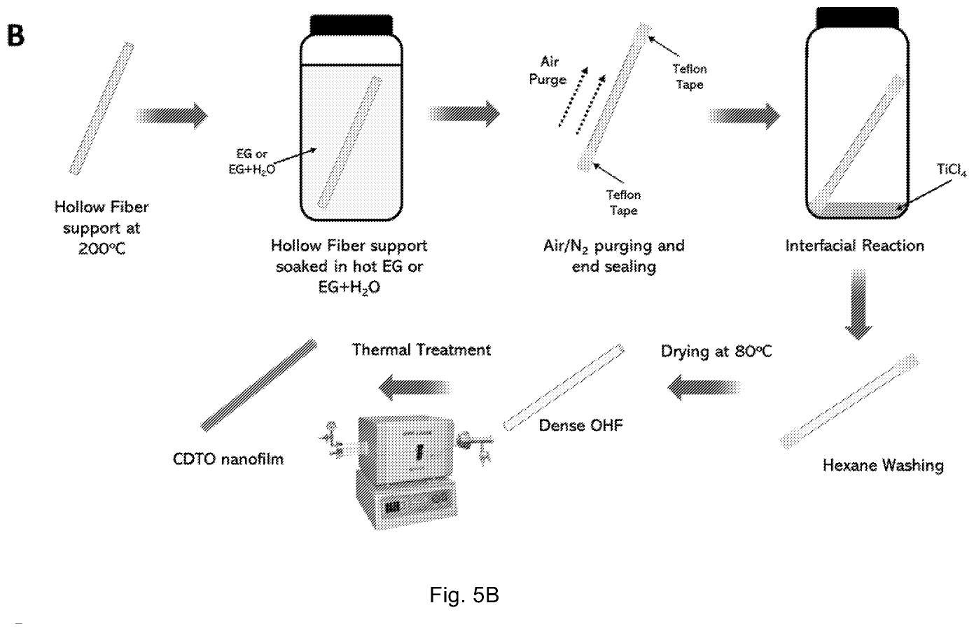

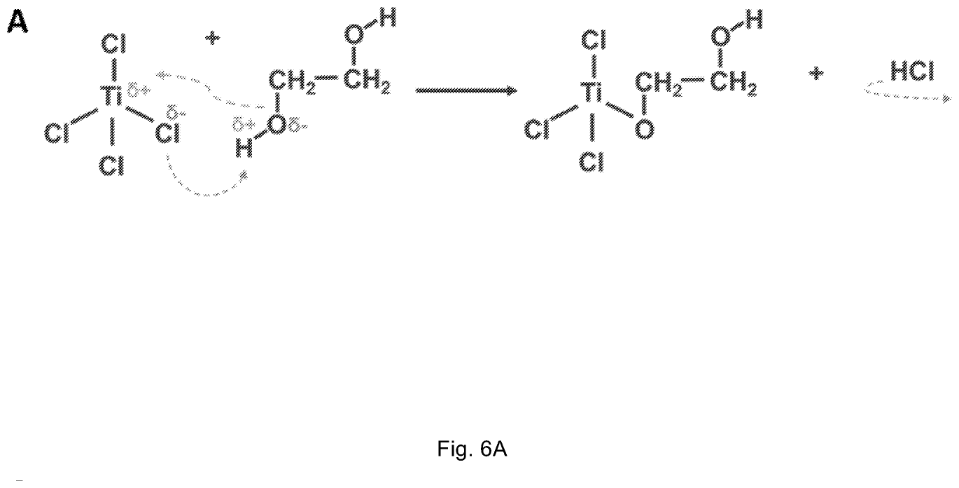

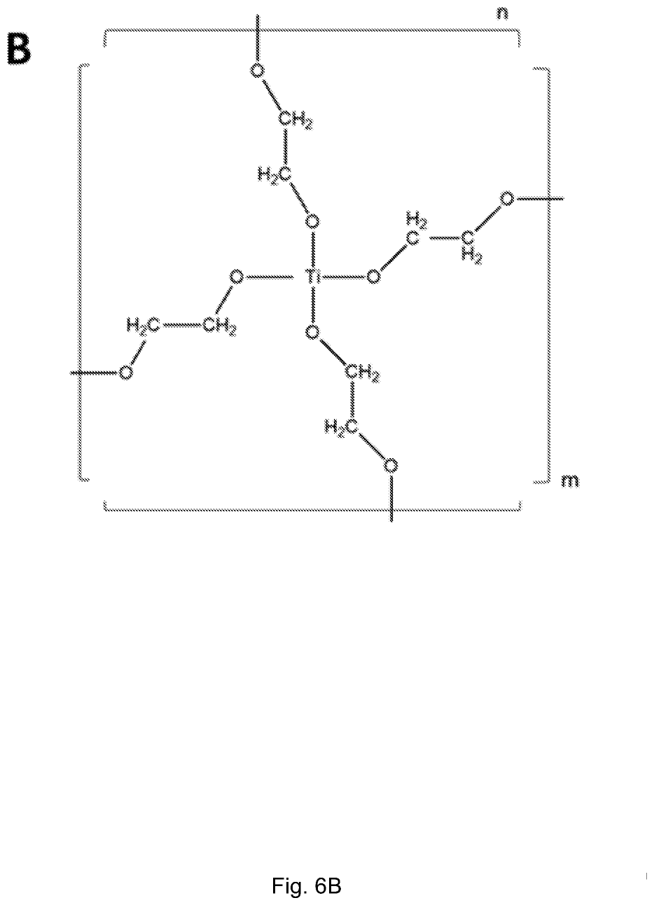

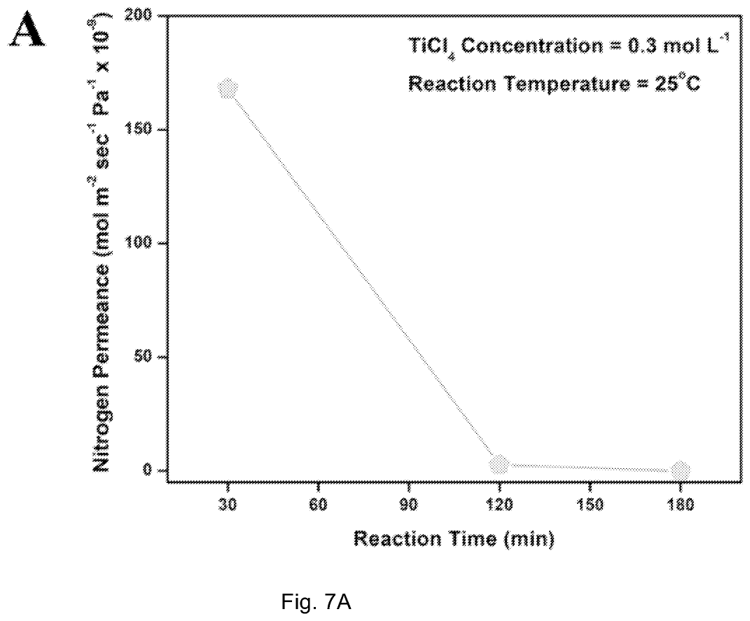

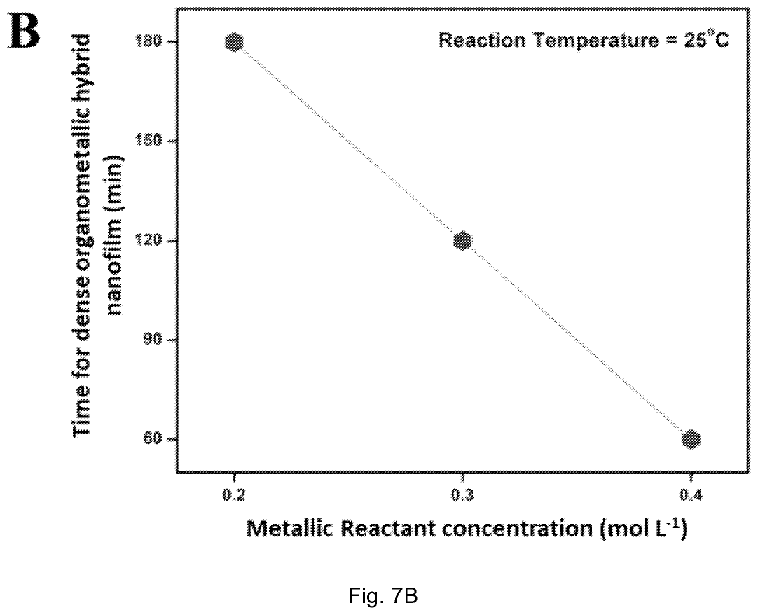

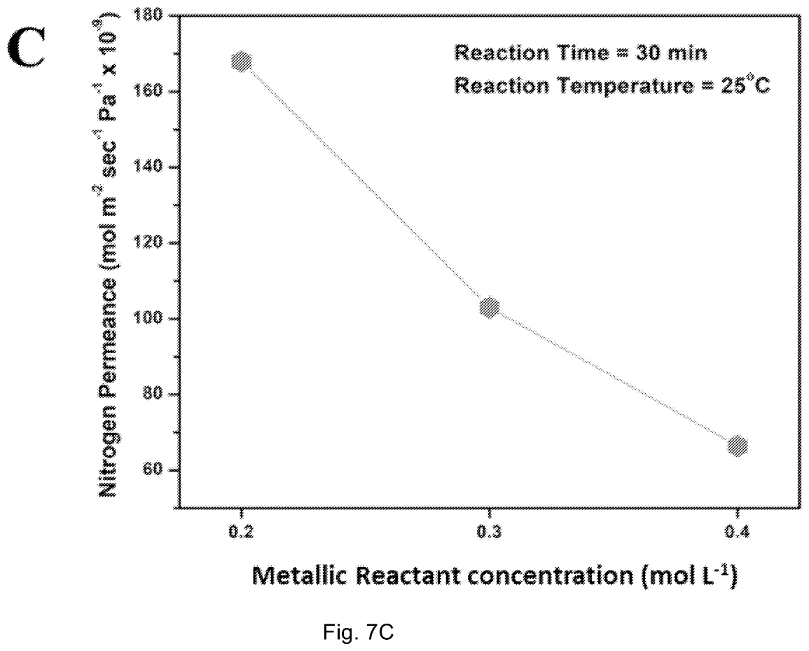

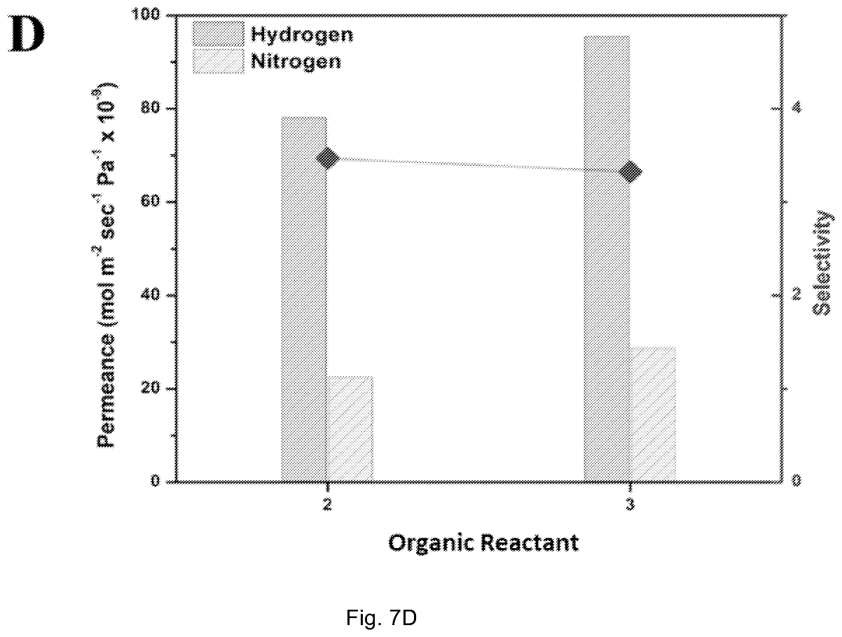

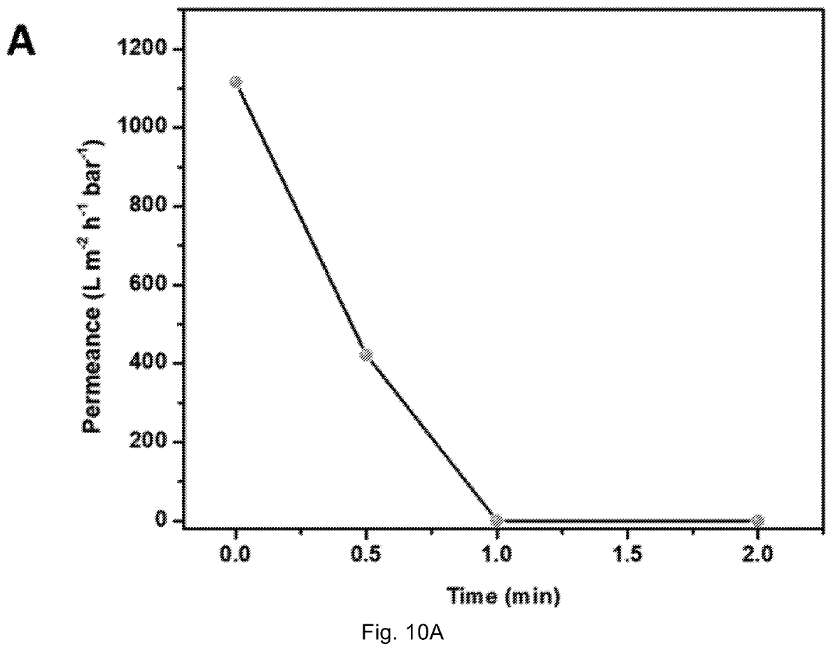

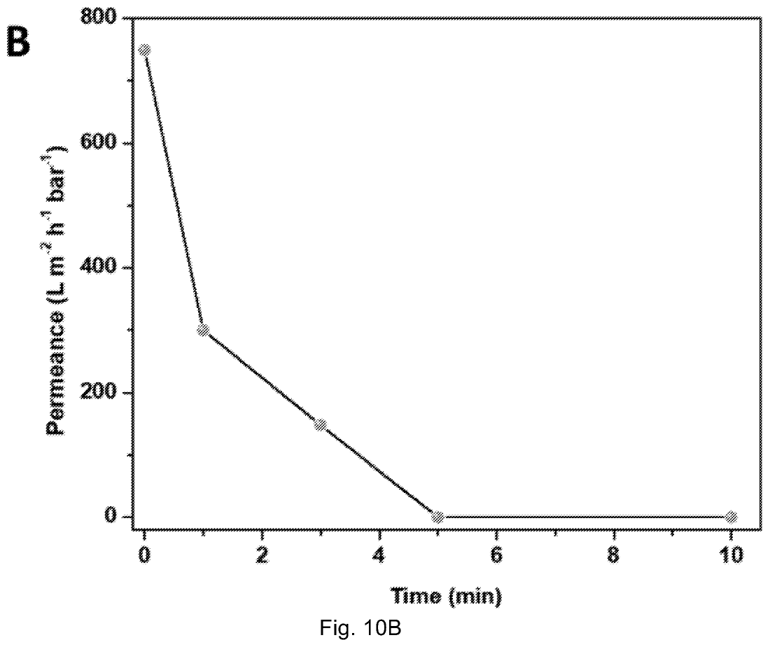

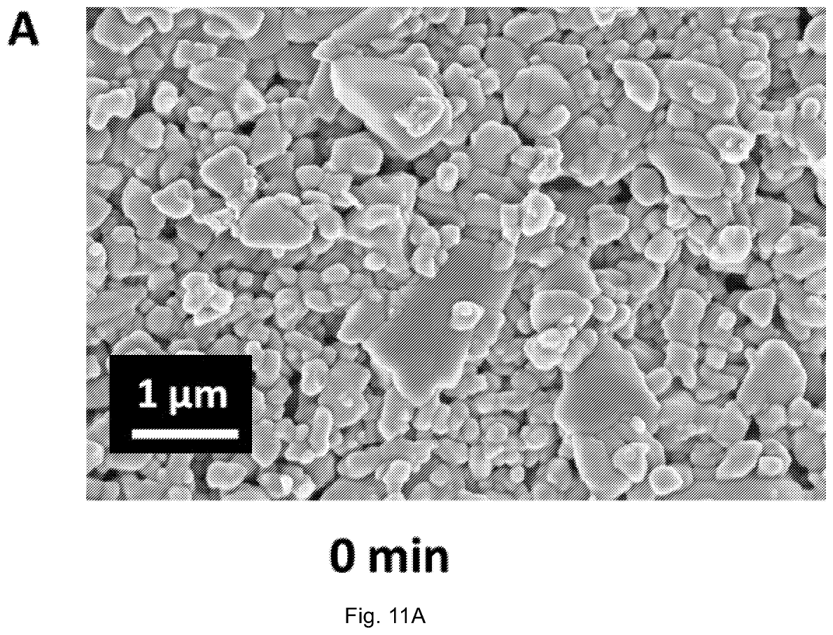

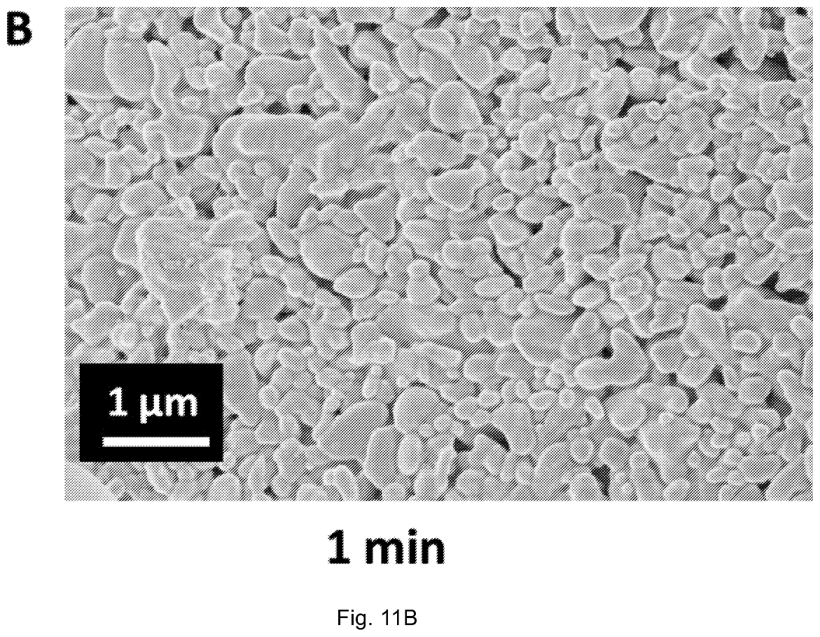

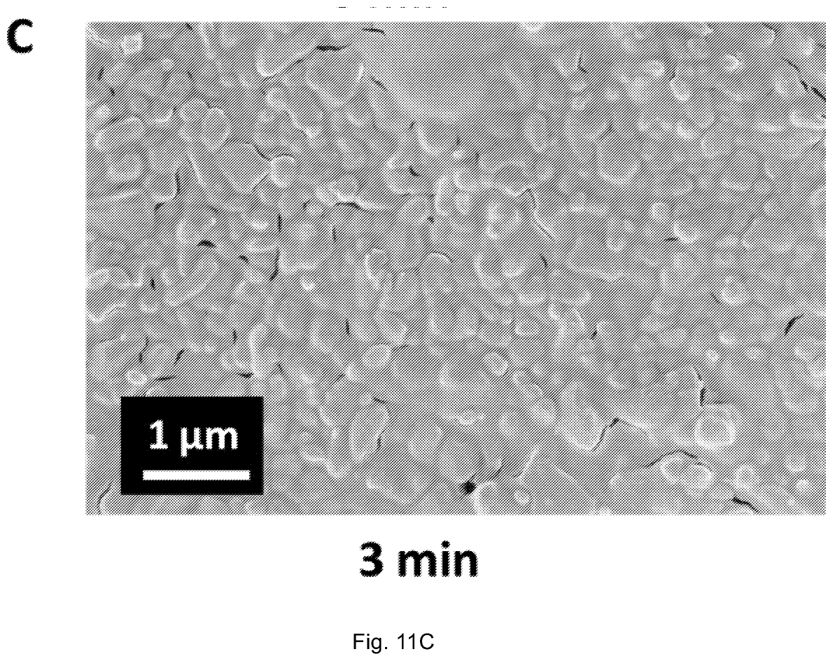

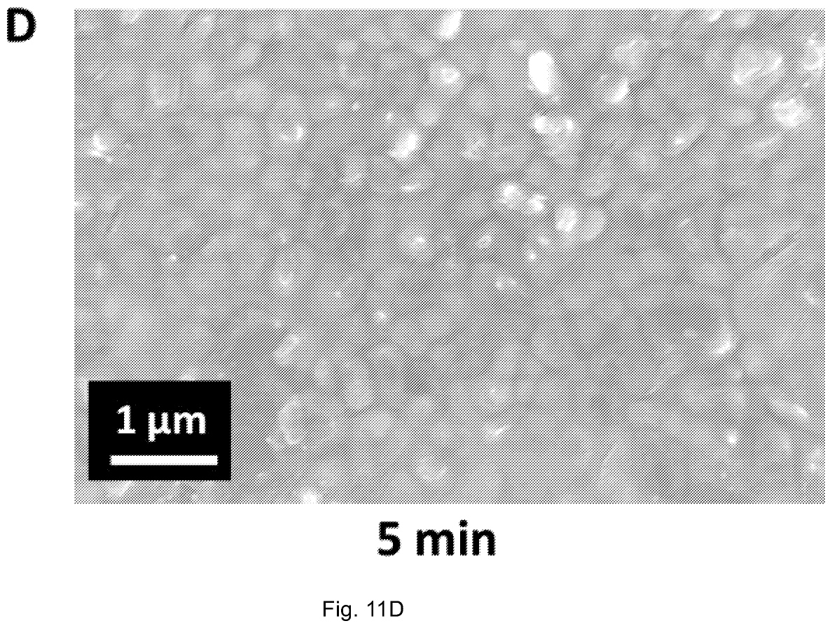

Molecular Layer Deposition (MLD) is a vapor-phase deposition technique for polymeric or organo-metallic hybrid films. Because of the layer-by-layer growth feature and non-selective deposition on all the exposed surfaces, MLD is not appropriate for the fast deposition of a skin layer/separation membrane on the porous supports. Titanium tetrachloride (TiCl₄) and ethylene glycol (EG) were used as metallic and organic reactants, respectively, in an interfacial reaction process (FIG. 1A-I, II) to prepare a dense skin layer (FIG. 1A-III). Independent of support morphology-flat anodic aluminum oxide (AAO) or cylindrical α-alumina hollow fiber (HF), the support pores were filled with liquid EG, followed by reaction with TiCl₄ at the pore mouth to form a non-porous organometallic hybrid film (OHF) (FIGS. 5 and 6). This generates a OHF skin layer at a rate 2 to 3 orders of magnitude faster (only 1 min) than layer-by-layer MLD process. Upon carbon removal by thermal treatment/calcination, nanoporous carbon-doped titanium oxide (CDTO) is generated (FIG. 1A-IV). Formation of defect-free, non-porous OHF is critical to ensure continuous nanoporous CDTO nanofilms. Fabrication conditions were optimized for rapid and defect-free synthesis of OHF (FIGS. 7-9, Tables 2 and 3). OHF can be formed on supports having different pore sizes by optimizing TiCl₄ phase (vapor or liquid), concentration, and reaction time, as indicated by gas permeance and scanning electron microscopy (SEM) images. Reaction between liquid EG and TiCl₄ vapor at higher temperatures (150° C.) forms the thinnest, defect-free OHF in the shortest time. Therefore, results for this OHF are reported henceforth. Undetectable permeance of N₂ (<10⁻¹² mol m⁻² s⁻¹ Pa⁻¹) and methanol (<0.05 L m⁻² h⁻¹ bar⁻¹) measured using a commercial or a home-built permeation cell (FIG. 10) indicate defect-free OHF formation within 1 min (min=minute(s)) on AAO and 5 min on α-alumina HF. SEM images show evolution of OHF into a continuous, amorphous (confirmed by X-ray diffraction) nanofilm on a 50 nm porous HF (FIG. 11).

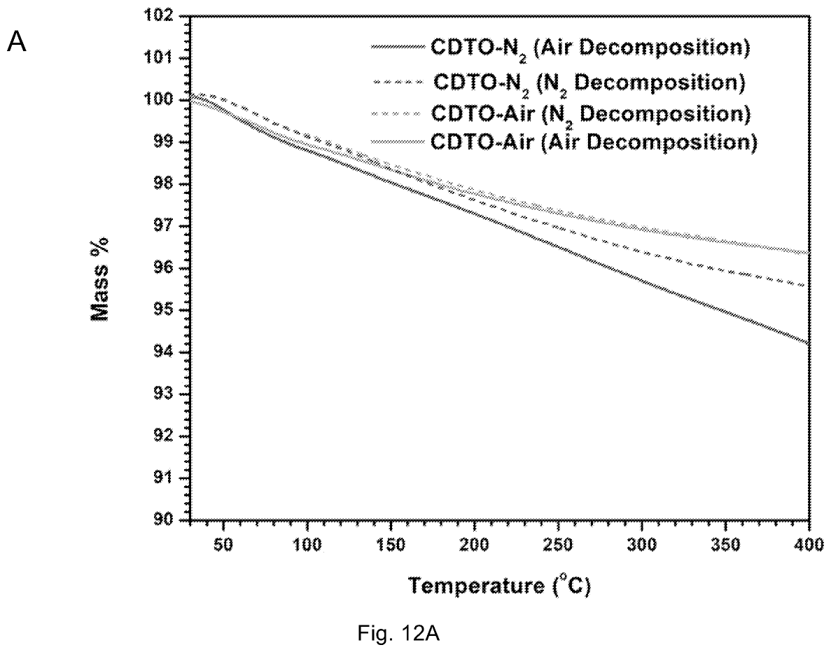

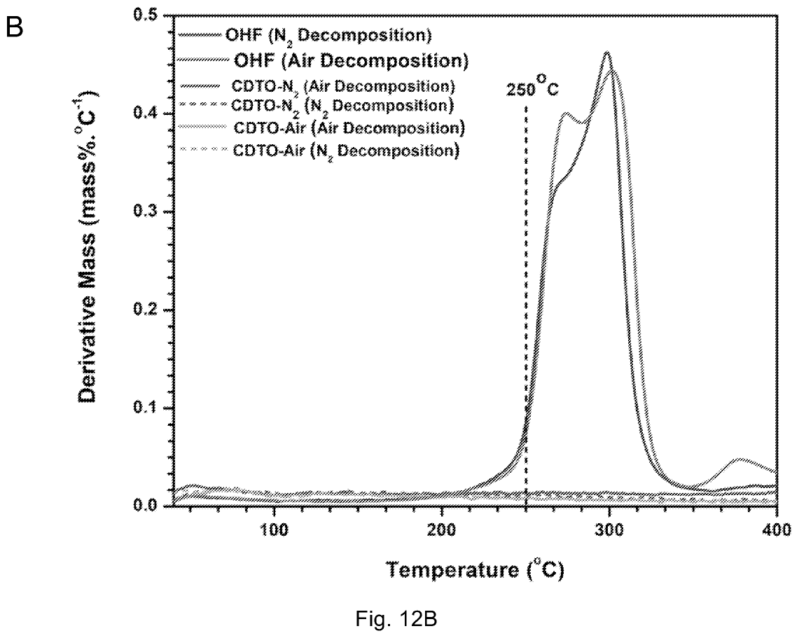

This hybrid material was modeled using the large-scale atomic/molecular massively parallel simulator (LAMMPS) to understand pore generation during calcination; energy minimized structure was subjected to heat under N₂ or O₂ atmosphere. FIG. 1B shows the material formed after heat treatment in N₂ and O₂, respectively. Indeed, densely packed pores are generated throughout the material, and resulting porous structure is highly dependent on its final carbon content (FIG. 1B-I, II). Pore formation is comparatively faster in O₂ and accelerated by temperature. The surface area, pore volume, and porosity of CDTO are highly correlated with carbon retained after calcination, namely ‘carbon doping’, in titanium oxide network (FIG. 1B-III). Carbon partially leaves the hybrid material, and carbon removal is responsible for the pore formation and precise size alteration (FIG. 1B-IV). It was speculated that carbon follow the fastest path to leave from bulk to gas phase, leaving behind voids that form highly dense, nanometer-sized pores, as observed in our simulation. OHF is stable (≤5% mass loss) in both air and N₂ till 250° C. (FIG. 1C), beyond which it decomposes, possibly losing carbon as indicated in simulation, with ˜10% more mass loss in air than in N₂ at 400° C. (FIG. 12). However, porous CDTO is stable up to 300° C. in both air and N₂ (FIG. 1C, inset), showing only 3-4% mass loss. Change in composition, as shown in X-ray photoelectron spectroscopy (XPS), and formation of oxygen-containing carbonaceous groups, as seen in Fourier transform infra-red (FTIR) spectroscopy, also indicate carbon removal upon heating, consistent with our simulation results.

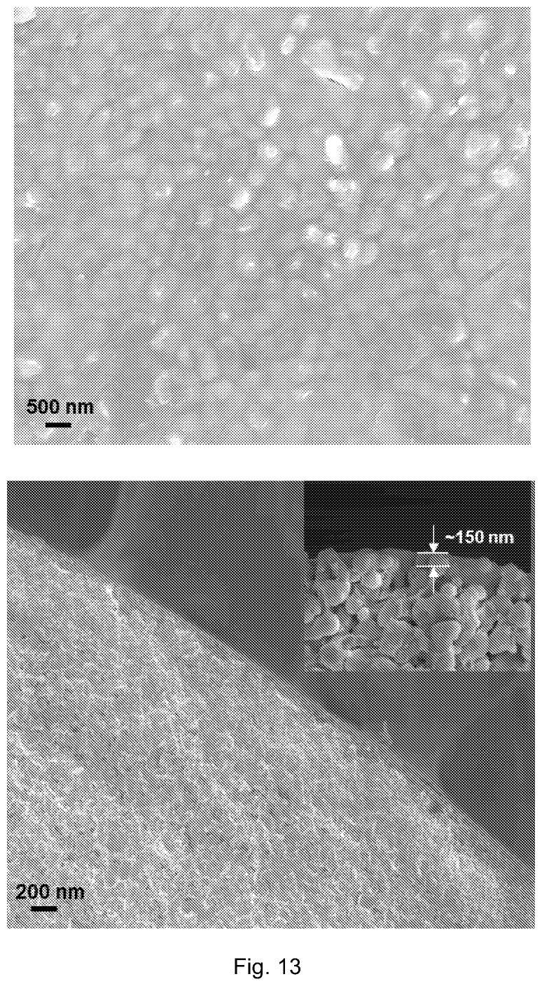

OHF was thus controllably calcined, either in air or N₂, at temperature≥250° C. for 2 h, to precisely regulate the ‘carbon doping’ to form porous CDTO nanofilms. CDTO-Air and CDTO-N₂ were denominated for OHF calcined at 250° C. in air and N₂, respectively (unless stated). Table 1 summarizes elemental composition, mechanical strength, and surface characteristics of the CDTO nanofilms. Although calcination makes CDTO porous, it maintains excellent mechanical stability with Young's modulus between 50 and 90 GPa (Table 1), comparable to the strongest reported OSN membrane. Calcination environment impacts residual carbon; protective N₂ environment impedes carbon removal, evidenced by simulation and measured carbon content (Table 1, FIG. 1B-III). Controlling carbon content also allows surface property adjustment; greater hydrophobicity was realized with higher carbon doping. Hydrophobicity of OSN membranes is crucial as even miniscule amount of water in solvent can drastically foul hydrophilic membranes, limiting their industrial use. FIG. 1D shows centimeter-scale OHF and CDTO nanofilms on AAO and HF with varying composition and properties; higher carbon doping (Table 1) leads to darker membrane color, yellow for CDTO-Air and black for CDTO-N₂. SEM images (FIG. 1E) show a selective layer of CDTO-Air, ˜30 nm thick on AAO. Compared to the porous supports, CDTO surface is smooth (FIG. 1E; FIG. 13).

TABLE 1
Chemical composition, water contact angle, and Young's
modulus of CDTO nanofilms and OHF. Temperature in membrane
name represents the calcination temperature.

| | | | | | Young's |
|---|---|---|---|---|---|
| | Chemical Composition (%) | | | Contact | Modulus |
| Membrane | Carbon | Titanium | Oxygen | Angle | GPa |
| OHF | 58.1 | 11.5 | 30.4 | 93.4 ± 1.8° | 61.5 ± 2.3 |
| CDTO-Air | 36.3 | 19.3 | 44.4 | 42.0 ± 2.2° | 55.1 ± 3.4 |
| (250° C.) | | | | | |
| CDTO-N₂ | 39.7 | 17.4 | 42.9 | 78.0 ± 3.2° | 76.4 ± 1.4 |
| (250° C.) | | | | | |
| CDTO-Air | 23.5 | 21.9 | 54.6 | 30.9 ± 0.3° | 50.6 ± 3.7 |
| (400° C.) | | | | | |
| CDTO-N₂ | 38.6 | 20.3 | 41.1 | 75.3 ± 0.2° | 88.8 ± 5.9 |
| (400° C.) | | | | | |

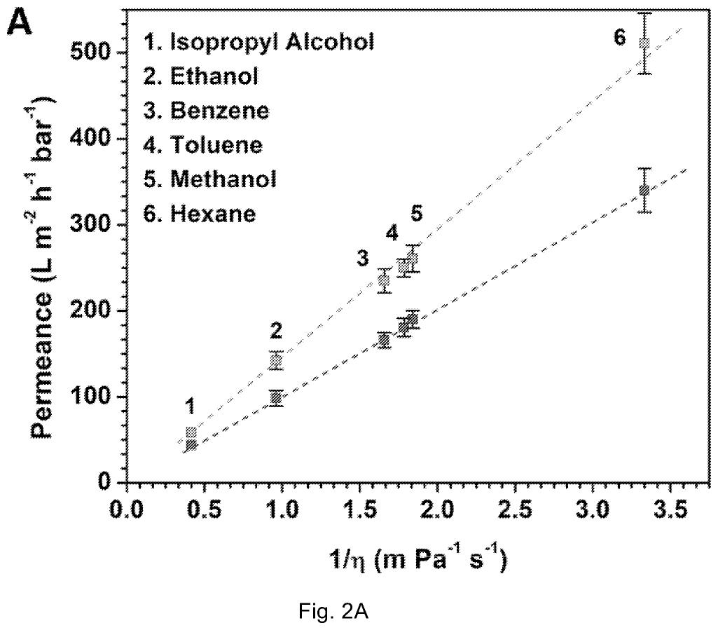

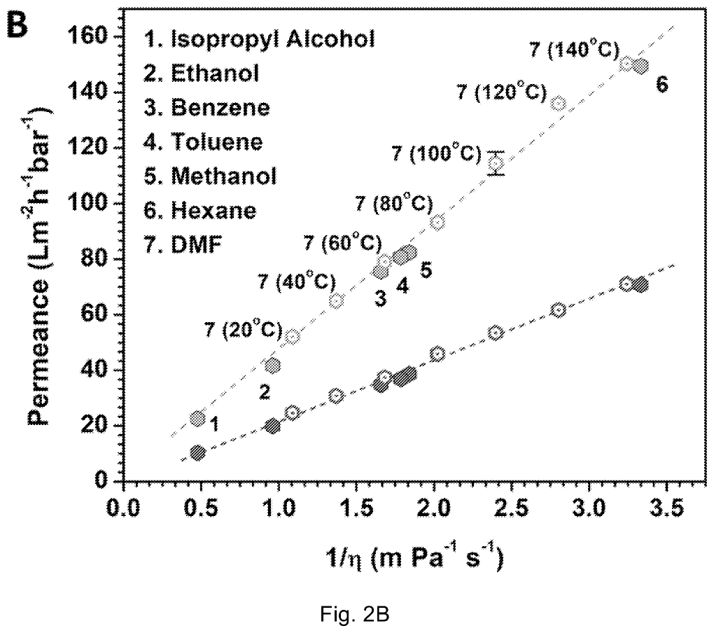

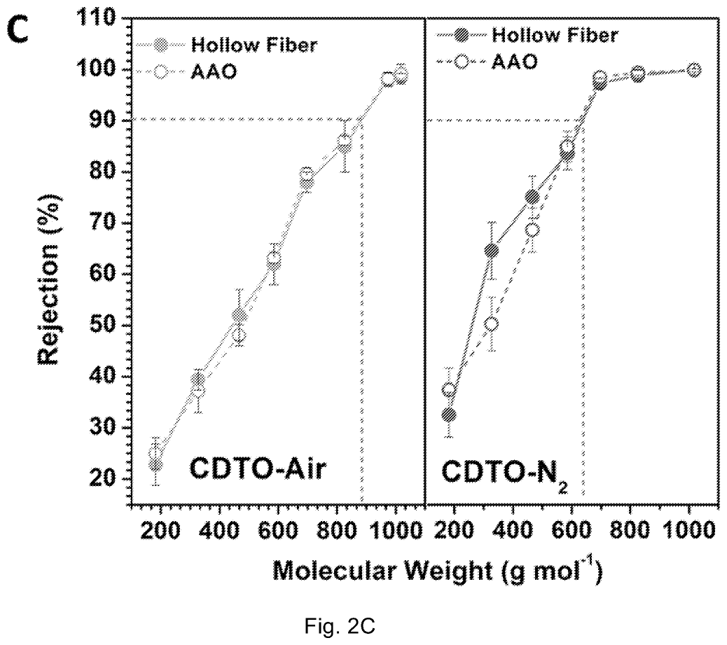

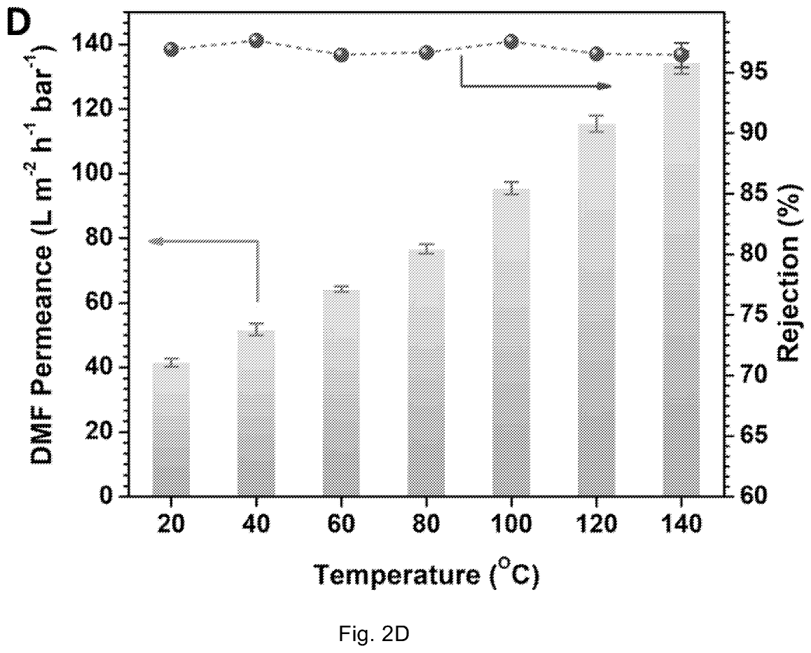

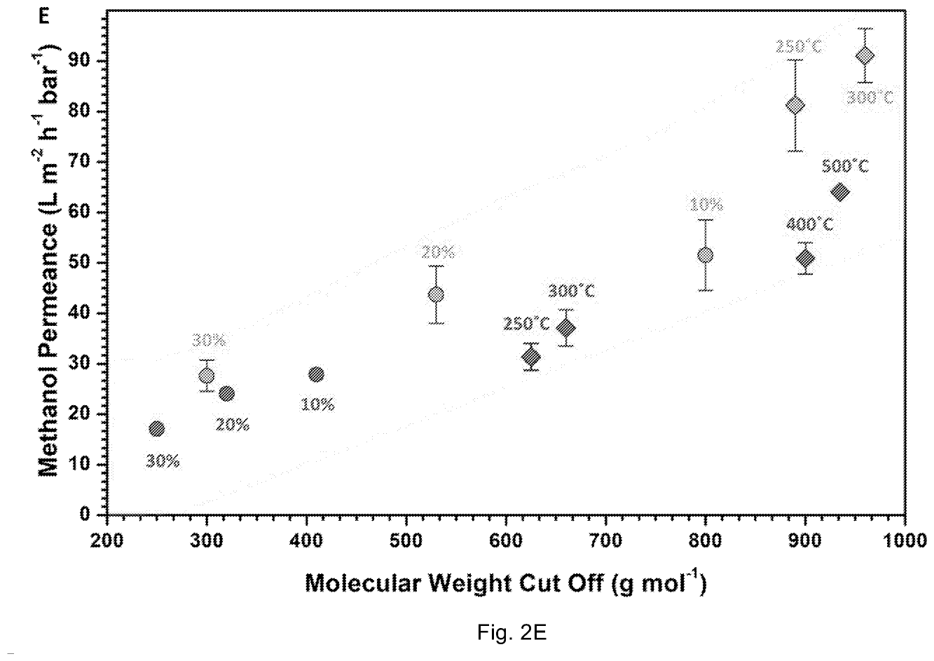

Transport of various organic solvents (Table 4) through CDTO nanofilms was investigated and 2-3 orders of magnitude higher permeance observed compared to commercial OSN membranes, with unprecedented hexane permeance of 550 L m⁻² h⁻¹ bar⁻¹. Interaction between solvents and CDTO was minimal, as suggested by weak dependence of viscosity-normalized permeance on Hansen solubility parameters, in agreement with other OSN membranes with rigid pores. Permeance is correlated to viscosity, as predicted by the Hagen-Poiseuille equation; a solvent, for example, hexane, having the lowest viscosity, permeated fastest and vice versa, for both CDTO-Air and CDTO-N₂ nanofilms on AAO (FIG. 2A). Solvents permeated slower in CDTO-N₂ than CDTO-Air, due to smaller pores generated during calcination in N₂ (higher carbon doping), consistent with our simulation.

Industrially, HF membranes are more applicable than flat sheets because of the higher module packing density and ability to withstand high pressure. Hence, CDTO nanofilms were also prepared on HFs and tested for transport and separation efficiency (FIG. 2B, C). Expectedly, similar viscosity dependent permeance was observed through CDTO nanofilms prepared on HFs (FIG. 2B). For dimethylformamide (DMF), a harsh solvent, when temperature was increased up to 140° C. (causing viscosity decrease), the permeance followed the same viscosity correlation as other solvents at room temperature. This indicates exceptional rigidity of CDTO pores in harsh solvent, even at elevated temperatures. CDTO nanofilms on HFs, however, exhibited lower permeance than those on AAO. This difference in permeance is because of the formation of thicker skin layer on HFs, ˜150 nm, in contrast with ˜30 nm on AAO, resulting from larger pore size of HFs and thus requiring longer time to form a dense OHF (FIG. 1E, FIGS. 10 and 13). Although the solvent permeance differs, the permeability (=permeance× thickness) is very similar (methanol: 6.6 and 6.3 L m⁻² h⁻¹ bar⁻¹ μm for CDTO-N₂ on AAO and on HF, respectively), indicating solvent transport depends only on CDTO material. Rejection of solutes (Table 5) by CDTO-N₂ and CDTO-Air nanofilms prepared on both supports was measured and their separation effectiveness found to be similar (FIG. 2C), further confirming CDTO pores are independent of the underlaying supports.

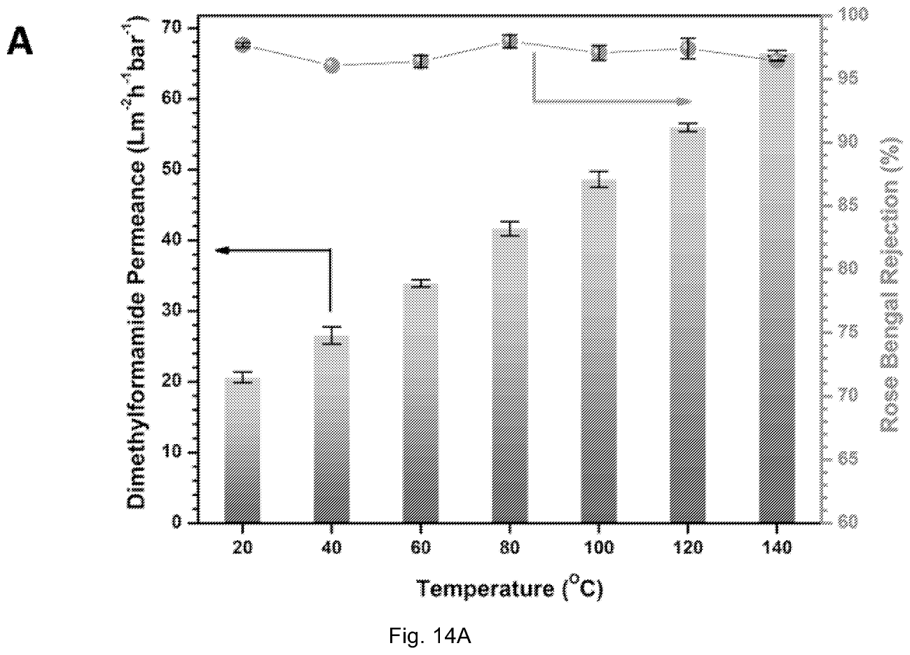

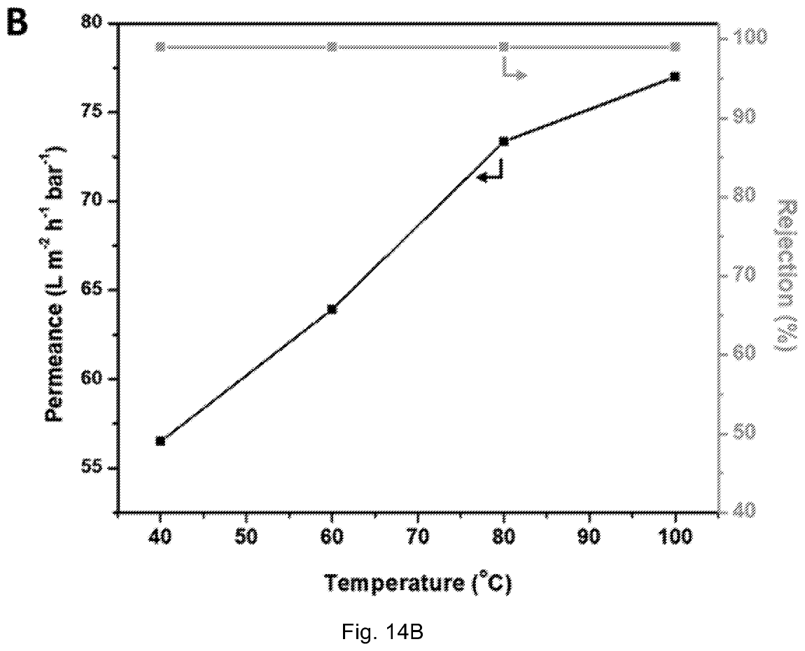

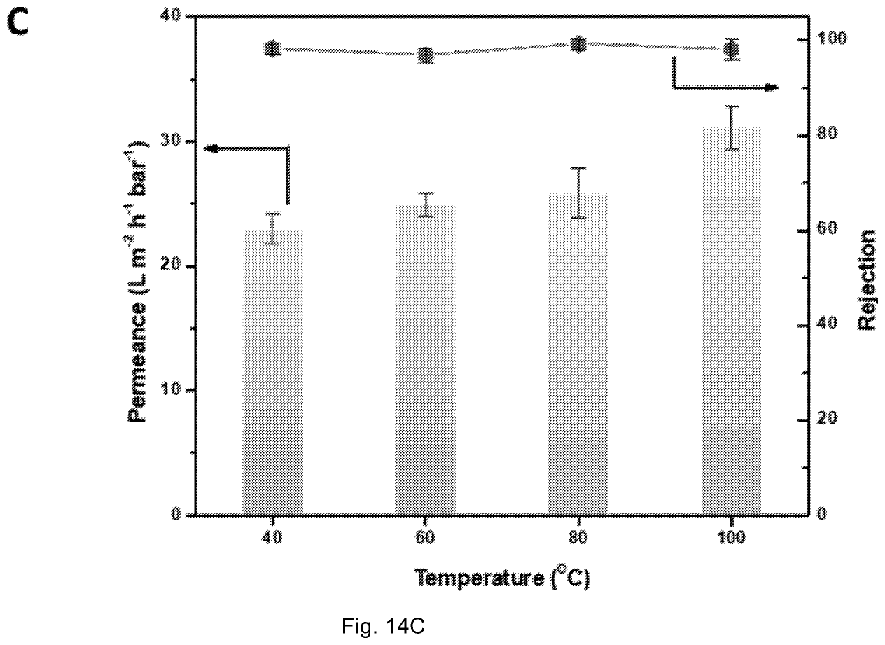

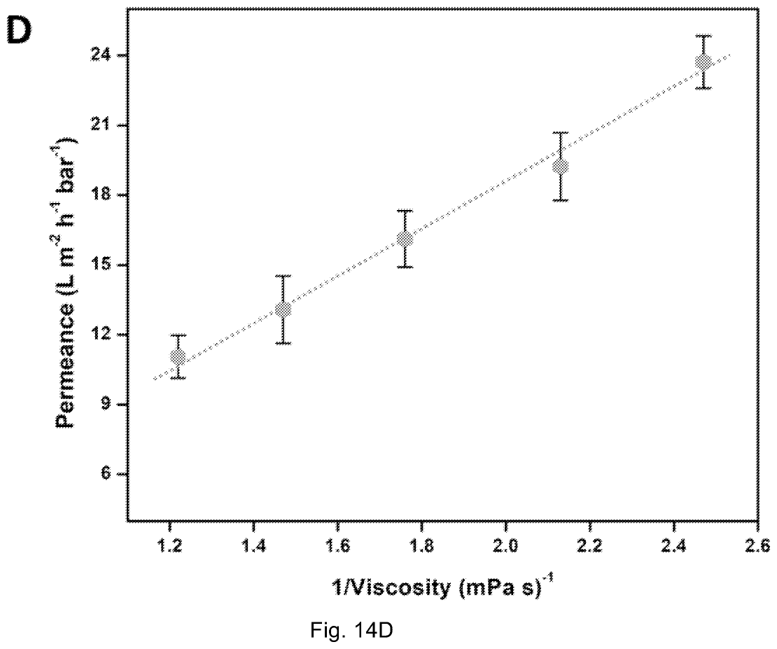

For effective separation, pores in OSN membranes should be rigid in harsh solvents and at elevated temperatures. Stable separation of Rose Bengal from DMF by CDTO-Air nanofilm was observed up to 140° C. (FIG. 2D). This was also observed for other CDTO nanofilms and with different solvents. These nanofilms exhibited long term stability in organic solvents with constant solute rejection, independent of solvents or operation conditions, predominantly via ‘size-sieving’ mechanism through its rigid molecular-sized pores (FIGS. 14-19). Expectedly, other glycols can also form CDTO nanofilms. These results clearly show that CDTO nanofilms with rigid nanopores and ultrahigh solvent transport can be fabricated on different porous supports by ultrafast interfacial reaction, followed by calcination, for OSN applications in harsh solvents and at elevated temperatures.

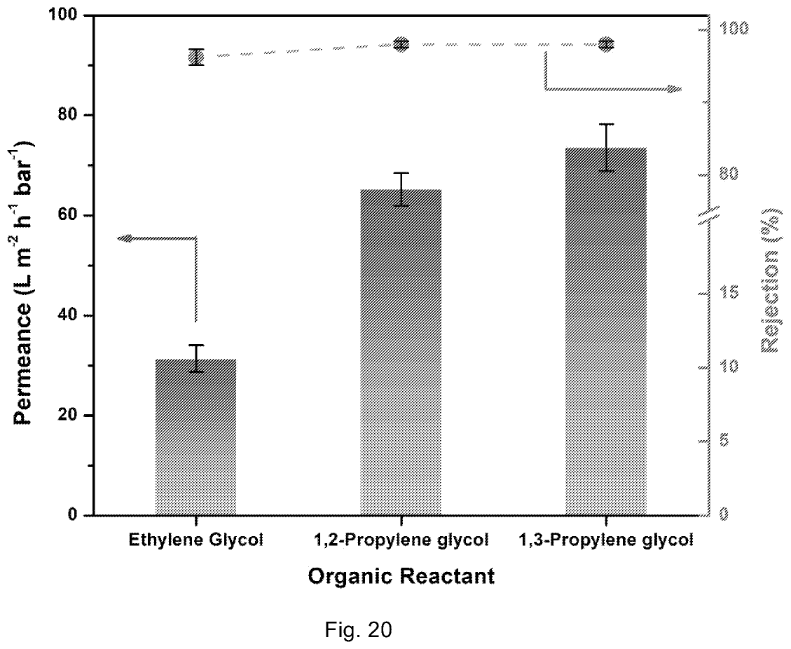

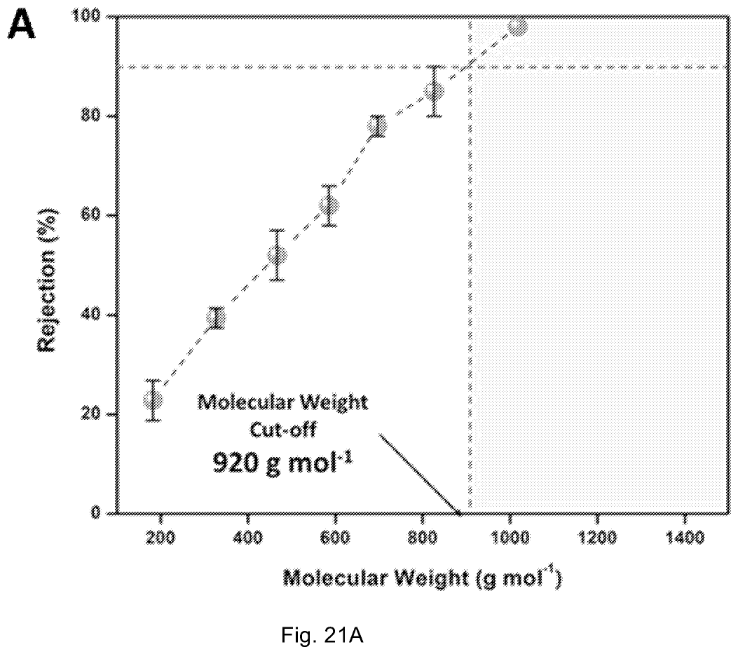

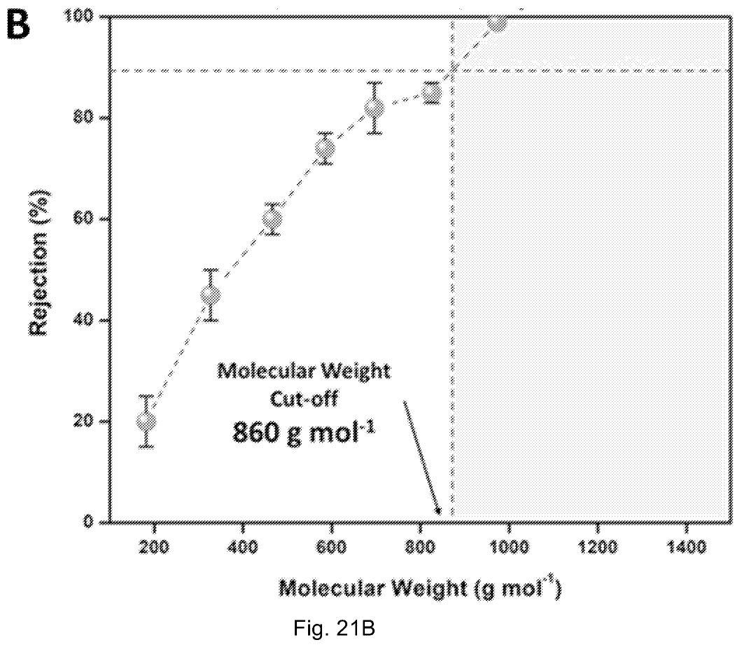

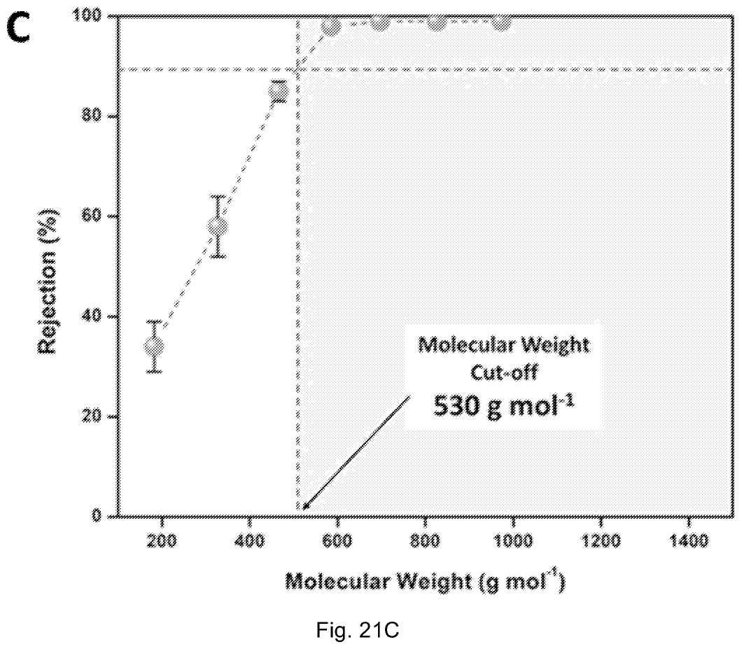

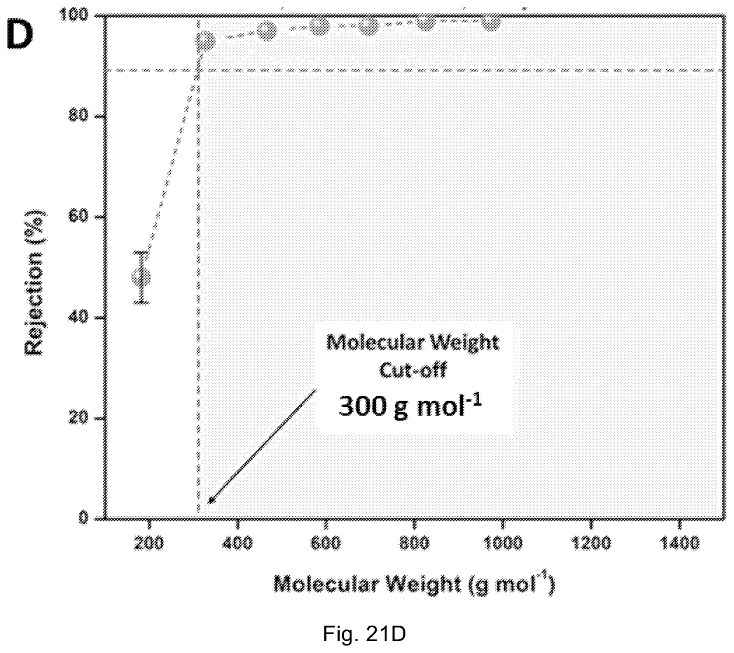

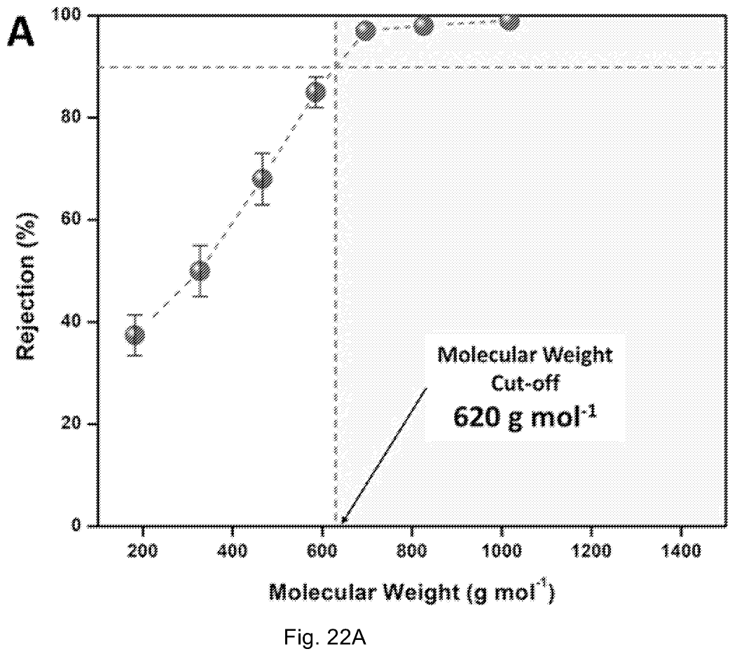

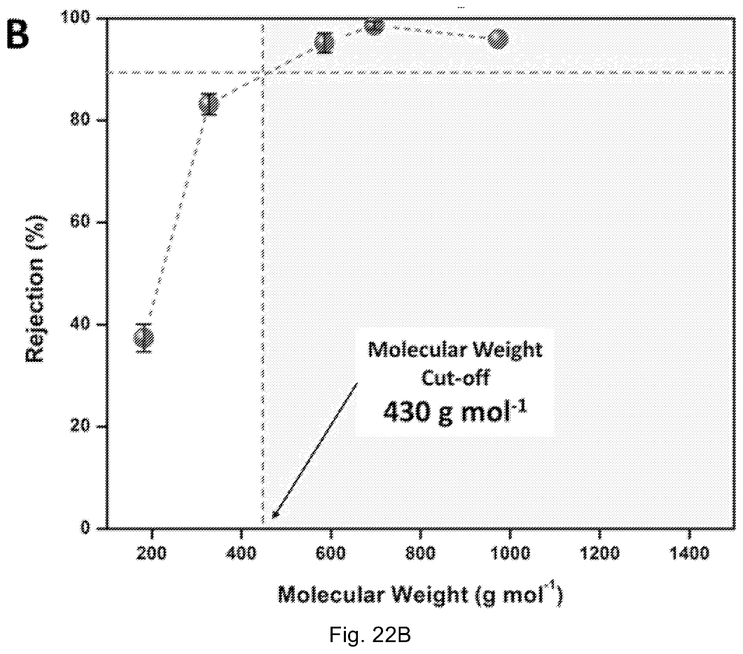

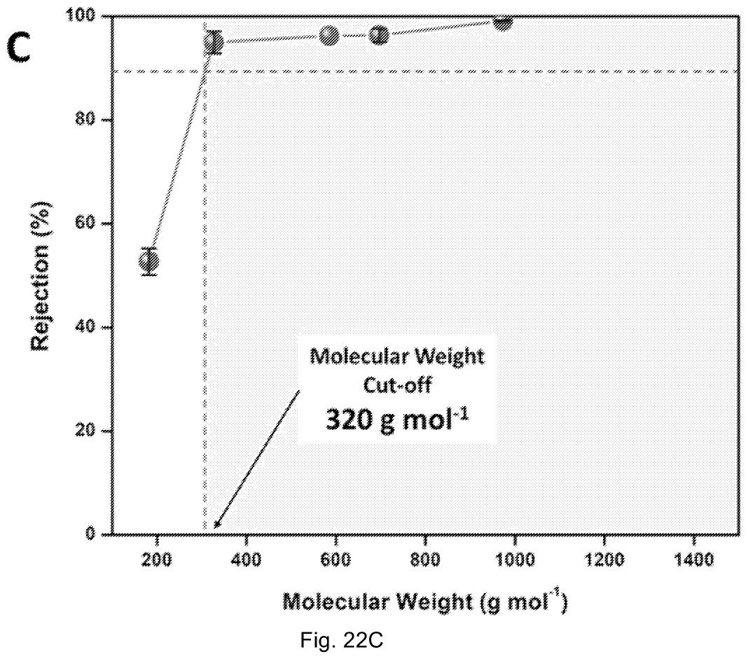

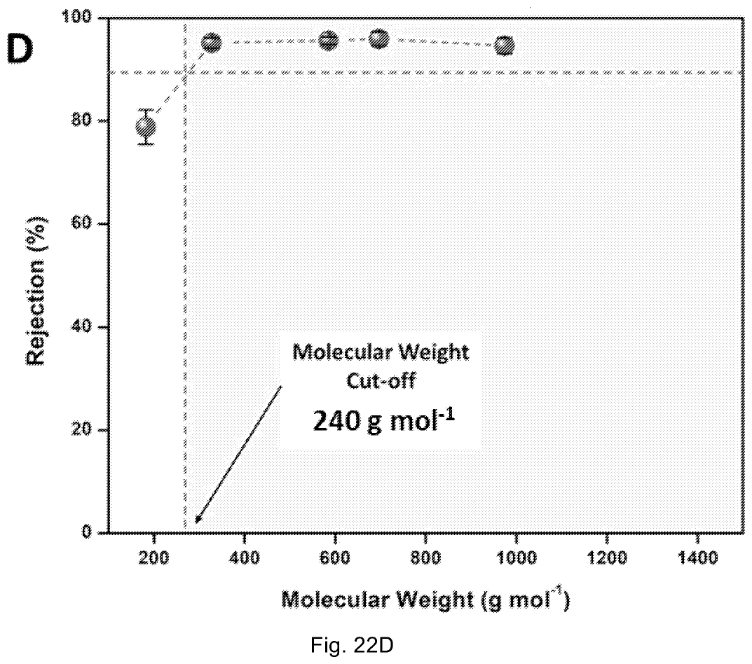

For OSN, membranes with tunable nanopores with MWCO between 200 and 1,400 Da is highly desirable, catering to diverse industrial processes. The residual carbon in the CDTO nanostructures dictates MWCO of these nanofilms, as suggested by simulation (FIG. 1B-III, IV). two strategies were employed to vary carbon doping: i) changing initial carbon content of the dense OHF and ii) controlling carbon removal by altering calcination conditions (gas environment/temperature). This generated CDTO nanofilms with precisely controlled MWCO (FIG. 2E) covering the entire OSN range. Initial carbon content in OHF was controlled by addition of H₂O in EG. OHF formed by adding H₂O generated smaller pores in CDTO after calcination. This is evident from decrease of MWCO from 620 to 240 Da for CDTO-N₂—H₂O (CDTO obtained by calcining OHF prepared by mixing H₂O in EG at 250° C.) and from 920 to 320 Da for CDTO-Air-H₂O, as water concentration was increased (10-30 wt. %) in EG (FIG. 2E, FIGS. 20 and 21). It was speculated that water introduce Ti—O—Ti bond, allowing tighter packing of titanium atoms and thus generating smaller pores after calcination (FIG. 22). Moreover, as calcination in N₂ generates smaller pores; CDTO-N₂—H₂O showed lower MWCO than its CDTO-Air-H₂O. The lowest MWCO of 240 g mol-1 was achieved by calcining OHF in N₂ prepared from EG with 30 wt. % water. Hence, changing the initial carbon content of OHF allows MWCO tuning between 240 to 920 g mol-1 (FIG. 2E).

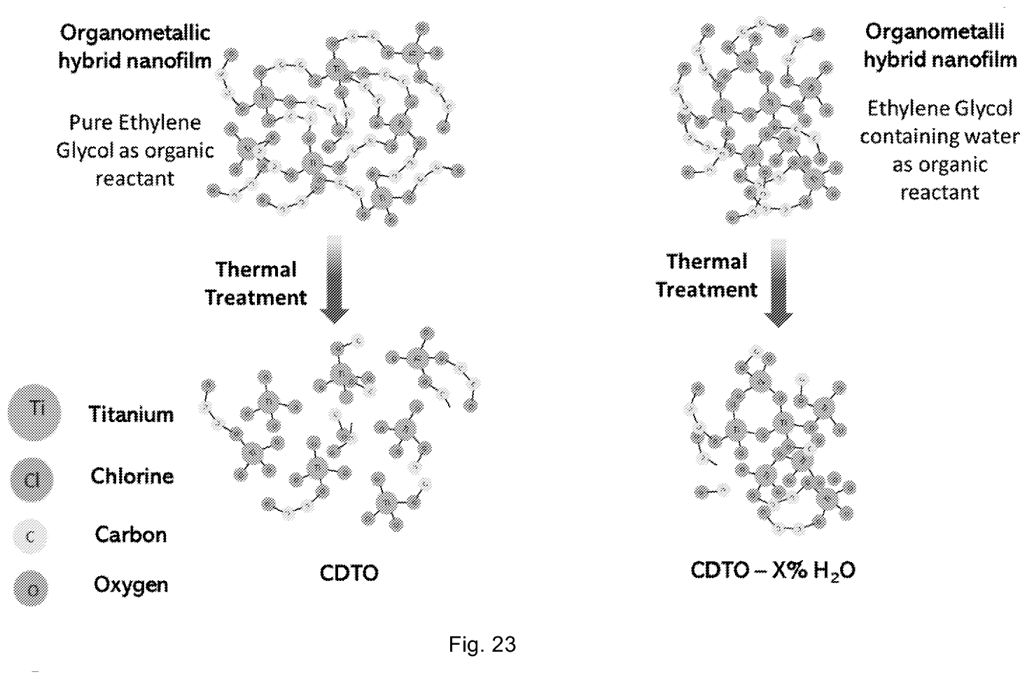

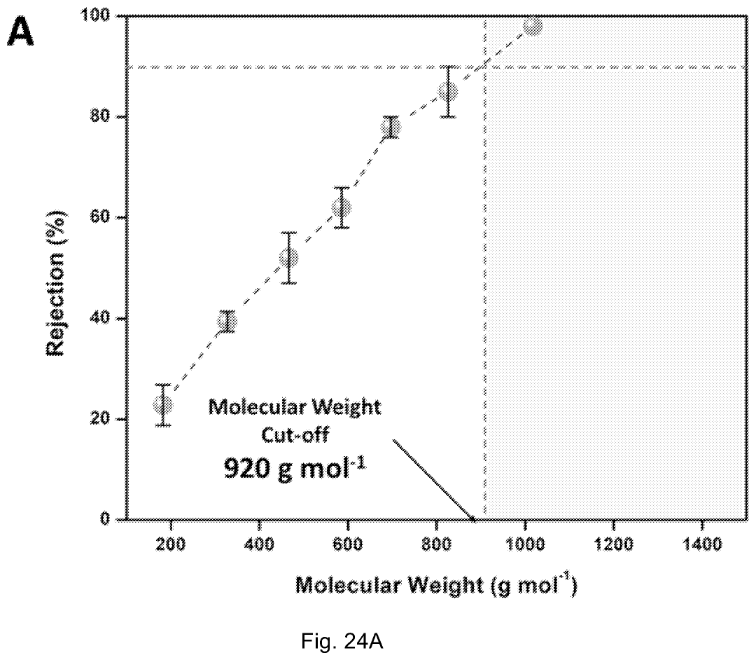

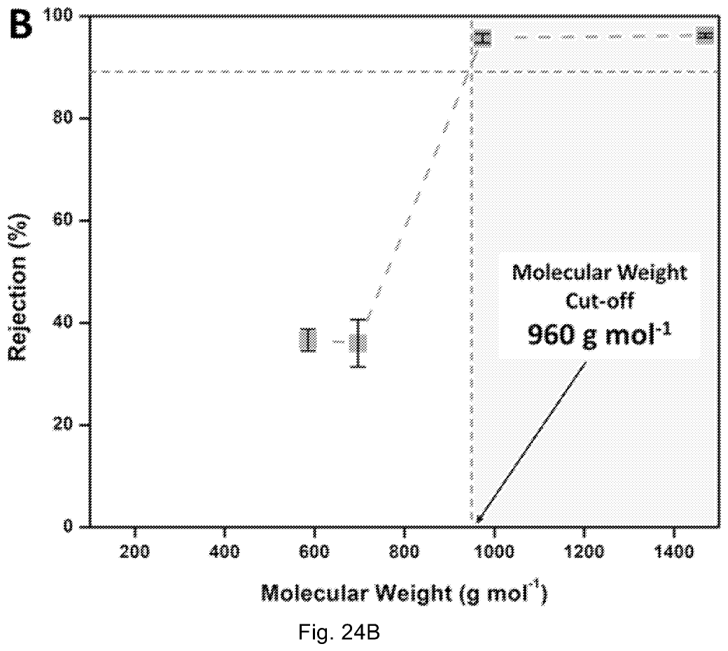

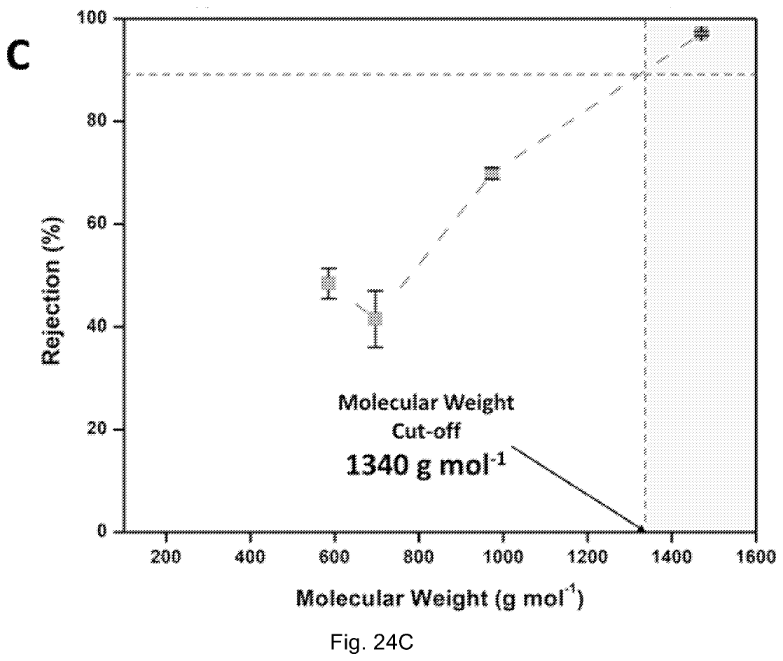

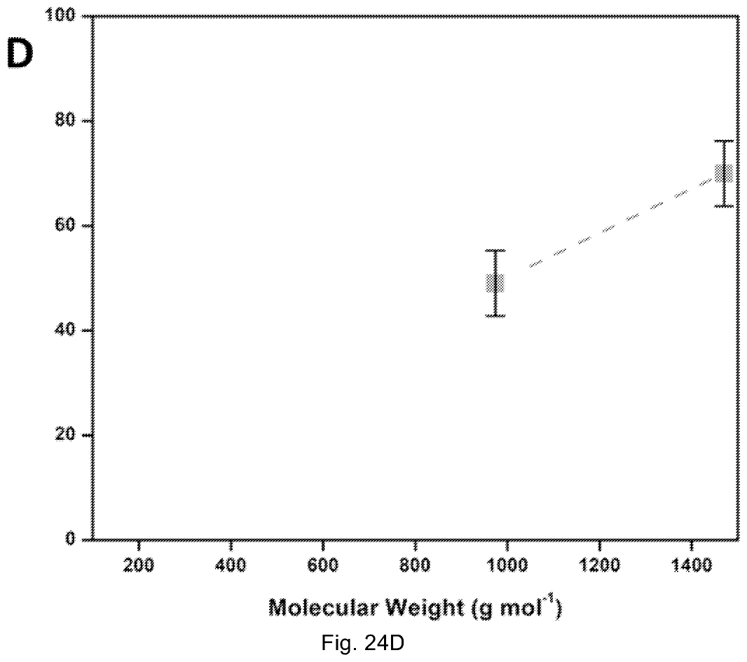

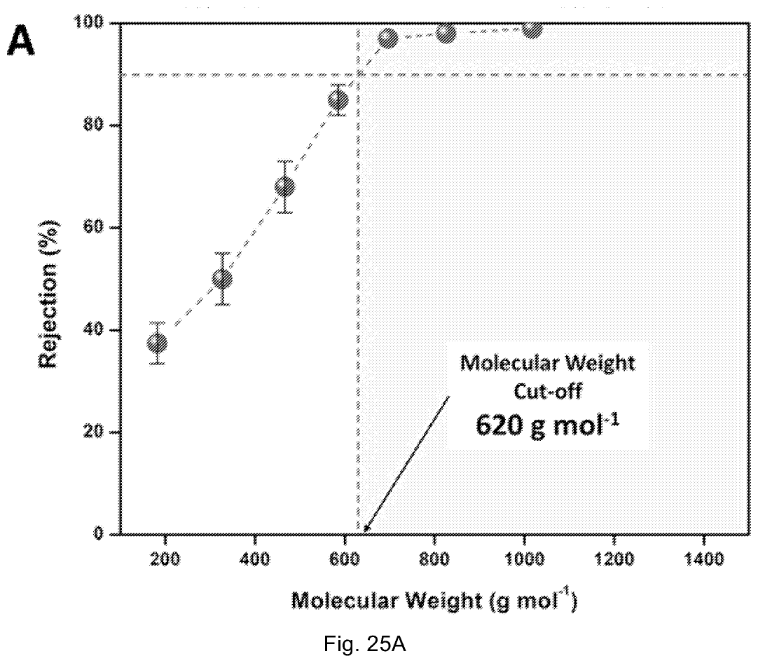

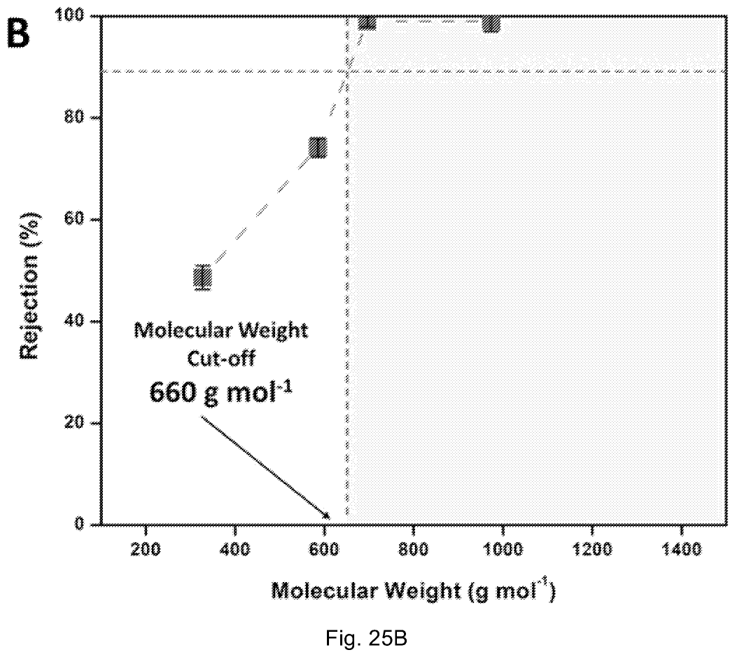

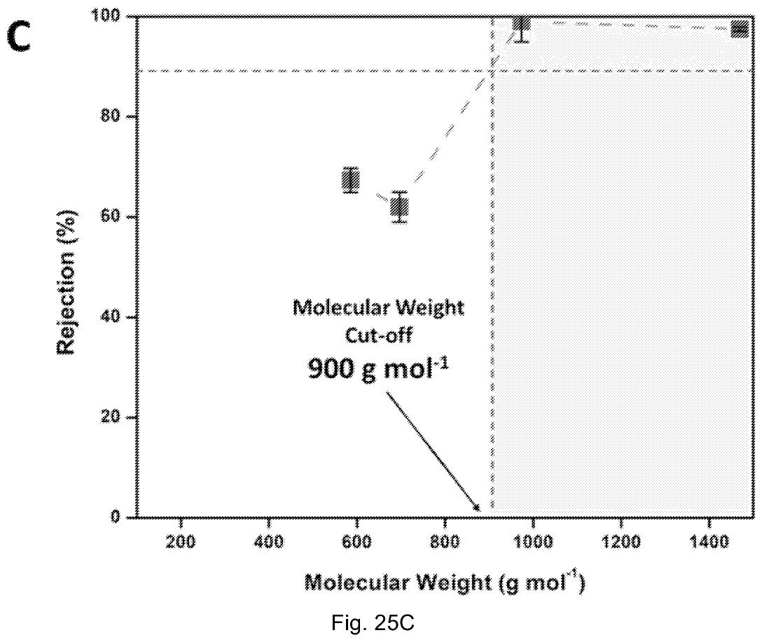

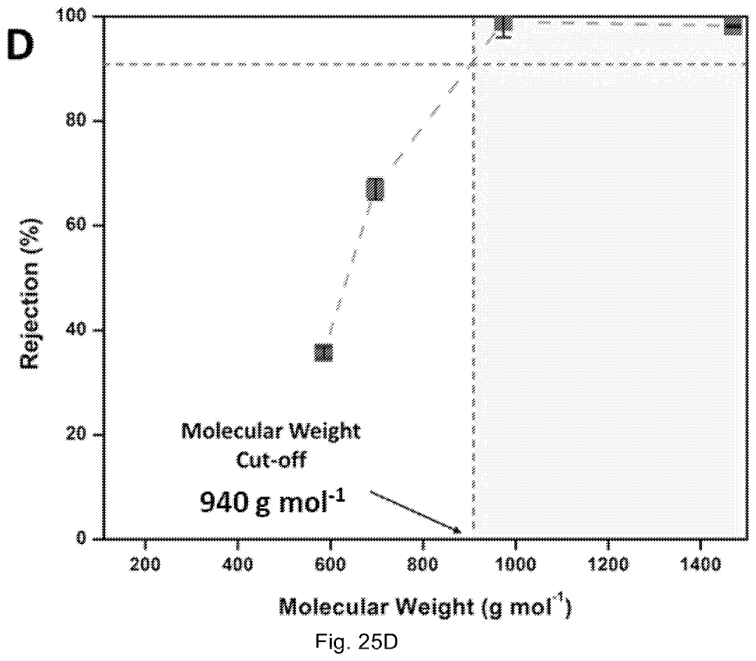

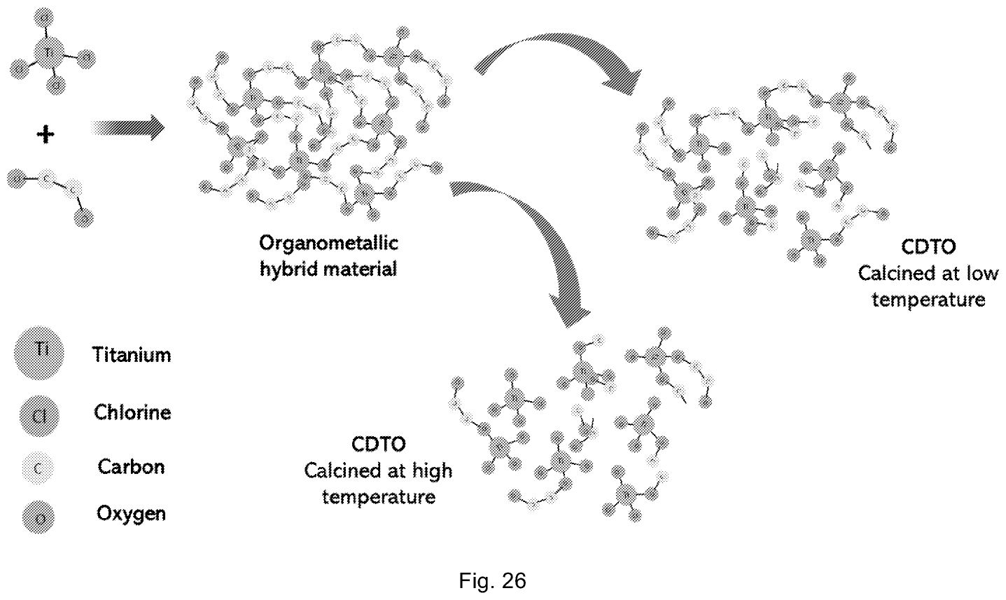

The other approach of tuning pore size is via controlling carbon removal (FIG. 2E, FIGS. 23 and 24). Calcining at higher temperatures or in air removes more carbon from OHF, hence reducing carbon doping (Table 1) and generating larger pores, as predicted by our simulation (FIG. 1B-III, IV; FIG. 25). By increasing the calcination temperature from 250 to 500° C. in air, it was found the MWCO of CDTO nanofilms increased from 920 Da to beyond 1,000 Da (FIG. 2E; FIG. 23). Calcination at temperatures≥300° C. in air causes rapid carbon removal, with possible crystalline TiO₂ clusters (FIG. 26), generating looser structure with larger pores, yielding membranes with MWCO>1,000 g mol-1. Increasing calcination temperature from 250 to 500° C. in N₂, MWCO for CDTO increased from 620 to 935 g mol⁻¹ (FIG. 2E; FIG. 24). Typically, membranes with lower MWCO have lower permeance and vice versa (FIG. 2E). CDTO, thus, demonstrates effective pore size tunability between 240 and 1400 Da (FIG. 2E, with MWCO step change as small as 100 g mol-1. This represents the broadest and the most precise tunability for a single OSN membrane material (Table 6), allowing fabrication of OSN membranes with tailored pore sizes for specific applications within the entire OSN range.

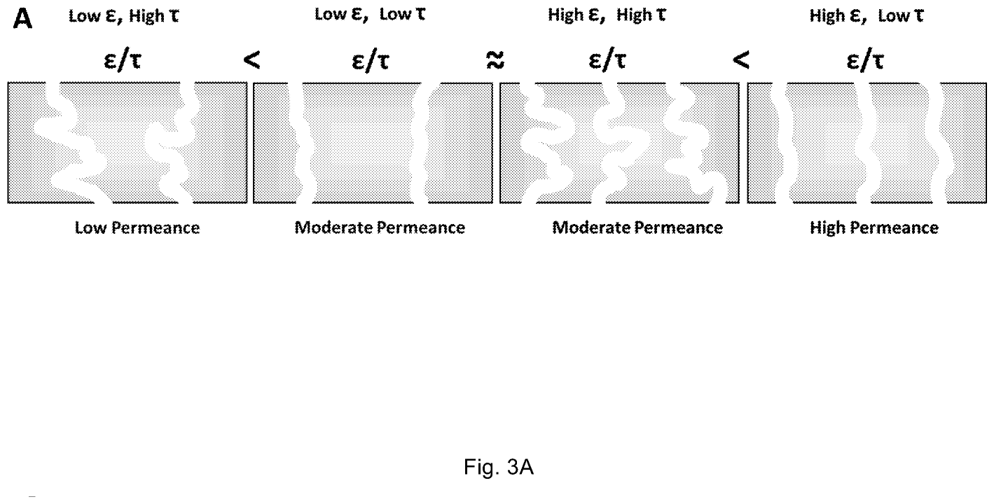

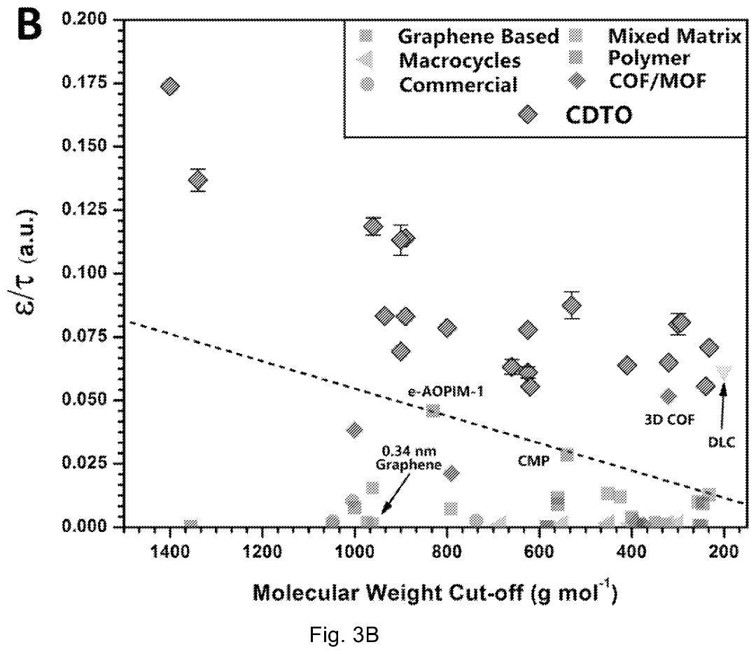

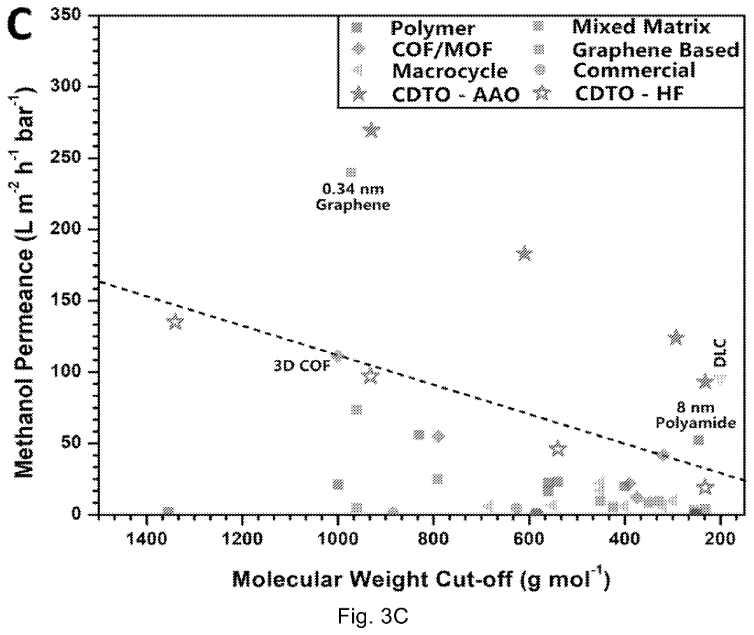

It is believed densely packed nanopores with low tortuosity in CDTO is responsible for the ultrafast solvent transport. As observed, solvent transport through CDTO nanofilms is highly dependent on viscosity, with minimal interaction between solvent and the membrane material. In such a case, solvent transport is described by the ‘pore-flow’ model, following the Hagen-Poiseuille equation:

$$Permeance = \frac{J}{Δ P} = \frac{π ε {r}_{p}^{2}}{8 μδτ}$$

where J is solvent flux, ΔP transmembrane pressure drop, ε surface porosity, rₚ pore radius, μ solvent viscosity, δ membrane thickness, and t tortuosity. Although Hansen solubility correction may be required for some materials exhibiting considerable interaction with solvents, the nature of transport remains the same. This aligns with the observation of viscosity dependent permeance (FIG. 2A-B), proportional increase of flux with transmembrane pressure drop (up to 35 bar), and slightly higher rejection in dead-ended operation than crossflow. While reducing ‘δ’ proportionally increases permeance, high ε/τ, indicating high density of nanopores with low tortuosity, can also boost transport (FIG. 3A), eliminating challenging fabrication of membranes with ‘near atomic’ thinness.

Properties of nanoporous membranes, including pore density, pore size and its distribution, and pore connectivity, are important for understanding and improving transport through membranes. An estimation for these properties is made from measurements of permeation and separation performance of the nanoporous films. Thus, ε/τ of CDTO nanofilms and that of the reported OSN membranes were calculated, using pure methanol flux and the calculated effective pore size, and compared them as a function of MWCO (Range: 200-1,400 Da). As shown in FIG. 3B, ε/τ of CDTO nanofilms increases with the increase of MWCO generally, with the highest value of 0.175. This general trend suggests desired nanoporous structure (high ε/τ) for high permeation rate could be generated more easily for larger nanopores but more challenging for smaller nanopores. Naturally, it is thermodynamically unfavorable to generate highly porous materials with smaller nanopores, as smaller pores tend to merge into larger ones, minimizing surface area and hence free energy. Materials that are relatively rigid and crystalline in nature may own large amount of small nanopores, such as MOFs, ZIFs, and zeolites. However, they usually lack the processibility of amorphous polymers, thus challenging to assemble them into thin, defect-free films.

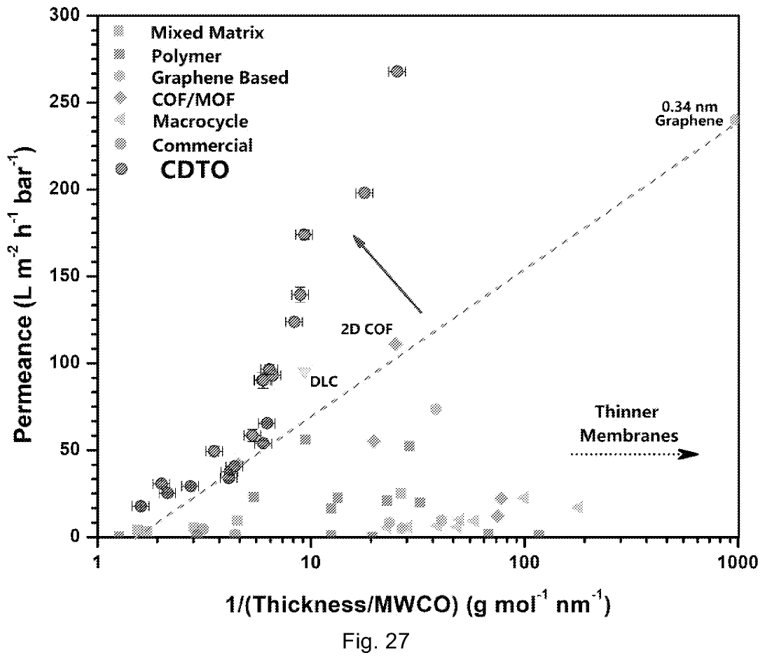

Compared with commercial OSN membranes with the same MWCO, ε/τ of CDTO nanofilms is approximately 1 to 2 orders of magnitude higher. Compared with the OSN membranes reported in the literature, ε/τ of CDTO is 1.6 to 3 times higher at 400-1,000 Da; only at about 200 and 300 Da, two best reported OSN membranes, diamond like carbon (DLC) and 3D COF, show comparable ε/τ. It was speculated that during calcination, homogeneously distributed, large number of carbon atoms in OHF (FIG. 1B-I and II, FIG. 12) be removed from the structure, leaving behind high-density, evenly distributed small nanopores with low tortuosity and thus conferring a high ε/τ (observed in simulation, FIG. 1B). It is believed high mechanical strength of Ti—O network after carbon removal (Table 1) is essential to maintain large number of small nanopores without them being collapsing into larger ones. Coincidentally, DLC membrane, which has ε/τ close to that of CDTO, also has a very high Young's modulus. The high ε/τ of CDTO nanofilms favors fast transport of solvent molecules and thus ensures their ultrahigh permeance, even if they are thicker or have comparable thickness to other OSN membranes (FIG. 27). CDTO nanofilms' OSN performance was compared with commercial and reported OSN membranes, in terms of MWCO and pure methanol permeance (FIG. 3B, Table 6). With the same MWCO, CDTO nanofilms on AAO (high permeance support) exhibit approximately 2 times higher permeance than the highest reported values, apparently resulting from the high ε/τ. Even CDTO nanofilms on HF (low permeance support) are at par with the best reported membranes.

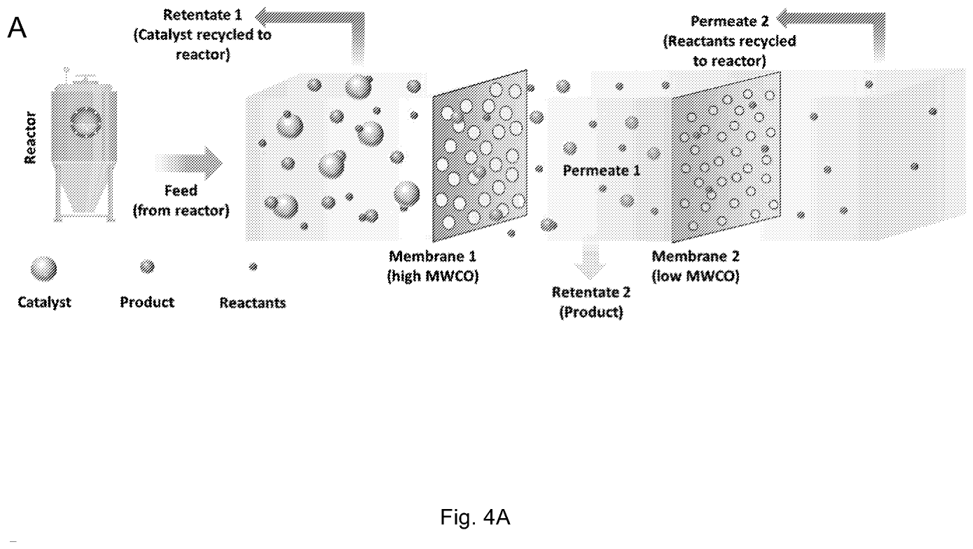

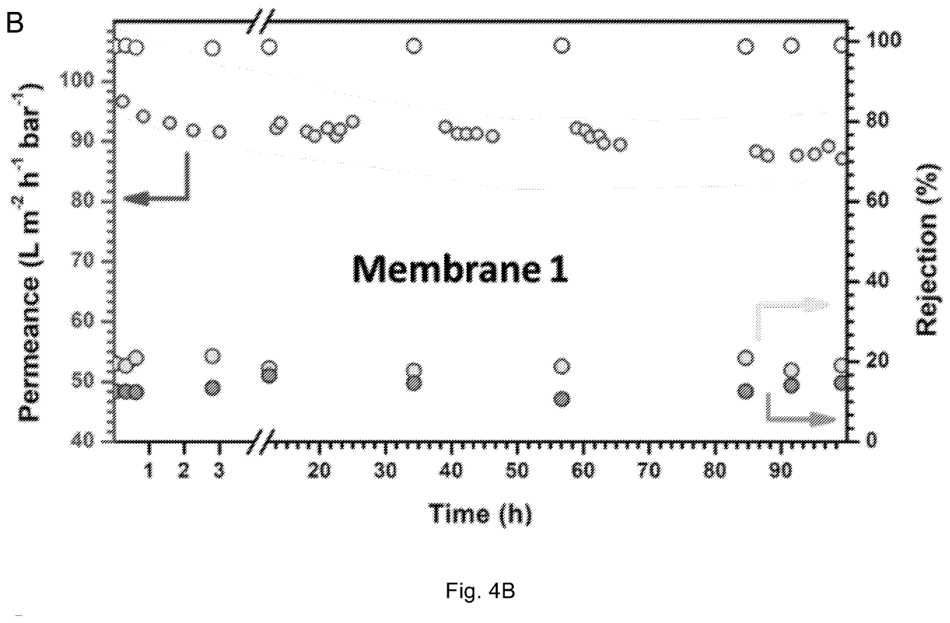

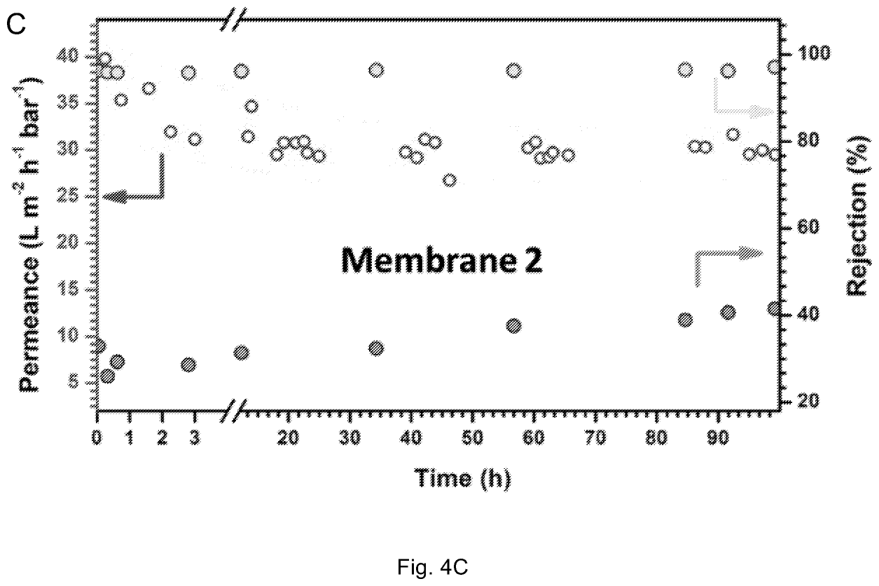

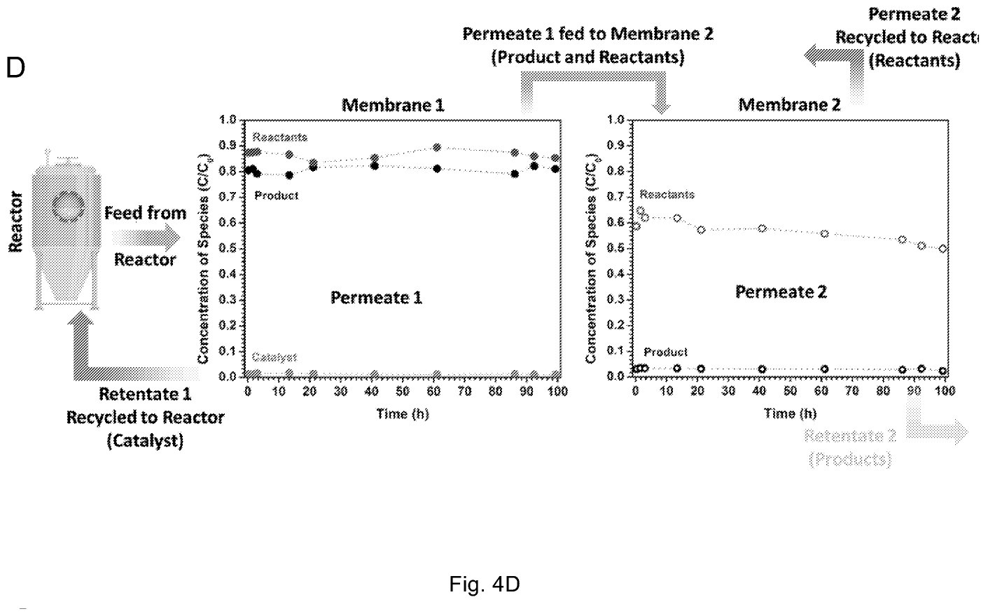

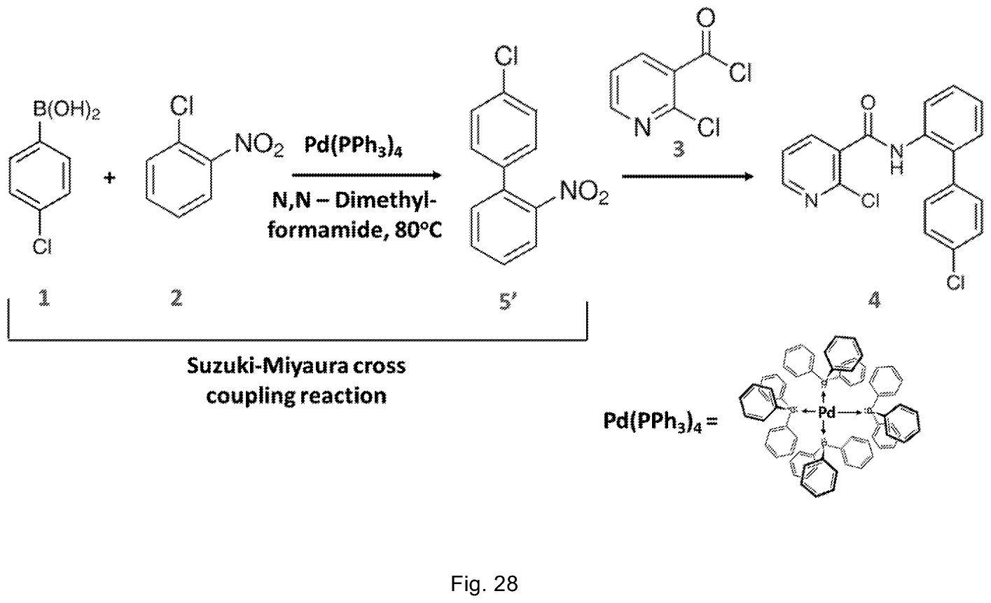

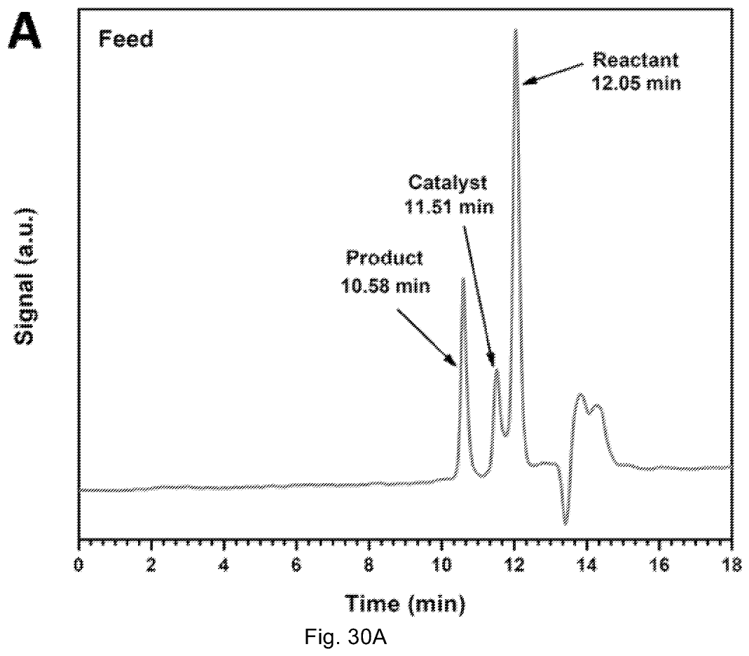

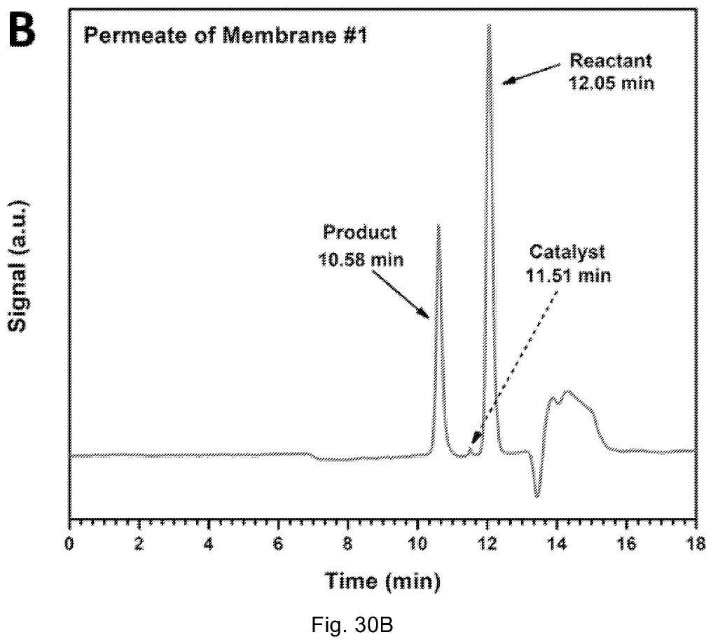

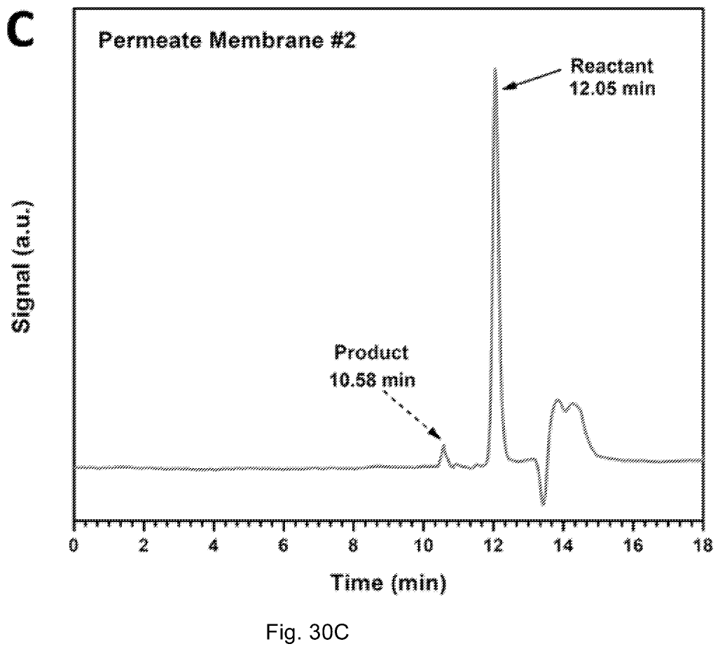

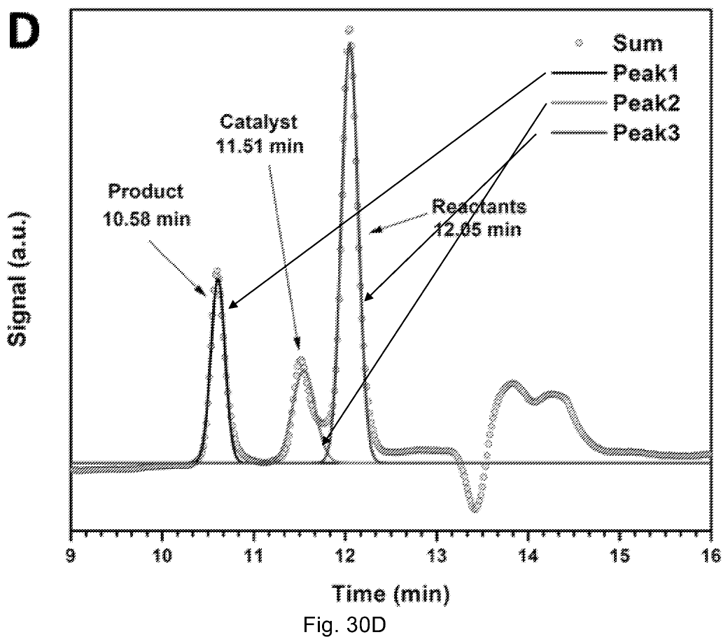

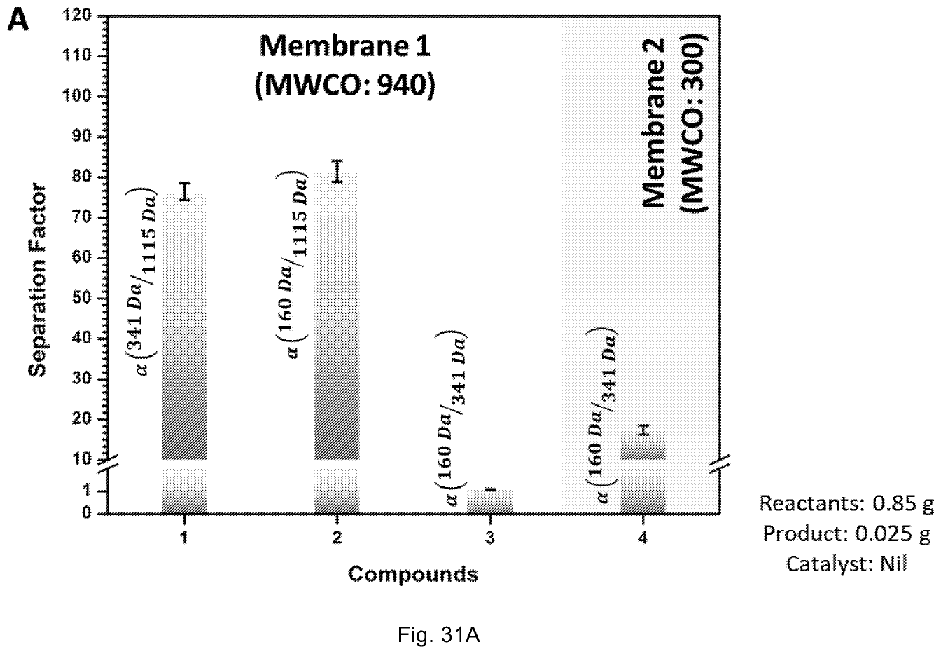

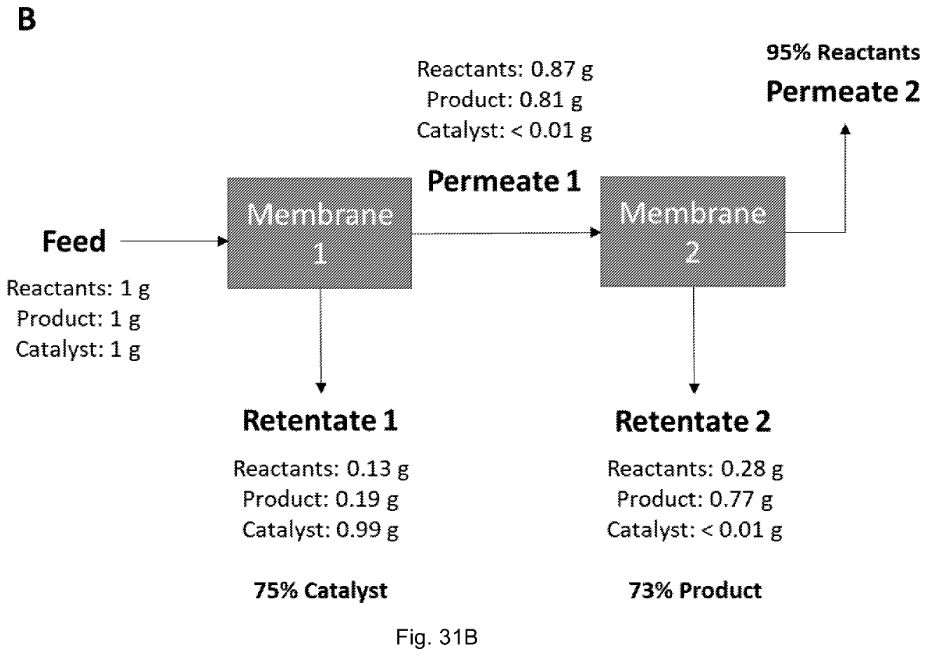

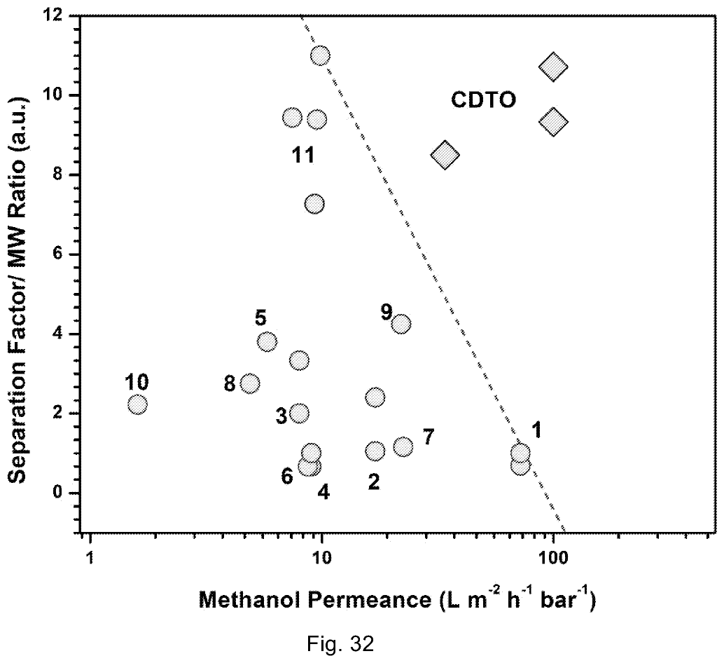

Specialty chemicals, for example, small drugs, agrichemicals, etc., require challenging synthesis conditions, involving harsh solvents at high temperatures and pressures. Membranes that are stable under such conditions can significantly reduce energy consumption by separating products/catalysts from reactors at the synthesis conditions. While most polymeric membranes may fail, CDTO membranes are stable and expected to be effective for such applications. To demonstrate this, CDTO membranes with appropriate MWCOs were selected and used for separating reactants, product, and homogeneous catalyst in the production of the pesticide Boscalid under industrially relevant harsh conditions. Boscalid is a representative of the growing USD 600 billion specialty chemical market. A two-stage membrane cascade system was designed using two appropriate CDTO membranes with MWCOs of 940 Da and 300 Da (Table 7), respectively, to separate i) catalyst from reactants and product and ii) product from reactants at 90° C. in DMF (FIG. 4A; FIGS. 28-31, Table 7). 100-h continuous operation demonstrated CDTO's capability of sustained rejection of catalyst and product with an excellent separation factor of 65.9 (product/catalyst) and 17.4 (reactants/product) for the looser membrane 1 (higher MWCO) and tighter membrane 2 (lower MWCO), respectively, while being stable in a harsh solvent, DMF at 90° C., close to actual synthesis conditions (FIG. 4B, C). These high separation factors (comparison with literature in FIG. 30) led to highly effective catalyst recovery (<1% loss) and extraction of 80-90% of the reactants/product by membrane 1 and highly efficient reactants recovery (with <5% product) for recycling.

In summary, this work addresses the need of inorganic versions of interfacial polymer membranes, which can be fabricated into defect-free nanofilms, via fast interfacial reaction. CDTO nanofilms are stable in harsh solvents at temperature up to 140° C. and have rigid nanopores that can be precisely controlled within the entire OSN range, exhibiting broad and precise pore tunability for a single OSN membrane material. CDTO nanofilms exhibit the highest ε/τ in the OSN range, probably resulting from their mechanical strength that enables high-density, evenly distributed nanopores. As a result, they show desirable organic permeance, even when they are not atomically thin. This new material exhibits stability of ceramics along with tunability and processability of polymers, expectedly extending OSN membranes into a new application domain involving harsh industrially relevant conditions. In addition, other metallic and organic reactants employed in traditional MLD process are expected to be useful in this interfacial reaction process for stable, skin membrane fabrication at time scales much shorter than vapor-phase, layer-by-layer MLD process.

Materials and Methods. Chemicals and Materials.

Membrane supports-Whatman Anodic Alumina Oxide (AAO) (pore size: 0.02 μm; diameter: 47 mm and 13 mm) was purchased from Sigma Aldrich, and α-alumina ceramic hollow fiber (outer diameter: 1.5 mm and 5.7 mm; pore size: 5, 10 and 50 nm) was purchased from Media and Process Technology Inc. (USA). Ethylene glycol (EG, 99.8%), titanium (IV) tetrachloride (TiCl₄, 99.9% trace metal basis and 1 Molar in Toluene), methanol (99.9%), isopropyl alcohol (99.5%), N,N-Dimethylformamide (DMF, 99.8%), 1,2-propylene glycol, 1,3-propylene glycol, and dyes (Azobenzene, Methyl Orange, Acid Fuchsin, Congo Red, and Rose Bengal, Indigo Carmine, Reactive Red 120) were purchased from Sigma Aldrich. Ethanol was obtained from Decon Labs, Inc. Hexane (99.9%), Hexanes (for use as solvent), and toluene (99.99%) were obtained from Fisher chemical. Ultrapure N₂ from Airgas was used for filtration experiments and to maintain an inert atmosphere during thermal treatment. All chemicals were directly used without further purification. Water, when used, was DI water. Commercial OSN membranes (Evonik Puramem Flux, Evonik Puramem Selective, Brosig oNF2, and Borsig oNF3) were purchased from Sterlitech Corporation.

Dense hybrid nanofilm synthesis via interfacial reaction. Interfacial reaction between TiCl₄ (liquid/vapor) and liquid glycols (ethylene/propylene glycols) was used to prepare the skin layer of organometallic hybrid film (OHF) on porous substrates. The porous support was heated at 200° C. and immersed into glycols (pre-heated at 140° C.) and kept for at least 2 h (h=hour(s)). The porous support soaked in glycols was then taken out, and compressed air/N₂ was used to blow away excess liquid on the surface. During OHF formation on hollow fiber, Teflon tapes were wrapped at two ends of the hollow fiber to prevent the entry of the TiCl₄ into the inner lumen side of the hollow fiber, limiting OHF formation only on the outer surface. The support with pores filled with glycols was then placed in a container with the metallic reactant, either in liquid phase (TiCl₄ solution) or in vapor phase (generated by heating liquid TiCl₄). The TiCl₄ solution was preheated to the desired temperature to ensure fast reaction. The as-synthesized OHF after extensive toluene/hexane and water washing was dried overnight in a forced air oven at 80° C. To alter the carbon content of the dense nanofilms, EG was also mixed with a certain amount of water (by weight percent), varying from 10 to 30 wt. % with a step change of 10%. The most optimized method of high temperature, 2 phase vapor-liquid interfacial reaction was employed for forming OHF.

Different techniques of generating this skin layer via interfacial reaction were investigated to find the best process of fabricating these OHF. The metallic reactant's (TiCl₄) phase was varied—either in the vapor phase or in the liquid phase while the organic reactant (EG) was maintained in a liquid phase. In the vapor-phase TiCl₄ reaction, the vapor was generated from pure TiCl₄ (99.9% trace metal basis). In the liquid-phase reaction, TiCl₄ solution in toluene was used and its concentration was varied between 0.01 and 1 mol L⁻¹ in toluene. Further discussion on the optimization of the nanofilm fabrication process is provided herein. Due to the ease of handling and its industrial applicability, porous hollow fiber support was used for optimizing the nanofilm fabrication process. Teflon tapes were wrapped at the two ends of the hollow fiber to prevent the entry of the TiCl₄ (liquid or vapor) into the inner lumen side of the hollow fiber preventing interfacial reaction on the inner surface. This limited the nanofilm formation only on the outer surface of the hollow fiber.

Single Phase reaction: For one phase interfacial reaction (with both reactants being in liquid phase), the hollow fiber support (pore size: 50 nm, or 10 nm or 5 nm) was heated at 200° C. overnight in a forced air oven to remove adsorbed moisture. The heated porous hollow fiber support was then immersed into a container with a pre-heated EG at 140° C. and kept for 2 h. Heating the organic reactant reduces its viscosity and facilitates its penetration into the support pores. The porous support soaked in organic reactant was then taken out, and compressed air or N₂ was used to blow away excess reactant on the surface. Teflon tape was used to seal the two ends of the hollow fiber to prevent the deposition of nanofilm on the inner surface of the hollow fiber. The organic reactant-soaked support was then dipped into a container having the metallic reactant at the desired concentration. Solution with lower concentrations of TiCl₄ was prepared by diluting the 1 mol L⁻¹ TiCl₄ solution in toluene by adding the desired amount of pure toluene. The TiCl₄ solution was preheated to the desired temperature to ensure proper reaction temperature during the formation of a dense OHF.

Two-Phase Reaction: For a two-phase interfacial reaction, a schematic presentation of the preparation of dense OHF was shown in FIG. 5. Firstly, the porous support (AAO or hollow fiber) was heated at 200° C., overnight, in a forced air oven to remove residual moisture and then rapidly soaked in the pre-heated liquid organic reactant, such as EG, at 140° C. and kept for 2 h. Compressed air or N₂ was purged parallel to the surface immediately after taking them out of the liquid reactant for removing residual liquid on the surface. Then, the organic reactant-soaked support was placed in a sealed container (without touching the liquid metallic reactant, FIG. 5) with preheated liquid TiCl₄ at 150° C. at the bottom to allow the TiCl₄ vapor to come in contact with the liquid EG at the pore mouth of the support for the vapor-liquid interfacial reaction to take place and form a dense, non-porous OHF.

The as-synthesized OHF after extensive toluene/hexane and water washing was dried overnight in a forced air oven at 80° C. Particularly, while depositing the OHF on the hollow fiber support, the two ends of the hollow fiber were sealed off using Teflon tapes to prevent the vapor of TiCl₄ from entering the lumen side. The OHF grows on both sides of the AAO (but can only form a continuous skin layer on the top surface with smaller pores), while its growth on the hollow fiber support can be limited to one surface if required by sealing off the ends using Teflon tapes.

Varying the composition of dense nanofilm: To alter the carbon content of the dense nanofilm, EG was mixed with a certain amount of water (by weight percent), varying from 10 to 30 wt. % with a step change of 10%. The dense nanofilm preparation methods with the water-EG membranes were the same as the pure organic reactant-based membrane. Different organic reactants with a larger number of carbon atoms were used to generate OHF. 1,2-Propylene glycol (3 carbons) and 1,3-propylene glycol (also 3 carbons, glycol isomer) were also used as the organic reactant with TiCl₄ as the metal reactant to demonstrate the versatility of our double substitution reaction. When different organic reactants were used, a similar procedure FIG. 5 was followed. The OHF using varying organic reactants was prepared on both AAO and Hollow fiber support. The most optimized method of high temperature, 2 phase vapor-liquid interfacial reaction was employed while forming OHF.

Porous nanofilms generated through thermal treatment. The organic part (carbon) of OHF can be removed by thermal treatment (calcination) under different conditions (varying thermal treatment temperature and atmosphere), and subsequently converting to porous nanofilms with different pore sizes and compositions. As discussed above, the retained carbon quantity in the metal oxide framework (carbon doping) greatly influences the pores of the as synthesized porous nanofilm, these porous nanofilms are referred to as Carbon Doped Titanium Oxide (CDTO). All calcinations were carried out for a fixed time of 2 h and the temperature was ramped up and down at 1° C. min⁻¹ in a quartz tube furnace. For thermal treatment in N₂, an ultrapure N₂ flow at rate of 5 ml min⁻¹ was maintained using a mass flow controller in a fused quartz tube after flushing all the air out of the furnace at a high N₂ flow rate (60 ml min-1) for 1 h. All thermal treatment was done in a tubular furnace (OTF-1200X-S-NT-LD, MTI corporation, CA, US). Based on the calcination environment (air or N₂), the porous nanofilm was named CDTO-Air or CDTO-N₂ (If no temperature is indicated, the CDTO is formed by calcining at 250° C.).

Porous nanofilms generation via thermal treatment. Carbon from OHF was removed by thermal treatment/calcination under different conditions to convert OHF to porous nanofilms-Carbon Doped Titanium Oxide (CDTO), with different pore sizes and compositions. All calcinations were carried out for 2 h, and the temperature was ramped up and down at 1° C. min⁻¹ in a quartz tube furnace. For calcination in N₂, N₂ was flown at 5 ml min-1 for calcination under N₂ environment. For calcination in air, the samples were calcined in stagnant air.

Porous Skin nanofilms Characterization. The surface and cross-sectional morphologies of the fabricated OHF and CDTO were characterized by field emission scanning electron microscopy (FE-SEM) conducted on a Zeiss SUPPA 55 instrument. Before loading into the vacuum chamber for SEM, the samples were sputter-coated using gold with an estimated thickness of 0.3 nm.

The element composition was analyzed by X-ray photoelectron spectroscopy (XPS) equipped with an Al K-alphas X-ray gun of a spectral resolution of <0.5 eV. The measurements were done under vacuum pressure of <10⁻⁸ torr. The detailed scan for individual elements was used to determine the chemical environment of the atoms (the bonds), and the area under these curves was used to evaluate the elemental composition of the OHF and CDTO nanofilms. The whole spectrum scan was averaged over 6 runs, while a detailed scan of the individual elements was averaged over 10 scans.

The water contact angle was measured with a contact angle goniometer (DSA100E, Kruss) at room temperature. 3 μl of water was dropped on the surface of the OHF and CDTO, and the image of the water droplet was captured instantly by the instrument. The instrument measures and provides individually the left and right contact angles. The values of the contact angle presented are the average of these two values. All the membranes were dried at 70° C. before the contact angle measurement.

Force measurement was conducted by using a Bruker Icon AFM (Santa Barbara, CA) system. In the Atomic Force Microscopy (AFM) experiment, contact mode was used to obtain the topographic information of the OHF and CDTO thin films. A high spring constant (200-400 N/m) AFM probe (Al-coated, TM525A, AppNano) with the resonance frequency of 515 kHz, a tip of a radius of curvature of <10 nm, half-angle of 18° was used as the probe. Multiple locations on the film were tested with a scan size of ˜10×10 μm. The force analyzations (DMT model) and topographic images were processed using NanoScope Analysis software (V1.5, Bruker). For reference, the Young's modulus of Soda Lime microscope glass slide was measured and it's Young's Modulus was 73.7±2.3 GPa, which is close to values reported in literature for the material.

Thermogravimetric analysis (TGA) was done to examine the thermal stability of the non-porous OHF material and the CDTO. TGA was done in TA Instruments DSC SDT Q600 under 100 ml min⁻¹ flow rate of N₂ and air. All gases were of high purity, purchased from Airgas, USA. Before starting the temperature ramp, the sample was subjected to dry N₂ at 70° C. for 15 min. The ramping was done at 10° C. min⁻¹ from 30° C. to 450° C.

Surface charge or Zeta potential of CDTO-Air and CDTO-N₂ was measured in Anton Parr Surpass 3 instrument. Electrokinetic zeta potential was measured from the streaming current and streaming potential using Helmholtz and Smoluchowski model when 10 mmol of KCl solution is flown between the two nanofilm surfaces facing each other.

X-Ray Diffraction (XRD) was measured using Bruker DB-Discover 8D diffractometer to understand the amorphous nature of the prepared CDTO and OHF. The diffraction was measured between 20=5° and 80° with a scanning speed of 0.5° sec⁻¹, averaged over 3 readings.

Furrier Transfer Infrared Spectrograph (FTIR) of OHF and CDTO was measured using Nicolet™ iS™ 5 FTIR Spectrometer. Readings were taken between 4,000 cm⁻¹ and 400 cm⁻¹ at an interval of 0.2 cm⁻¹ and averaged over 16 readings.

Permeation measurements. A Sterlitech dead-end pressure filtration cell (HP4749) for CDTO membranes prepared on AAO and a home-built filtration cell (for CDTO membranes prepared on hollow fiber) were used to measure the organic solvent permeance and evaluate the separation performance of nanofilms and to ensure defect-free OHF formation. The measurements were conducted at 80 PSIG at room temperature (˜20° C.) for rejection of dyes and 40 PSIG for evaluating pure solvent permeance (unless otherwise specified; temperature and pressure were changed for high-temperature membrane evaluation and pressure dependence on flux measurements). A magnetic stirrer was used to mitigate concentration polarization and hence minimize fouling during the dye rejection experiments. A membrane area (Aₘ) of 1.13 cm² (diameter of the home build aluminum module was 1.2 cm) was used for evaluation of CDTO nanofilms on flat AAO support, and for the CDTO nanofilms prepared on hollow fiber support, the effective permeation area was 0.7 cm² (length of 1.5 cm with outer diameter of hollow fiber being 1.5 mm) for 50 nm pore size support and 16.65 cm² (length: 5 cm, OD: 5.3 mm) for hollow fibers of 10 nm and 5 nm pore size. The weight of the permeate collected was measured (wₜ), and using the density of the corresponding solvent (ρₛ) at the testing temperature, the exact volume (Vₜ) of the permeate collected was determined over some time (Δt) of collection [Vₜ=wₜ/ρₛ]. Marine Weld™ epoxy from JB Weld, Texas, US was used to seal the CDTO nanofilms to the flat sheet and hollow fiber module(s). A home-built permeation setup was used for the evaluation of the performance of CDTO nanofilms prepared on hollow fibers. The flux (J) of the corresponding CDTO nanofilm was calculated using the following formula:

$$J = {V}_{t} / ( Δ t \times {A}_{m} ) \qquad ( 1 )$$

And the corresponding permeance was calculated by normalizing the flux by the transmembrane pressure drop (ΔP):

$$P = J / Δ P \qquad ( 2 )$$

The detection limit of our solvent permeation setup was 0.05 L m⁻² h⁻¹ bar⁻¹, and any membrane demonstrating permeance less than this value is considered as dense or impermeable. This value is at least 2 orders of magnitude lower than that of the CDTO membranes having the lowest permeance.

To estimate the Gas (N₂ and H₂) permeance of the as-prepared nanofilms, a standard bubble flowmeter was used. The gas of choice was pressurized at room temperature through the non-porous dense OHF or CDTO nanofilms at 5 bar feed pressure (ΔP) and the permeate was introduced into the bubble flow meter. The time (t, in seconds) for a soap meniscus to travel a certain length (i.e., volume, V, in L) was recorded. The permeance through these nanofilms (of Area=A, in m²) was calculated using the following formula:

$$P = J / Δ P = \frac{( V / 22.4 ) \times ( \frac{298.15}{273.15} )}{A \times t \times Δ P} \qquad ( 3 )$$

NOTE: Special care must be taken while measuring H₂ permeance because of its explosive nature.
The detection limit of our gas permeation system was 1×10⁻¹² mol m⁻² s⁻¹ Pa⁻¹.

The ideal gas selectivity (α) was calculated by simply taking the ratio of the permeances of the two gases through the membrane:

$$α = {P}_{gas 1} / {P}_{ga s 2} \qquad ( 4 )$$

To probe the pore size of the CDTO nanofilms, dye rejection measurements were conducted in methanol, as a model solvent with a feed concentration of 20 mg L⁻¹ (otherwise stated). A series of dyes with varying molecular weight (Table 5 were used to determine the molecular weight cut-off (MWCO) for these membranes. MWCO of a membrane is defined as the molecular weight (M_{w}) for which the membrane shows a rejection of 90% or higher for molecules having molecular weight of >M_{w}. A permeate volume of >4 ml (˜ 10% of feed) was collected to check the rejection (otherwise stated) using the UV-vis spectrophotometer (Model: Thermo Scientific AquaMate 7100). It was assumed that the addition of dyes (20 mg L⁻¹) maintains the density of the solution constant. The pure solvent permeance of porous nanofilm was used to evaluate membrane microstructure using the Hagen-Poiseuille model:

$$P = J / Δ P = \frac{π ε {r}^{2}}{8 μτδ} \qquad ( 5 )$$

Where J solvent flux, ΔP the pressure drop across the membrane, ε porosity, r pore radius, μ solvent viscosity, τ tortuosity, and δ nanofilm thickness.

The rejection of a solute (say, i) through these membranes was calculated as follows:

$${Rejection}_{i} = ( 1 - \frac{{C}_{p , i}}{{C}_{f , i}} ) \times 100 \% \qquad ( 6 )$$

Where C_{p,i} and C_{f,i} are the concentration of the solute ‘i’ in the permeate and feed respectively, calculated from their corresponding absorbance recorded from the UV-Vis spectrometer.

### Two Stage Membrane Cascade System for Demonstrating Separation in Boscalid Production.

To demonstrate the applicability of CDTO membrane in real industrial scenarios was demonstrated. There is a need for precise separation of molecules (products and catalysts) in specialty chemical industries, which in 2021 values over 600 billion USD. Specialty chemicals includes small drug molecules, agricultural chemicals, chemicals for food and beverage industries, surfactants, lubricants, paints, cosmetic products among many others. These chemicals are synthesized under harsh conditions involving high temperature and pressures often associated with harsh organic solvents. A large amount of energy can be saved by applying non thermal based separation for product and catalysts at conditions very close to the synthesis condition for these chemicals. Most polymeric membranes, although some of them are resistant to solvents, fails to operate at these harsh conditions. CDTO on the other hand, with facile interfacial fabrication, similar to interfacial polymer membranes, but its inorganic analog, has rigid pores which are very stable at high temperatures and pressure in presence of harsh organic solvents are desirable for this kind of separation. To demonstrate the applicability of CDTO in industrial separation, the production of Boscalid was investigated (molecule 4 in FIG. 28, IUPAC: 2-Chloro-N-(4′-chlorobiphenyl-2-yl)-nicotinamide), a pesticide commonly used. It is synthesized by Suzuki-Miyaura cross-coupling of 4-Chlorophenylboronic acid (molecule 1 in FIG. 28) and 1-Chloro-2-nitrobenzene (molecule 2 in FIG. 28) using Pd(PPh₃)₄ catalyst (IUPAC: Tetrakis(triphenylphosphine)palladium(0)) followed by reaction with 2-Chloropyridine-3-carbonyl chloride (molecule 3 in FIG. 28). A 2-stage membrane separation process (FIG. 29) was designed where the first CDTO membrane (membrane 1; MWCO=940 Da) rejects the catalyst, allowing the reactants and products to pass through. The second membrane with (membrane 2) MWCO=300 Da allows only the reactants to pass through while rejecting the product Boscalid. Both the separation was done in pure DMF at 80° C. with a pump flow rate of 17 ml min⁻¹. The back pressure valves at the retentate side were operated to maintain 7 bar feed side pressure. The separation was run for 100 h continuously and permeate for both membranes, along with feed at the permeate collection time was collected for analysis, at specific intervals. The feed was prepared with an arbitrary concentration (60 mg L⁻¹ each) of the product, reactant(s) and catalyst. For single component rejection, the concentration was maintained at 10 mg L⁻¹ for all components. The collected permeate and feed was analyzed using a Refractive Index detector in a Gel Permeation Chromatography (Agilent; Column InfinityLab OligoPore, 7.5×300 mm. PL 1213-6520) with DMF as the mobile phase. The area under the curve obtained from GPC chromatograph was used to correlate with the concentration of each product.

Optimization of OHF formation. The metallic reactant used (TiCl₄) reacts with the organic reactants (example: EG, 1,2-propylene glycol or 1,3-propylene glycol) via a simple substitution reaction (FIG. 6, shown for EG). The interfacial reaction between the metallic and organic reactants was used to fabricate OHF as a skin layer on the surface of the porous support. For the OHF fabrication, the organic reactant was always maintained in the liquid phase (because of its low vapor pressure causing difficulty in vaporization, for example, the vapor pressure of EG is only 0.012 kPa at 25° C.). The pores of the porous support were filled with the liquid organic reactant, while the metallic reactant was either introduced in liquid or vapor phase. The support used for the optimization of the dense nanofilm formation was ceramic hollow fiber (pore size: 50 nm, 10 nm, or 5 nm). A summary of all experiments for optimization is tabulated in Tables 2 and 3.

One phase interfacial reaction: both reactants in liquid phase. The following parameters were optimized keeping both reactants in liquid phase; and the temperature at which the two reactants react; and the concentration of the metallic reactant.

It was observed that on ceramic hollow fiber support (pore size: 50 nm), it required more than 180 min of reaction time to form a dense OHF (non-porous, defect-free nanofilms are the ones that exhibited <1×10⁻¹² mol m⁻² s⁻¹ Pa⁻¹ N₂ or <0.05 L m⁻² h⁻¹ bar⁻¹ methanol permeance at 5 bars transmembrane pressure) when the TiCl₄ concentration was 0.2 mol L⁻¹ (FIG. 7A). With the increase of reaction time under this condition (from 30 min to 180 min), the N₂ permeance through the OHF decreased, indicating the formation of dense, non-porous material that obstructs the flow of N₂. However, when the concentration of TiCl₄ was increased, the time required to form a dense OHF was much less (120 min for 0.3 mol L⁻¹, and 60 min for TiCl₄ concentration of 0.4 mol L⁻¹; FIG. 7B). Moreover, to investigate whether the amount of hybrid material formed at the interface, in form of OHF on the support, is a function of the concentration of TiCl₄ or not, the N₂ permeation was measured after an arbitrary time, 30 min, after the start of reaction with different concentrations of TiCl₄. As expected, the N₂ permeance reduced as the TiCl₄ concentration increased (FIG. 7C). SEM images were used to understand the morphology of OHF during its process of formation. For example, using 1 mol L⁻¹ metallic reactant at room temperature, after 10 min of reaction, the non-dense OHF showed 3.21×10⁻⁷ mol m⁻² s⁻¹ Pa⁻¹ N₂ permeance due to large gaps/defects that are yet to be covered by the nanofilms. Details of nanofilm preparation on 50 nm porous hollow fiber support with both reactants in liquid phase are given in Table 2.

Two-phase Interfacial Reaction: Organic reactant in the liquid phase, TiCl₄ in vapor phase. The following parameter was optimized while keeping the reactants in two different phases:
Reaction temperature. The interfacial reaction was carried out with liquid organic reactant but the metallic reactant in its vapor phase. The metallic reactant was in its pure form (99.9% trace metal, TiCl₄). Temperature of the reaction varied: room temperature (20° C.), 70° C., and 150° C. It was observed that on a 50 nm porous ceramic hollow fiber support, it required 30 min of reaction at 70° C. to form a non-porous OHF which shows no N₂ permeance. But when the interfacial reaction was carried out at 150° C., it required only 5 min to generate a dense OHF. Details of nanofilm preparation on 50 nm pore size hollow fiber support were tabulated in Table 2.
Two-phase Interfacial Reaction: Organic reactant in the liquid phase, TiCl₄ in vapor phase.

The requirement for a longer time to form a dense nanofilm may be related to the rate of reaction and the rate of diffusion of the reactant molecules to the interface at the given reaction environment. From Arrhenius equation (Eq. 1), it is obvious that the rate of reaction increases as the temperature of reaction increases.

$$k = A {e}^{- \frac{{E}_{a}}{R T}} \qquad ( 1 )$$

where K is the reaction rate constant for the reaction given in FIG. 6A, A is the Arrhenius constant, Eₐ the activation energy, R the universal gas constant, and T the temperature of the interfacial reaction. Also, diffusion of molecules changes with temperature.

For a molecule diffusing in liquid, Strokes-Einstein Equation gives:

$${D}_{l} = \frac{{k}_{B} T}{6 πγ r} \qquad ( 2 )$$

For molecules diffusing in gases, Chapman-Enskog theory gives:

$${D}_{g} = \frac{AT 3 / 2}{p {σ}_{12}^{2} Ω} \sqrt{\frac{1}{{M}_{1}} + \frac{1}{{M}_{2}}} \qquad ( 3 )$$

It is clear (from Eqs. 2 and 3) that the diffusion increases with temperature. Thus, there is a competition between the rate at which the reactant molecule diffuses to the interface and the rate at which the reaction occurs. It follows that a high-temperature reaction (faster reaction, from Eq. 1), with reactants being in the vapor phase (diffusion is faster in gas and increases faster with temperature in gas, from Eqs. 2 and 3), generates OHF fastest with no defects. Indeed, the best result in terms of time needed for the formation of the dense OHF was observed in the case of metallic reactant in the vapor phase and reaction taking place at high temperature.

Nanofilm formation using different organic reactants: Both reactants in the liquid phase. OHF was successfully on 5 nm porous ceramic hollow fiber support (Table 3) using two different organic reactants-EG (organic reactant #1) and 1,3-propylene glycol (organic reactant #2), molecules having similar structure but different carbon numbers. They both formed a dense OHF within 30 min of reaction on the 5 nm porous support at room temperature, using 0.5 mol L⁻¹ TiCl₄ in toluene. Both nanofilms were calcined in air for 2 h at 250° C. with a temperature ramp-up/down rate of 1° C. min⁻¹ to form the CDTO nanofilms. Both N₂ and H₂ permeance through the nanofilms under 5 bar transmembrane pressure were measured. Interestingly, it was observed that CDTO with EG shows lower permeance for both gases compared to CDTO prepared with 1,3-propylene glycol (FIG. 7D). However, the ideal selectivity for the gases is very similar to Knudson diffusion selectivity (Eq. 4):

$${α}_{[ {H}_{2} / {N}_{2} ]} = \frac{\sqrt{M {W}_{{N}_{2}}}}{\sqrt{M {W}_{{H}_{2}}}} \qquad ( 4 )$$

suggesting the absence of large defects in the CDTO nanofilms.

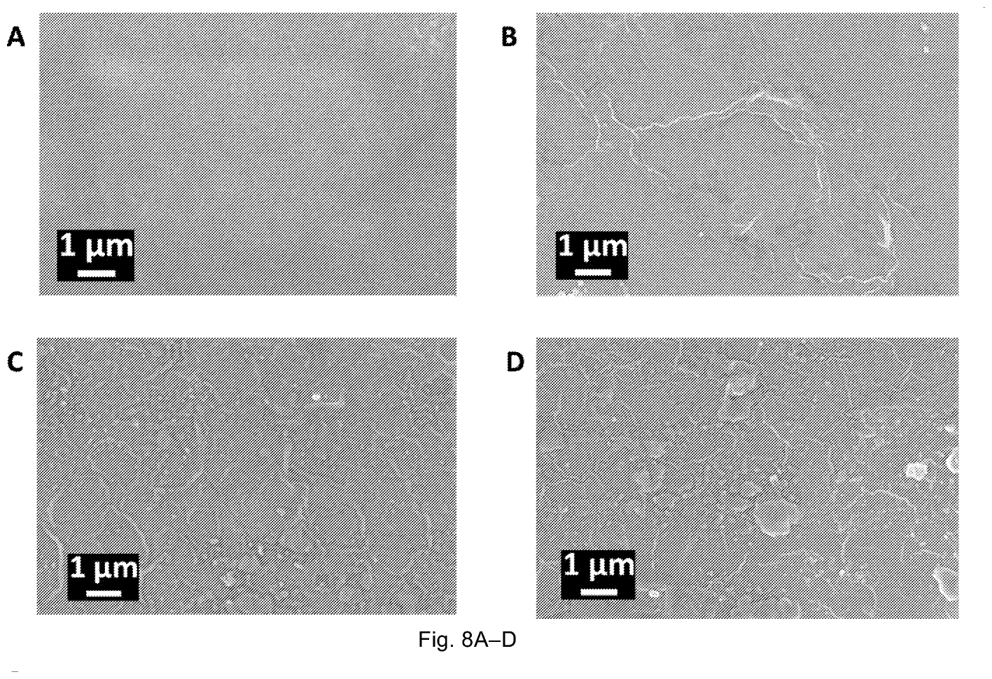

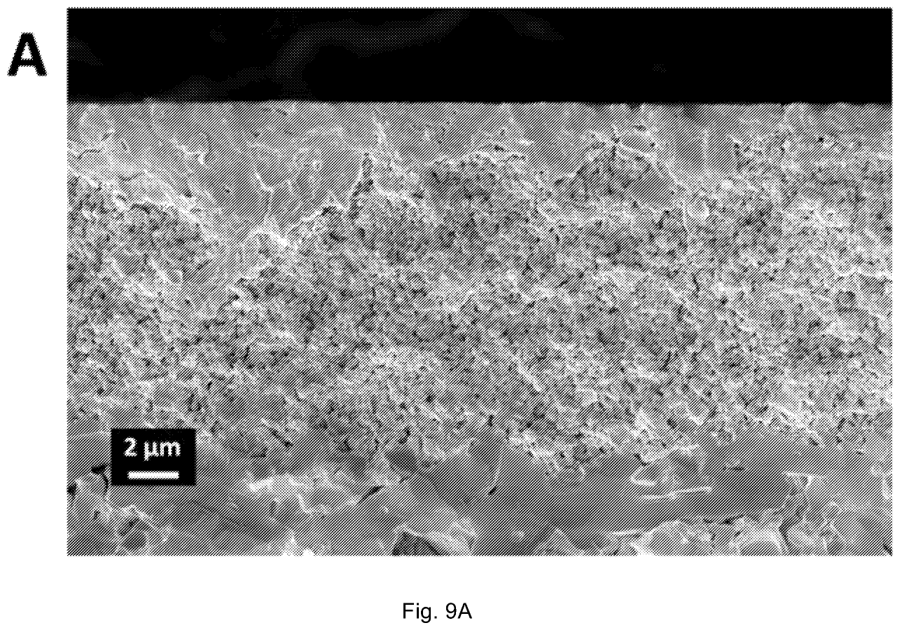

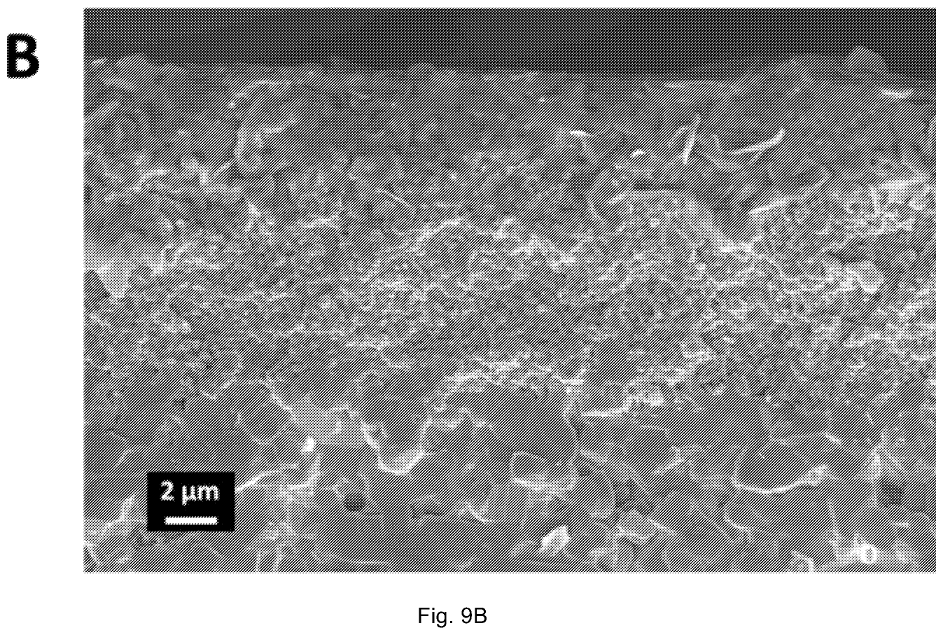

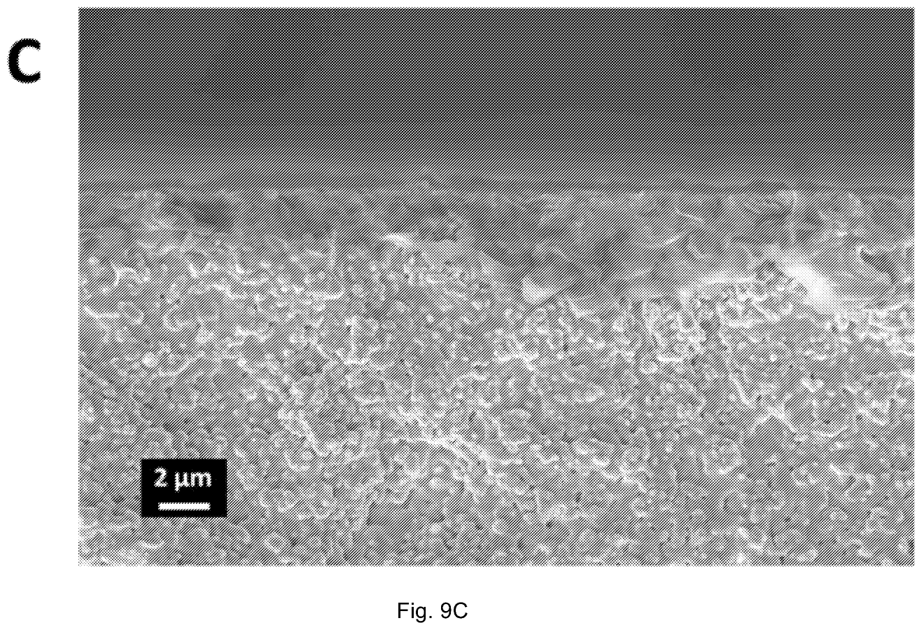

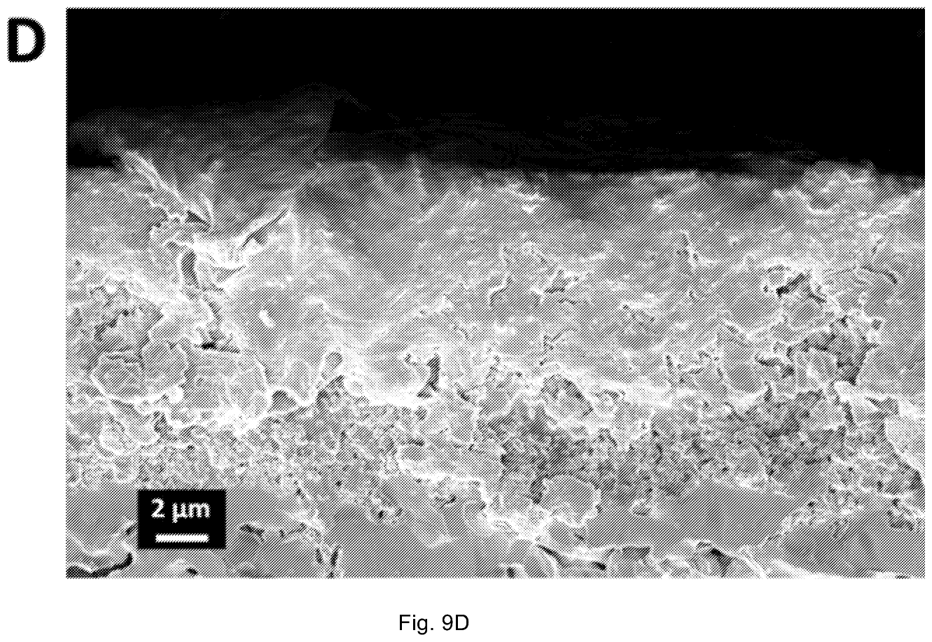

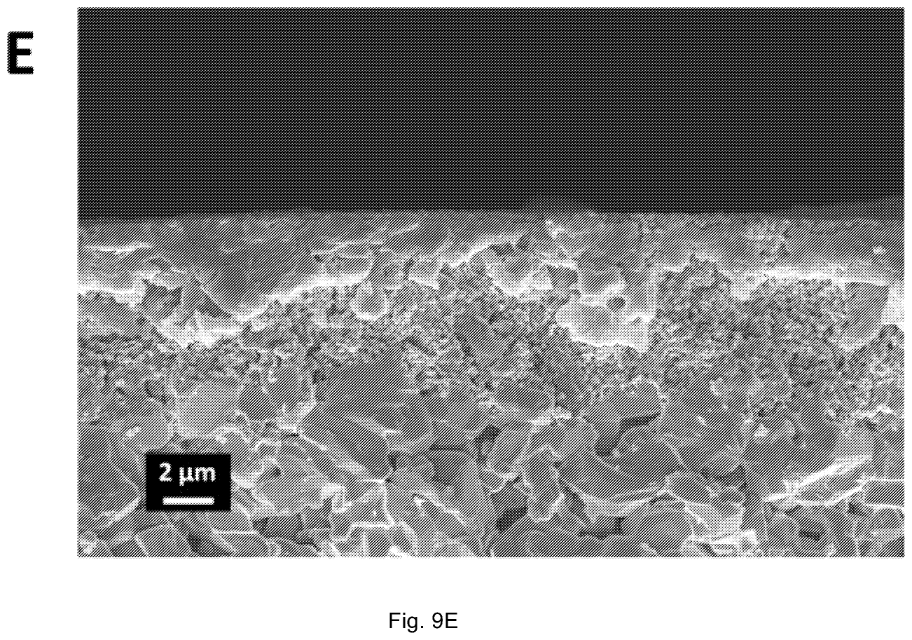

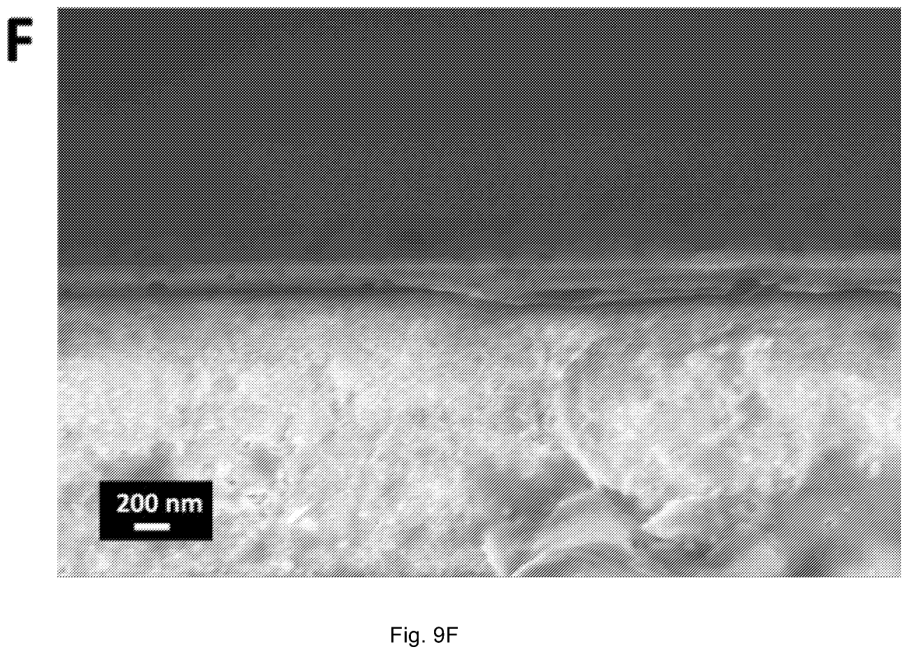

Morphology of OHF. SEM micrographs of OHF prepared with different TiCl₄ concentrations and reaction at room temperature are shown in FIG. 8. The bare unmodified 5 nm hollow fiber support looks smooth under SEM (FIG. 8A). After 30 min of liquid phase interfacial reaction on the 5 nm porous hollow fiber support, the surface got coated with OHF which is characterized by undulating surface morphology (FIG. 8A-D). Interestingly, with the increase in the concentration of TiCl₄, the surface became more and more crumpled. Also, the SEM micrographs were taken for the cross-section of the dense OHF (FIG. 9. It was observed that having the metallic reactant in the vapor phase generated the thinnest OHF (FIG. 9F) among all metallic reactant concentrations in the liquid phase (FIG. 9A-E). It requires a much greater thickness of the nanofilms to ultimately form a defect-free, continuous film if reactants are in liquid phase. This may be due to two reasons: i) lower concentrations of metallic reactant provided longer time for reactants to migrate from the bulk to the interface hence allowing many of the early arriving reactant molecules to penetrate deeper into the interface causing the wider distribution of products (hybrid network) and ii) having both reactants in the same phase may allow physical mixing of the reactant molecules at the interphase, allowing deeper penetration of either of the reactants and thus generating a thicker OHF, deeper inside the pores of the hollow fiber.

From the above discussion, it was obvious that a high-temperature reaction with liquid and vapor reactants was desirable for forming a dense nanofilm on any given porous substrate.

Separation performance of CDTO membranes. Additional experiments were performed to evaluate the performance of our CDTO membranes and further understand details of our membranes and evaluate their separation mechanism.

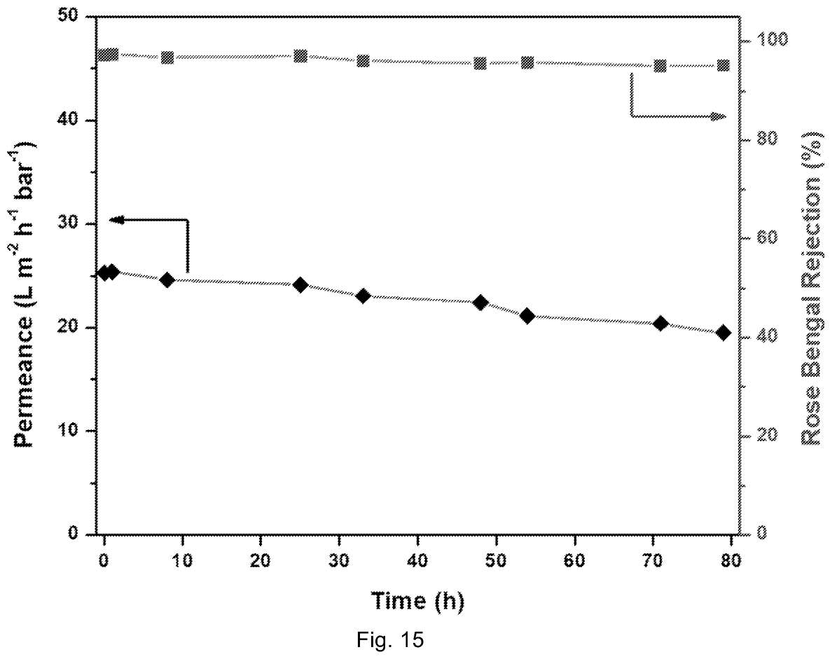

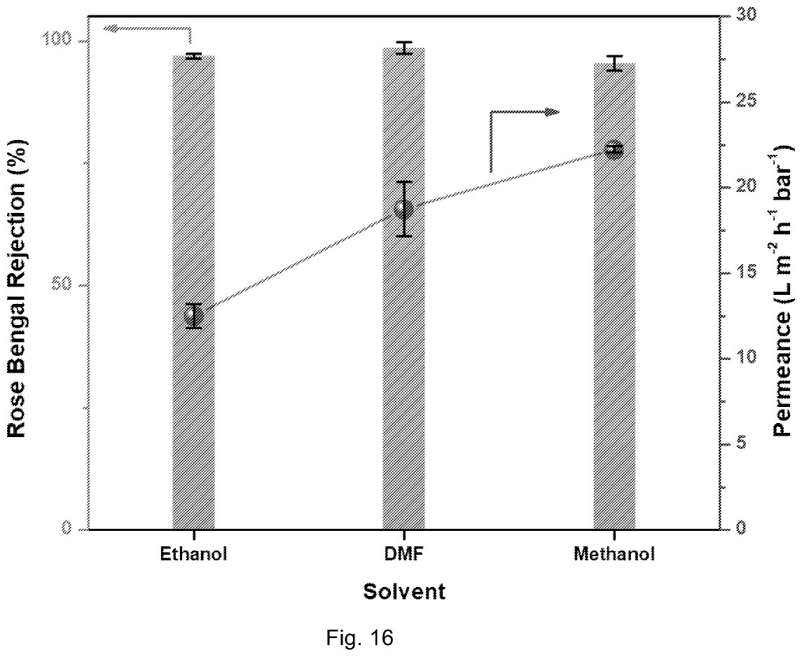

Membrane stability and pore rigidity. Experiments were designed to determine the long term stability of our membranes. The CDTO nanofilms were subjected to long-term exposure to organic solvents. With 20 mg L⁻¹ Rose Bengal in methanol, the CDTO-N₂ membrane was subjected to over 80 h of organic solvent environment. In certain intervals, the membrane was subjected to a transmembrane pressure of 5 bar and collected permeate to analyze it. Over 80 h nearly no drop in rejection of Rose Bengal through the nanofilm was observed (FIG. 15). As expected, flux dropped (<15%) over the period of collecting 30 ml of permeate due to fouling/concentration polarization. Also, a long-term stability test for pure solvent (methanol) was carried out under different pressures for the CDTO-N₂ membrane. It was observed that the permeance of pure methanol remained stable over 90 h (FIG. 16) and it was constant for different transmembrane pressures. Further, a CDTO-N₂ membrane was kept in pure DMF over a period of about 2.5 months. The membrane showed 94.61% rejection of Rose Bengal from methanol with a permeance of 23.13 L m⁻² h⁻¹ bar⁻¹, which is comparable to the performance of freshly prepared membranes.

Several experiments have been carried out to demonstrate the rigidity of the pores of the CDTO membranes. Firstly, a goal was to understand if the pores of our CDTO membranes reject the same solute similarly when being dissolved in different solvents. It has been reported in the literature that membranes often exhibit different MWCOs using different solvents. Less than 1.5% variation of rejection was found, while rejection of Rose Bengal was attempted from three different solvents-ethanol, methanol, and DMF by a CDTO-N₂ nanofilm. All filtration experiments were carried out under 5 bar transmembrane pressure. Obviously, different permeance was observed for the different solvents, with ethanol permeating slowest while methanol permeating fastest. This variation of permeance strongly follows typical viscosity dependent flow in the pores of CDTO nanofilms.

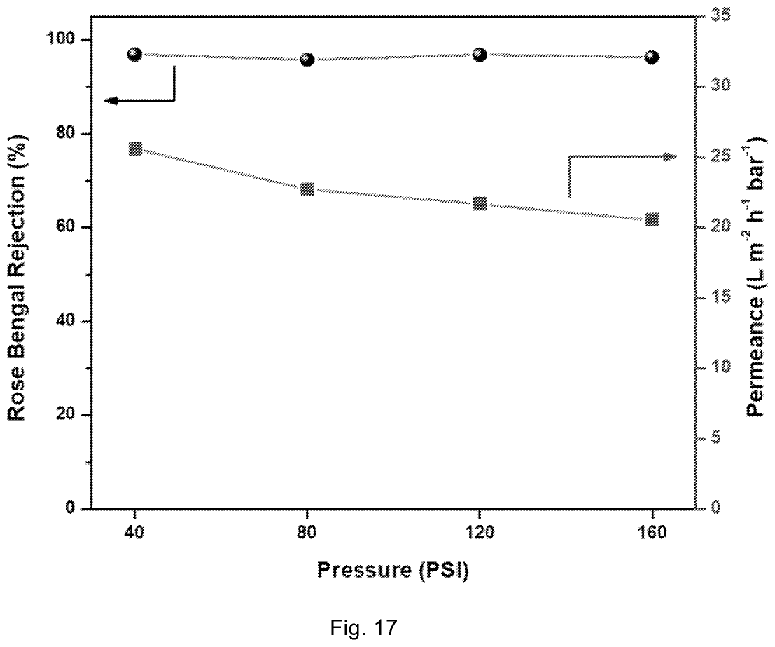

Membranes with rigid pores typically show unaltered rejection at varying operating conditions (usually, transmembrane pressure). The CDTO-N₂ membrane was subjected to transmembrane pressure ranging from 40 PSIG to 160 PSIG with 20 mg L⁻¹ Rose Bengal in methanol as feed. Little to no variation of rejection was observed (FIG. 17), indicating a very rigid porous structure of the CDTO nanofilms. However, it was seen that the permeance dropped at higher transmembrane pressure, which may be due to faster fouling at higher fluxes. This flux decline is not due to any kind of pore collapse at high pressure as it is evident from the linear increase of flux with transmembrane pressure ensuring stable rigid pores of the CDTO nanofilm.

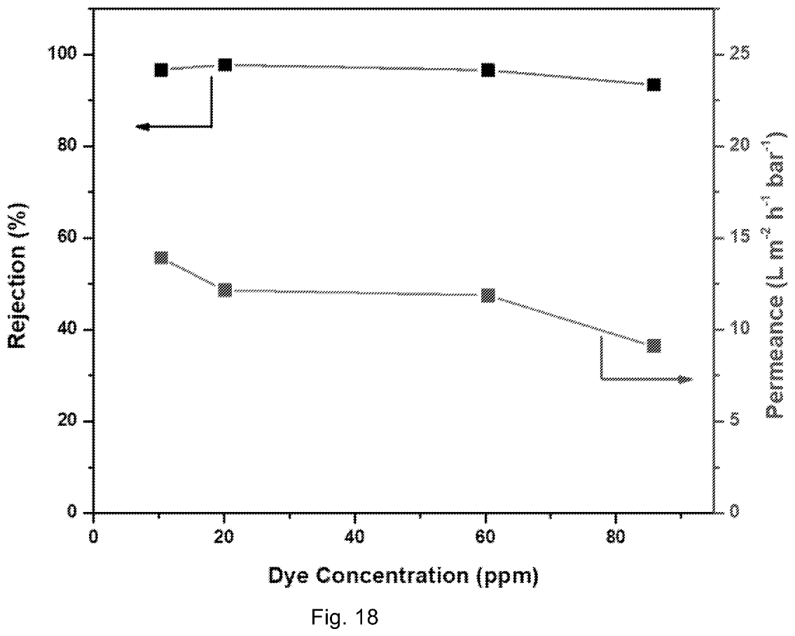

Under practical application, an OSN membrane is often subjected to variable solute concentrations. The performance of a CDTO-N₂ (30% H₂O, CDTO nanofilm which was prepared with 30% water added to EG) nanofilm was tested under the different concentrations of Acid Fuchsin as solute-varying from 10 mg L⁻¹ to 85 mg L⁻¹. It was observed that our CDTO nanofilm can retain the same amount of solute molecules under varying feed concentrations (FIG. 18) yielding constant rejection across the spectrum of feed concentrations. However, the permeance suffered at higher feed concentrations, which is attributed to higher membrane fouling.

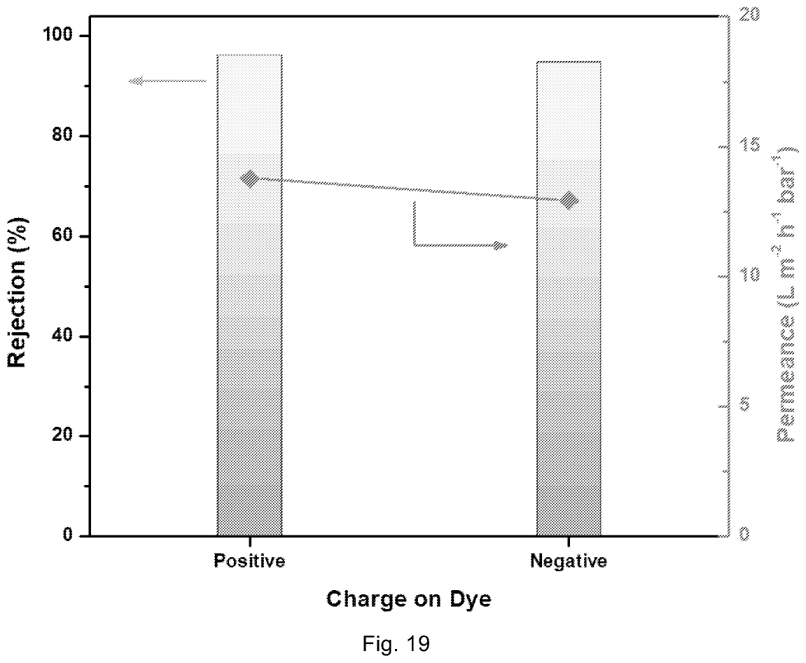

The surface of the CDTO nanofilms calcined under either air or N₂ shows different charges. The one calcined in N₂ was negatively charged, while the one calcined in air has a positive charge at neutral pH. There is a possibility of solutes getting rejected from solvent due to charge. To check the actual mechanism of rejection through the CDTO nanofilms, a CDTO-N₂ (30% H₂O) nanofilm was tested for rejection of two very similar sized dyes (˜250 Da) but having an opposite charges. 6-Hydroxy-2-naphthalene sulfonic acid sodium salt hydrate, a negatively charged dye, and Chrysoidine G, a positively charged dye, both having similar molecular weight, were used. It was observed that through our nanofilms, both dyes were rejected similarly (FIG. 19). This led to us believing limited role of charge in separation through CDTO membrane, and rejection was majorly caused by size selectivity.

Comparison with commercially available OSN membranes. Evaluating CDTO membranes for prospective industrial OSN applications requires critical analysis of commercial OSN membranes in terms of performance under similar testing conditions. Commercial OSN membranes with MWCO ranging from 150 to 700 Da were evaluated.

DuraMem 150 is a popular crosslinked polyimide membrane in the lower range of MWCO for OSN. The ethanol permeance (measured at 10 bar) associated with this membrane is 0.06 L m⁻² h⁻¹ bar⁻¹ which is about 3 orders of magnitude lower than our CDTO membranes with similar MWCO. Even though the specified MWCO of DuraMem 150 is 150 Da, the maximum rejection obtained for azobenzene (molecular weight: 182.2 Da) from ethanol is only 41%. This indicates that the pores may not be rigid, suggesting the need for membranes with rigid pores.

Starmem 122 is a hydrophobic membrane with an active layer of polyamide, synthesized by phase inversion with a specified MWCO of 220 Da. Although it has a low MWCO, one study shows unexpected low rejection (only 19%) of a large molecule, tridodecylamine (522 Da) at 30 bar pressure, while another showed 99% rejection of molecules of size 546 Da. Moreover, the ethanol permeance is 0.7 L m⁻² h⁻¹ bar⁻¹ which is ˜30 times lower than our membrane with similar MWCO. Livingston's group observed that it takes a few days to obtain a stable methanol flux of ˜65 L m⁻² h⁻¹ at 30 bar transmembrane pressure through Starmem 122. Interestingly, as Starmem 122 gets compressed under increasing transmembrane pressure, the flux declines significantly, and the rejection increases exhibiting MWCO very close to the specified value. However, at lower transmembrane pressures (>30 bar), these membrane showed larger permeance but lower rejection. Another study used Starmem 122 at 30 bar and found the rejection of solute molecules with molecular weight 276 Da (greater than MWCO) to be only ˜62%. They also observed solvent-dependent rejection of solute of molecular weight ˜464 Da; membrane showed good rejection (>90%) in alcohols, moderate rejection (˜80%) in toluene, and poor rejection (<50%) in ketenes. Interestingly, this trend in rejection goes against the hydration solvation mechanism.

MPF50 is a hydrophobic crosslinked polydimethylsiloxane selective layer on a polyacrylonitrile support membrane for OSN application with a specified MWCO of 700 Da. This membrane showed <90% rejection of erythromycin (molecular weight ˜733 Da) after the membrane was preconditioned by flushing with ethanol at 30 bar. It was observed that the flux declined with time, whereas the rejection increased with time indicating prominent membrane compaction. The methanol flux was ˜60 L m⁻² h⁻¹ measured at 40 bar, which is ˜180 times lower than that of our membranes with similar MWCO. Interestingly, these membranes showed a non-linear relationship of pressure with flux for alcohols, with flux decline more pertinent for larger alcohols. However, the response to pressure for MPF50 is much quicker, and the flux stabilized almost immediately.

These indicate the need for materials with rigid pores for sustained OSN performance. The lack of rigid pores causes prominent compaction and permeance loss for commercial OSN membranes. Moreover, most of the commercial OSN membranes are unstable at high temperature and are specified to be operated at temperatures below 40-50° C.

TABLE 2
Differentinterfacial reaction conditons to form dense OHF
prepared on 50 nm pore size ceramic hollow fibre support.

| | | TiCl₄ | Reaction | | | |
|---|---|---|---|---|---|---|
| Serial | Reaction | Conc. | Time | TiCl₄ | EG | N₂ Permeance |
| Number | Temperature | mol L⁻¹ | min | phase | Phase | mol m⁻² s⁻¹ Pa⁻¹ × 10⁻⁹ |
| 1 | Room | 1.0 | 0.5 | Liquid | Liquid | 3260 |
| 2 | Temperature | 1.0 | 1 | | | 272 |
| 3 | (20° C.) | 1.0 | 3 | | | 233 |
| 4 | | 1.0 | 5 | | | 466 |
| 5 | | 1.0 | 10 | | | 321 |
| 6 | | 1.0 | 20 | | | 87.4 |
| 7 | | 0.2 | 30 | | | 168 |
| 8 | | 0.2 | 120 | | | 2.62 |
| 9 | | 0.2 | 180 | | | ND |
| 10 | | 0.3 | 30 | | | 10.3 |
| 11 | | 0.3 | 60 | | | 173 |
| 12 | | 0.3 | 120 | | | ND |
| 13 | | 0.4 | 30 | | | 66.4 |
| 14 | | 0.4 | 60 | | | ND |
| 15 | 25° C. | Pure | 1 | Vapor | | 4040 |
| 16 | 70° C. | Pure | 30 | | | ND |
| 17 | 150° C. | Pure | 5 | | | ND |
| 18 | 150° C. | Pure | 180 | | | ND |

* ND indicates that no N₂ premeance was detected under 5 bar transmembrane pressure.
Note:
none of the samples were calcined in any form before testing the N₂ permeance. All coating was done only on the outside of the support.

TABLE 3
Different reaction condtions carried out at room temperature
for 30 min on a 5 nm pore size hollow fiber support membrane.

| | Metallic | | | | | |
|---|---|---|---|---|---|---|
| | Precursor | | Organic | | | |
| Serial | Concentration | TiCl₄ | Precursor, | Coating | | Gas Permeance |
| Number | mol L⁻¹ | phase | Phase | Location | Calcination | mol m⁻² s⁻¹ Pa⁻¹ × 10⁻⁹ |
| 1 | 0.01 | Liquid | EG, Liquid | Inside and | No | N₂: 45.6 |
| | | | | outside | | |
| 2 | 0.5 | | | Outside | No | N₂: ND |
| 3 | 0.5 | | | Inside and | No | N₂: ND |
| | | | | outside | | |
| 4 | 0.5 | | EG, Liquid | Outside | Yes, 250° C. | N₂: 26.5 |
| 5 | | | | | for 2 h, in | H₂: 72 |
| 6 | | | 1,3- | | Air | N₂: 33.7 |
| 7 | | | Propylene | | | H₂: 90.4 |
| | | | glycol, | | | |
| | | | Liquid | | | |

* ND indicates that no N₂ premeance was detected under 5 bar transmembrane pressure. N₂ and H₂ permeance through calcined nanofilms were measured at 3 bar transmembrane pressure.

TABLE 4
Physical properties of organic solvents used in this Example.

| | Temperature | | | | | | | |
|---|---|---|---|---|---|---|---|---|
| | at which | | | | | | | |
| | property is | | | | | | | molar |
| | evaluated | ρ | μ | δ_{d} | δₕ | δₚ | δ | volume |
| Solvent | ° C. | g ml⁻¹ | mPa s | MPa^{0.5} | MPa^{0.5} | MPa^{0.5} | MPa^{0.5} | cm³mol⁻¹ |
| Isopropyl | 20 | 0.785 | 2.39 | 15.8 | 6.1 | 16.4 | 23.6 | 75.1 |
| alcohol | | | | | | | | |
| Ethanol | | 0.789 | 1.19 | 15.8 | 8.8 | 19.4 | 26.5 | 58.7 |
| Benzene | | 0.874 | 0.65 | 18.4 | 2 | 0 | 18.5 | 89.5 |
| Toluene | | 0.865 | 0.59 | 18 | 1.4 | 2 | 18.2 | 106.9 |
| Methanol | | 0.791 | 0.61 | 15.1 | 12.3 | 22.2 | 29.5 | 40.7 |
| Hexane | | 0.659 | 0.31 | 14.9 | 0 | 0 | 14.9 | 131.4 |
| DMF | | 0.944 | 0.92 | 17.4 | 13.7 | 11.3 | 24.8 | 77 |
| DMF | 40 | 0.931 | 0.73 | | | | | |
| | 60 | 0.913 | 0.59 | | | | | |
| | 80 | 0.894 | 0.49 | | | | | |
| | 100 | 0.875 | 0.42 | | | | | |
| | 120 | 0.856 | 0.36 | | | | | |
| | 140 | 0.835 | 0.31 | | | | | |

Note:
μ = viscosity, ρ = density, δ_{d} = solubility parameter due to dispersion forces, δₚ = solubility parameter due to dipole forces, and δₕ = solubility parameter due to doner-acceptor interaction, and δ = \sqrt{δ_{d}² + δₚ² + δₕ²}.

TABLE 5
Solutes used to determine separation performance of CDTO membranes.

| | | Molecular |
|---|---|---|
| Name | Structure | Weight, g mol⁻¹ |
| Azobenzene AB | 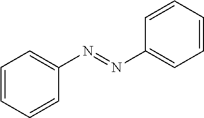 [SMILES: c1ccc(/N=N/c2ccccc2)cc1] | 182.22 |
| Methyl Orange MO | 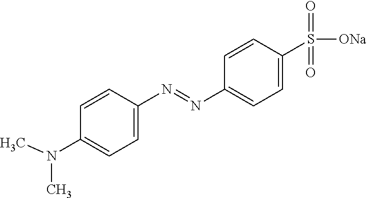 | 327.33 |
| Indigo Carmine IC | 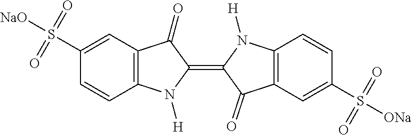 | 466.36 |
| Acid Fuchsin AF | 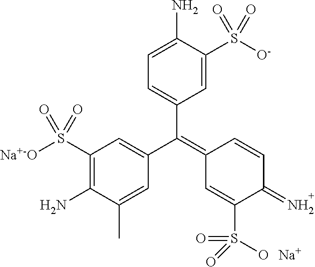 | 585.54 |
| Congo Red CR | 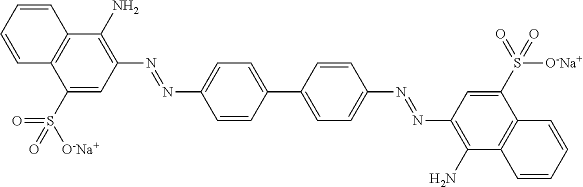 | 696.67 |
| Brilliant Blue R BB | 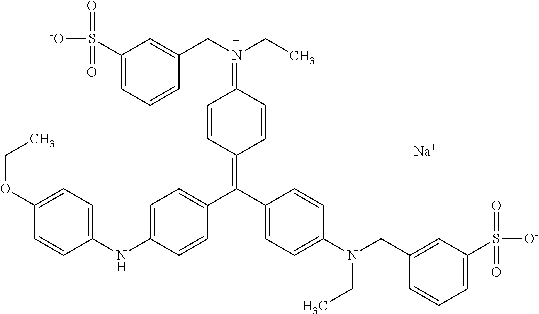 | 826.00 |
| Rose Bengal RB | 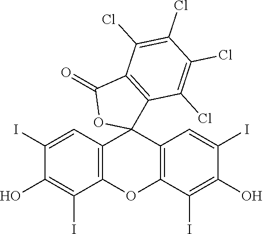 [SMILES: O=C1OC2(c3cc(I)c(O)c(I)c3Oc3c2cc(I)c(O)c3I)c2c(Cl)c(Cl)c(Cl)c(Cl)c21] | 973.67 |
| Reactive Red 120 RR | 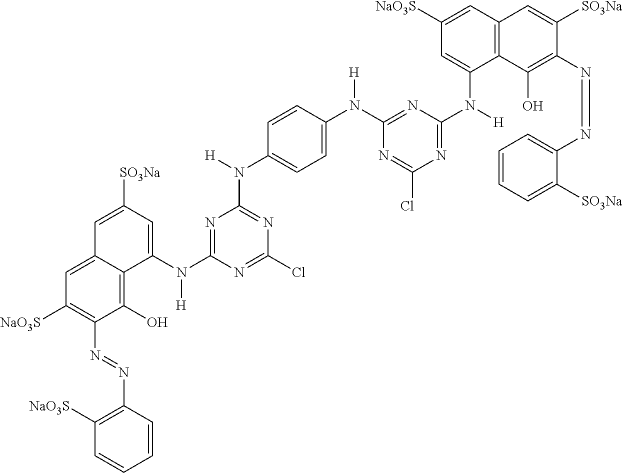 | 1338.10 |

TABLE 6
Comparison of state-of-the-art OSN membranes reported in the literature and commercially available.

| | | Methanol | | Tunability | | |
|---|---|---|---|---|---|---|
| Serial | | Permeance | MWCO | (MWCO range) | Temp. | Thickness |
| Number | Membrane | L m⁻² h⁻¹ bar⁻¹ | g mol⁻¹ | g mol⁻¹ | ° C. | nm |
| 1 | Mixed Matrix - PolyAmide/MOF | 3.9 | 232 | 232-295 | 30 | 150 |
| | (MIL, ZIF) | | | | | |
| 2 | Crosslinked polyarylate nanofilm | 0.7 | 249 | 249-314 | 30 | 20 |
| 3 | Reduced Graphene Oxide | 73.6 | 960.79 | NA | 30 | 25 |
| 4 | Mixed Matrix - | 9.1 | 630 | 590-770 | 30 | — |
| | Polyphenylsulfone/copper-1,3,5- | | | | | |
| | benzenetricarboxylate | | | | | |
| | nanoparticles | | | | | |
| 5 | Mixed Matrix - PolyAmide/MOF | 9.5 | 452 | NA | 30 | 100 |
| | (MIL-Cr) | | | | | |
| 6 | Mixed Matrix - PolyAmide/MOF | 5.5 | 425 | NA | 30 | 150 |
| | (MIL/ZIF) | | | | | |
| 7 | Mixed Matrix - PolyAmide/MOF | 3.3 | 256.35 | 256-425 | 55 | 150 |
| | (MIL/ZIF) | | | | | |
| 8 | Graphene Oxide | 9.6 | 329 | NA | 30 | 8 |
| 9 | Mixed Matrix - Polypyrrol/TiO₂ | 25 | 792 | 792-973 | 30 | <10 |
| | nanoparticles | | | | | |
| 10 | Polyamide | 34.12 | 246.2 | 246-327 | 30 | 8.5 |
| 11 | Reduced Graphene Oxide- | 4.4 | 960 | NA | 30 | 500 |
| | porphyrin | | | | | |
| 12 | Etched Single layer Graphene | 240 | 973 | NA | 30 | 1 |
| 13 | Trianglamine macrocycle thin | 22.5 | 450 | NA | 30 | 4.5 |
| | film | | | | | |
| 14 | Polyamide-CD thin film | 17 | 450 | NA | 30 | 2.5 |
| 15 | NH₂-Cyclodextrin (α, β, | 5.8 | 684 | 684-1051 | 25 | 14 |
| | γ)-TMC film | | | | | |
| 16 | β-CD-terephtaloy1 | 9.6 | 327 | NA | 25 | crumbled |
| | chloride thin film | | | | | |
| 18 | Conjugated microporous | 22 | 562 | NA | 25 | 40 |
| | polymers | | | | | |
| 19 | Hyperbranched | 1.09 | 585 | NA | 25 | 5 |
| | Sulfonated Poly | | | | | |
| | (aryleneoxindole) | | | | | |
| 20 | Electropolymerized | 23 | 540 | 540-690 | 25 | 100 |
| | conjugated microporous | | | | | |
| | polymer | | | | | |
| 21 | COF (TFP-DPF and | 44 | 790 | 790-1170 | 25 | 40 |
| | TFP-DNF) | | | | | |
| 22 | Lysozyme nanofilms | 7.5 × 10⁻⁷ | 582 | NA | 25 | 30 |
| 23 | Crosslinked Alginate | 1.8 | 1,355 | NA | 25 | 20 |
| 24 | 2D COF (TFP-DHF) | 105 | 1000 | NA | 25 | 42 |
| 25 | 3D COF (TFPM-Hz) | 42 | 320 | NA | 25 | 70 |
| 26 | TpHz COF/NH2- | 22 | 390 | NA | 25 | 5 |
| | GOQD | | | | | |
| 27 | Hydrophobic | 20 | 400 | NA | 25 | 12.3 |
| | Polyamide | | | | | |
| 28 | Aligned Macrocycle | 9.8 | 300 | 300-500 | 25 | 6 |
| 29 | Interfacial 2D COF | 12 | 370 | NA | 25 | 5 |
| 30 | Diamond Like Carbon | 102 | 200 | NA | 25 | 35 |
| 31 | e-AOPIM-1 | 58 | 820 | NA | 25 | 88 |
| Commercial | Duramem 150, Evonik | 0.48 | 586 | — | 25 | |
| Membrane | Solsep 030705 | 1.4 | 885 | — | 25 | |
| | Duramem 500, Evonik | 4.62 | 626 | — | 25 | |
| | Puramem 420, Evonik | 0.97 | 586 | — | 25 | |
| Carbon | CDTO-N₂ (250° C., 30% | 94 | 240 | 240-1340 | 140 | |
| Doped | H₂O, AAO) | | | | | |
| Titanium | CDTO-Air (250° C., 30% | 125 | 320 | | | 30 |
| Oxide | H₂O, AAO) | | | | | |
| (CDTO) | CDTO-N₂ (250° C., 0% | 186 | 620 | | | |
| | H₂O, AAO) | | | | | |
| | CDTO-Air (250° C., 0% | 276 | 920 | | | |
| | H₂O, AAO) | | | | | |
| | CDTO-N₂ (250° C., 30% | 17 | 240 | | | 150 |
| | H₂O, HF) | | | | | |
| | CDTO-Air (250° C., 20% | 43 | 530 | | | |
| | H₂O, HF) | | | | | |
| | CDTO-Air (300° C., 0% | 92 | 960 | | | |
| | H₂O, HF) | | | | | |
| | CDTO-Air (400° C., 0% | 135 | 1,340 | | | |
| | H₂O, HF) | | | | | |

* HF: Hollow Fiber (Low permeance support), AAO: Anodic Aluminum Oxide (high permeance support)

TABLE 7
Permeance and rejection of individual components used for
the synthesis of Boscalid through CDTO membranes at Room
Temperature, as evaluated by the dead-end filtration.

| | | | | Permeance |
|---|---|---|---|---|
| | | | | L |
| | | Molecular | | m⁻² |
| | Target | Weight | | h⁻¹ |
| Membrane | Molecule | g mol⁻¹ | Rejection | bar⁻¹ |
| MWCO: 940 | Catalyst | 1115 | >99% | 54.36 |
| [CDTO | Product | 341 | 21.7% | 57.34 |
| prepared by | Reactant 1 | 156.37 | 14.4% | 50.25 |
| calcining | Reactant 2 | 157.55 | 17.5% | 57.16 |
| OHF at 500° C. | Reactant 3 | 176 | 16.8% | 52.46 |
| in N₂] | Mixed Reactant | ~160 | 18.2% | 55.11 |
| MWCO: 300 | Catalyst | 1115 | >99% | 20.55 |
| [CDTO | Product | 341 | 96.8% | 21.32 |
| prepared by | Reactant 1 | 156.37 | 23.6% | 21.12 |
| calcining | Reactant 2 | 157.55 | 22.8% | 20.56 |
| OHF | Reactant 3 | 176 | 21.9% | 20.35 |
| (prepared with | Mixed Reactant | ~160 | 22.3% | 23.13 |
| 30% H₂O) at | | | | |
| 250° C. in N₂] | | | | |

### Example 2

The following is an example of a carbon-doped ceramic membrane of the present disclosure and use of same.

Hexane recovery from commercial soybean oil (purchased from Wegmans Food Market) was carried out using aCDTO membrane calcined at 250° C. in N₂ (prepared as described in EXAMPLE 1). A stable hexane flux of 220 L/m²/h with oil rejection ˜98% was observed after 10 h permeation at 30 bar feed pressure. This flux is about 4 times of the highest previously reported hexane flux. It is expected that a hexane flux of >500 L/m²/h at >50 bar can be achieved.

Although the present disclosure has been described with respect to one or more particular embodiment(s) and/or example(s), it will be understood that other embodiment(s) and/or example(s) of the present disclosure may be made without departing from the scope of the present disclosure.

1. A filtration substrate comprising a substrate and layer comprising one or more porous carbon-doped metal oxide and/or metal layer(s), wherein at least one of the porous carbon-doped metal oxide and/or metal layer(s) is/are disposed on at least a portion of a surface or surfaces of the substrate.

2. The filtration substrate of claim 1, wherein the substrate is planar, a fiber, or a plurality of fibers.

3. The filtration substrate of claim 2, wherein the fiber is a hollow fiber.

4. The filtration substrate of claim 1, wherein the substrate is porous.

5. The filtration substrate of claim 1, wherein the substrate comprises a metal chosen from stainless steel, titanium, zirconium, tin, tungsten, or any combination thereof.

6. The filtration substrate of claim 1, wherein the substrate comprises a ceramic material chosen from aluminum oxide, titanium oxide, zirconium oxide, tin oxide, tungsten oxide, or any combination thereof.

7. The filtration substrate of claim 1, wherein each of the porous carbon-doped metal oxide and/or metal layer(s) independently comprise(s) at least one linear cross-sectional dimension of about 2 nm to about 200 nm.

8. The filtration substrate of claim 1, wherein each of the porous carbon-doped metal oxide and/or metal layer(s) independently comprise(s) one or more transition metal(s) and/or one or more transition metal oxide(s).

9. The filtration substrate of claim 1, wherein each of the porous carbon-doped metal oxide and/or metal layer(s) independently comprise(s) a carbon-doped titanium oxide and/or titanium metal, a carbon-doped zirconium oxide and/or zirconium metal, carbon-doped tungsten oxide and/or tungsten metal, carbon-doped zinc oxide and/or zinc metal, carbon-doped copper oxide and/or copper metal, carbon-doped tin oxide and/or tin metal, or any combination thereof.

10. The filtration substrate of claim 1, wherein each of the porous carbon-doped metal oxide and/or metal layer(s) independently comprise(s) about 30% at. to about 60% at.

11. The filtration substrate of claim 1, wherein each of the porous carbon-doped metal oxide and/or metal layer(s) independently comprise(s) about 40 at. % to about 70 at. % metal and/or metal oxide.

12. The filtration substrate of claim 1, wherein each of the porous carbon-doped metal oxide and/or metal layer(s) independently comprise(s) an average pore diameter of about 2 nm to about 10 nm.

13. The filtration substrate of claim 1, wherein each of the porous carbon-doped metal oxide and/or metal layer(s) independently comprises interconnected pores or an open pore structure.

14. The filtration substrate of claim 1, wherein each of the porous carbon-doped metal oxide and/or metal layer(s) independently comprise(s) about 5% pore volume to about 50% pore volume.

15. The filtration substrate claim 1, wherein the filtration substrate exhibits one or more or all of the following:
a flux of greater than about 10 L m⁻² h⁻¹;
no substantial change in pore dimension(s) at temperatures up to about 250° C. or greater;
a porosity/tortuosity factor of about 0.05 or greater
a molecular weight cutoff value from about 200 g/mol to about 1,000 g/mol); or
a rejection of about 80% or more.

16. A method of making a filtration substrate comprising a substrate and layer comprising one or more porous carbon-doped metal oxide and/or metal layer(s), wherein at least one of the porous carbon-doped metal oxide and/or metal layer(s) is/are disposed on at least a portion of a surface or surfaces of the substrate comprising:
contacting a substrate with one or more liquid carbon precursor(s) and optionally, water,
optionally, holding the substrate and carbon precursor(s) and optionally, water for a desired time and/or temperature;
optionally, drying or removing excess liquid precursor(s);
contacting the substrate with liquid precursor(s) disposed thereon with one or more vapor-phase metal and/or metal oxide precursor(s), wherein a precursor layer is formed;
optionally, contacting the precursor layer to remove undesirable material(s); and
heating precursor layer,
wherein the filtration substrate is formed.

17. The method of claim 16, wherein the carbon sourc(es) is/are chosen from polyols and any combination thereof.

18. The method of claim 16, wherein the vapor-phase metal and/or metal oxide precursor(s) are chosen from metal halides and any combination thereof.

19. A filtration system comprising one or more filtration substrate(s) of claim 1.

20. The filtration system of claim 19, the system comprising one or more pump(s), one or more mass/flow controller(s), one or more reservoir(s), one or more tank(s), or one or more pressure gauge(s), or any combination thereof.

21. The system of claim 19, wherein the filtration substrate(s) is/are disposed in a housing, the housing comprising one or more orafic(es).

22. A method of separating one or more compound(s) from a composition comprising:
contacting one or more filtration substrate(s) of claim 1 with the composition comprising the compound(s),
wherein the one or more compound(s) are separated from the mixture.

23. The method of claim 22, wherein the composition is a reaction mixture.

24. The method of claim 22, wherein the composition comprises vegetable oil(s) and one or more organic solvent(s) and substantially all the organic solvent(s) is/are separated from the composition.

25. The method of claim 22, wherein the one or more compound(s) are chosen from reaction component(s), reaction product(s), reaction by-product(s), reactant component degradation product(s), catalyst(s), and solvent(s), and any combination thereof.

26. The method of claim 22, wherein the filtration membrane(s) is/are reused in a subsequent filtration.

27. A method according to claim 26, wherein the filtration membranes(s) are cleaned prior to use in each of the subsequent filtrations.
